(19) United States
(12) Patent Application Publication
(10) Pub. No.: US 2012/0173732 A1
(43) Pub. Date: Jul. 5, 2012

(54) SYSTEMS AND METHODS FOR PROVIDING RESOURCES AND INTERACTIVITY IN COMPUTER SYSTEMS

(76) Inventor: Jason A. Sullivan, Youngstown, OH (US)

(21) Appl. No.: 13/342,199

(22) Filed: Jan. 2, 2012

Related U.S. Application Data
(63) Continuation-in-part of application No. 13/154,325, filed on Jun. 6, 2011.
Application No. 13/154,325 is a continuation-in-part of application No. 12/795,439, filed on Jun. 7, 2010.
Application No. 12/795,439 is a continuation of application No. 11/827,360, filed on Jul. 9, 2007, now Pat. No. 7,733,635.
Application No. 11/827,360 is a continuation of application No. 10/692,005, filed on Oct. 22, 2003, now Pat. No. 7,242,574.
Application No. 10/692,005 is a continuation-in-part of application No. 12/843,304, filed on Jul. 26, 2010.
Application No. 12/843,304 is a continuation of application No. 11/483,956, filed on Jul. 10, 2006, now Pat. No. 7,764,506.
Application No. 11/483,956 is a division of application No. 10/691,114, filed on Oct. 22, 2003, now Pat. No. 7,075,784.
Application No. 10/691,114 is a continuation-in-part of application No. 12/906,836, filed on Oct. 18, 2010.
Application No. 12/906,836 is a continuation of application No. 11/833,852, filed on Aug. 3, 2007, now Pat. No. 7,817,412.
Application No. 11/833,852 is a continuation-in-part of application No. 10/691,473, filed on Oct. 22, 2003, now Pat. No. 7,256,991.
(60) Provisional application No. 60/420,127, filed on Oct. 22, 2002.
(60) Provisional application No. 60/455,789, filed on Mar. 19, 2003.
(60) Provisional application No. 60/420,127, filed on Oct. 22, 2002.
(60) Provisional application No. 60/455,789, filed on Mar. 19, 2003.
(60) Provisional application No. 60/420,127, filed on Oct. 22, 2002.
(60) Provisional application No. 60/455,789, filed on Mar. 19, 2003.
(60) Provisional application No. 61/407,904, filed on Oct. 28, 2010.
(60) Provisional application No. 61/352,349, filed on Jun. 7, 2010.
(60) Provisional application No. 61/352,351, filed on Jun. 7, 2010.
(60) Provisional application No. 61/352,357, filed on Jun. 7, 2010.
(60) Provisional application No. 61/352,359, filed on Jun. 7, 2010.
(60) Provisional application No. 61/352,363, filed on Jun. 7, 2010.
(60) Provisional application No. 61/352,369, filed on Jun. 7, 2010.
(60) Provisional application No. 61/352,378, filed on Jun. 7, 2010.
(60) Provisional application No. 61/352,379, filed on Jun. 7, 2010.
(60) Provisional application No. 61/352,362, filed on Jun. 7, 2010.
(60) Provisional application No. 61/352,368, filed on Jun. 7, 2010.
(60) Provisional application No. 61/352,372, filed on Jun. 7, 2010.
(60) Provisional application No. 61/352,384, filed on Jun. 7, 2010.
(60) Provisional application No. 61/352,381, filed on Jun. 7, 2010.
(60) Provisional application No. 61/352,358, filed on Jun. 7, 2010.
(60) Provisional application No. 61/352,383, filed on Jun. 7, 2010.
(60) Provisional application No. 61/430,113, filed on Jan. 5, 2011.
(60) Provisional application No. 61/429,375, filed on Jan. 3, 2011.

(51) Int. Cl. G06F 13/14; G06F 15/173

(52) U.S. Cl. 709/226; 710/8

(57) ABSTRACT

Systems and methods for distributing computing resources utilize a base module having certain processing resources. A peripheral module is communicatively connected to the base module and is configured to utilize processing resources of the base module using one or more input/output devices connected to the peripheral module. The peripheral module uses a minimum of power, utilizes only enough computing resources to pass input/output signals between the input/output devices at the peripheral module and the base module, and provides access to an additional session of the operating system of the base module without requiring that a separate instance of the operating system be loaded into memory of the base module. The peripheral module may serve essentially as an intelligent mounting bracket.

### RELATED APPLICATIONS

This application is a continuation-in-part of U.S. patent application Ser. No. 13/154,325 filed Jun. 6, 2011, entitled “SYSTEMS AND METHODS FOR PROVIDING A UNIVERSAL COMPUTING SYSTEM”, which is a continuation-in-part of U.S. patent application Ser. No. 12/795,439 filed Jun. 7, 2010, entitled “SYSTEMS AND METHODS FOR PROVIDING A ROBUST COMPUTER PROCESSING UNIT,” which claims priority to U.S. patent application Ser. No. 11/827,360, which was filed on Jul. 9, 2007 and entitled “SYSTEMS AND METHODS FOR PROVIDING A ROBUST COMPUTER PROCESSING UNIT,” and issued on Jun. 8, 2010 as U.S. Pat. No. 7,733,635, which claims priority to U.S. patent application Ser. No. 10/692,005, which was filed on Oct. 22, 2003 and entitled “ROBUST CUSTOMIZABLE COMPUTER PROCESSING SYSTEM,” and which issued on Jul. 10, 2007 as U.S. Pat. No. 7,242,574, which claims priority to U.S. Provisional Patent Application Ser. No. 60/420,127, filed Oct. 22, 2002, entitled, “NON-PERIPHERALS PROCESSING CONTROL UNIT HAVING IMPROVED HEAT DISSIPATING PROPERTIES” and also claims priority to U.S. Provisional Patent Application Ser. No. 60/455,789, filed Mar. 19, 2003, entitled, “SYSTEMS AND METHODS FOR PROVIDING A DURABLE AND DYNAMICALLY MODULAR PROCESSING UNIT,” which are all expressly incorporated herein by reference in their entireties.

U.S. patent application Ser. No. 13/154,325 filed Jun. 6, 2011, entitled “SYSTEMS AND METHODS FOR PROVIDING A UNIVERSAL COMPUTING SYSTEM” is also a continuation-in-part of U.S. patent application Ser. No. 12/843,304, filed Jul. 26, 2010, entitled “SYSTEMS AND METHODS FOR PROVIDING A DYNAMICALLY MODULAR PROCESSING UNIT,” which claims priority to U.S. patent application Ser. No. 11/483,956 filed Jul. 10, 2006, entitled “SYSTEMS AND METHODS FOR PROVIDING A DYNAMICALLY MODULAR PROCESSING UNIT,” which is a divisional application of U.S. patent application Ser. No. 10/691,114 filed Oct. 22, 2003, entitled “SYSTEMS AND METHODS FOR PROVIDING A DYNAMICALLY MODULAR PROCESSING UNIT,” now issued as U.S. Pat. No. 7,075,784 which claims priority to U.S. Provisional Patent Application Ser. No. 60/420,127 filed Oct. 22, 2002 entitled “NON-PERIPHERALS PROCESSING CONTROL UNIT HAVING IMPROVED HEAT DISSIPATING PROPERTIES” and to U.S. Provisional Patent Application Ser. No. 60/455,789 filed Mar. 19, 2003 entitled “SYSTEMS AND METHODS FOR PROVIDING A DURABLE AND DYNAMICALLY MODULAR PROCESSING UNIT,” which are all incorporated herein by reference, and is related to issued U.S. Pat. No. 7,256,991 filed Oct. 22, 2003, entitled “NON-PERIPHERALS PROCESSING CONTROL MODULE HAVING IMPROVED HEAT DISSIPATING PROPERTIES”, and is related to issued U.S. Pat. No. 7,242,574 filed Oct. 22, 2003, entitled “ROBUST CUSTOMIZABLE COMPUTER PROCESSING SYSTEM”, which are all expressly incorporated herein by reference in their entireties.

U.S. patent application Ser. No. 13/154,325 filed Jun. 6, 2011, entitled “SYSTEMS AND METHODS FOR PROVIDING A UNIVERSAL COMPUTING SYSTEM” is also a continuation in part of U.S. patent application Ser. No. 12/906,836 filed Oct. 18, 2010, entitled “NON-PERIPHERALS PROCESSING CONTROL MODULE HAVING IMPROVED HEAT DISSIPATING PROPERTIES”, which claims priority to U.S. patent application Ser. No. 11/833,852, filed Aug. 3, 2007, entitled “NON-PERIPHERALS PROCESSING CONTROL MODULE HAVING IMPROVED HEAT DISSIPATING PROPERTIES,” which is a continuation application of U.S. patent application Ser. No. 10/691,473, filed Oct. 22, 2003, entitled “NON-PERIPHERALS PROCESSING CONTROL MODULE HAVING IMPROVED HEAT DISSIPATING PROPERTIES,” now issued as U.S. Pat. No. 7,256,991, which claims priority to U.S. Provisional Application Ser. No. 60/420,127, filed Oct. 22, 2002, entitled “NON-PERIPHERALS PROCESSING CONTROL UNIT HAVING IMPROVED HEAT DISSIPATING PROPERTIES,” and to U.S. Provisional Application Ser. No. 60/455,789, filed Mar. 19, 2003, entitled “SYSTEMS AND METHODS FOR PROVIDING A DURABLE AND DYNAMICALLY MODULAR PROCESSING UNIT,” which are all expressly incorporated herein by reference in their entireties.

U.S. patent application Ser. No. 13/154,325 filed Jun. 6, 2011, entitled “SYSTEMS AND METHODS FOR PROVIDING A UNIVERSAL COMPUTING SYSTEM” also claimed priority to the following provisional applications: Ser. No. 61/407,904 (Attorney Docket Number: 11072.268) titled “MODULAR VIRTUALIZATION IN COMPUTER SYSTEMS” filed Oct. 28, 2010, Ser. No. 61/352,349 (Attorney Docket Number: 11072.239) titled “SYSTEMS AND METHODS FOR OPTIMIZING MEMORY PERFORMANCE” filed Jun. 7, 2010, Ser. No. 61/352,351 (Attorney Docket Number: 11072.240) titled “SYSTEMS AND METHODS FOR PROVIDING MULTI-LINK DYNAMIC PCIE PARTITIONING” filed Jun. 7, 2010, Ser. No. 61/352,357 (Attorney Docket Number: 11072.241) titled “TRACKING APPARATUS” filed Jun. 7, 2010, Ser. No. 61/352,359 (Attorney Docket Number: 11072.242) titled “MINIATURIZED POWER SUPPLY” filed Jun. 7, 2010, Ser. No. 61/352,363 (Attorney Docket Number: 11072.243) titled “SYSTEMS AND METHODS FOR PROVIDING MULTI-LINK DYNAMIC VIDEO PARTITIONING” filed Jun. 7, 2010, Ser. No. 61/352,369 (Attorney Docket Number: 11072.244) titled “SYSTEMS AND METHODS FOR PROVIDING A PIN GRID ARRAY TO BALL GRID ARRAY ADAPTER” filed Jun. 7, 2010, Ser. No. 61/352,378 (Attorney Docket Number: 11072.245) titled “SYSTEMS AND METHODS FOR ACTIVATING MULTICOLOR LIGHT EMITTING DIODES” filed Jun. 7, 2010, Ser. No. 61/352,379 (Attorney Docket Number: 11072.246) titled “SYSTEMS AND METHODS FOR PROVIDING CONNECTIVITY” filed Jun. 7, 2010, Ser. No. 61/352,362 (Attorney Docket Number: 11072.247) titled “SYSTEMS AND METHODS FOR INTELLIGENT AND FLEXIBLE MANAGEMENT AND MONITORING OF COMPUTER SYSTEMS” filed Jun. 7, 2010, Ser. No. 61/352,368 (Attorney Docket Number: 11072.248) titled “MULTI-LINK DYNAMIC BUS PARTITIONING” filed Jun. 7, 2010, Ser. No. 61/352,372 (Attorney Docket Number: 11072.249) titled “MULTI-LINK DYNAMIC STORAGE PARTITIONING” filed Jun. 7, 2010, Ser. No. 61/352,384 (Attorney Docket Number: 11072.250) titled “LOAD BALANCING MODULAR COOLING SYSTEM” filed Jun. 7, 2010, Ser. No. 61/352,381 (Attorney Docket Number: 11072.251) titled “SYSTEMS AND METHODS FOR WIRELESSLY RECEIVING COMPUTER SYSTEM DIAGNOSTIC INFORMATION” filed Jun. 7, 2010, Ser. No. 61/352,358 (Attorney Docket Number: 11072.252) titled “SYSTEMS AND METHODS FOR PROVIDING A CUSTOMIZABLE COMPUTER PROCESSING UNIT” filed Jun. 7, 2010, Ser. No. 61/352,383 (Attorney Docket Number: 11072.253) titled “SYSTEMS AND METHODS FOR MOUNTING” filed Jun. 7, 2010, which are all expressly incorporated herein by reference in their entireties.

This application also claims priority to the following provisional applications: U.S. Ser. No. 61/429,375 (Attorney Docket No. 11072.236) titled “INTERACTIVE COMPUTING SYSTEM” filed Jan. 3, 2011, and U.S. Ser. No. 61/430,113 (Attorney Docket No. 11072.350) titled “PROVIDING COMPUTER RESOURCES USING MODULAR DEVICES” filed Jan. 5, 2011, which are all expressly incorporated herein by reference in their entireties.

### BACKGROUND OF THE INVENTION

1. Field of the Invention

The present invention relates to computer processors, computer systems, computer housings, computer encasement modules, computer system configurations, computer resources, and/or computer system interactivity. More particularly, implementations of the present invention relate to a virtually-modularized computer system, an interactive computing system, and/or storage and other modular systems devices for use with computer systems. At least some implementations of the present invention relate to systems and methods that increase the capability and performance of a portable computer device (“PCD”) by linking the PCD with a stationary processing control unit (“PCU”). In some implementations, the present invention further relates to systems and methods that increase the usability of a PCD by creating and associating scripts to defined movements or orientations of the PCD, thereby providing a desired processing function.

2. Background and Related Art

Existing systems for providing computer resources to multiple users are inefficient, costly, difficult and expensive to scale, and have a variety of other problems. For example, a standard desktop system utilizes a great deal of energy and is typically inefficiently used, having far more processing power than is usually necessary for most users. The total processing power is necessary, however, for the occasional times when a user places increased demand on the system by running multiple applications and/or running more intensive applications.

Existing thin client systems relying on remote utilization of computing resources are sometimes used to allow the sharing of computing resources. The use of such systems involves significant risk, as a failure at the remote system providing the bulk of the computing resources may result in significant downtime. Of course, such periods of downtime can be very costly for businesses and users alike, and many businesses shy away from such risks. Additionally, the costs of such implementations are high, as the “thin” clients still include significant local hardware resources.

Thus, there are significant problems remaining in the provision of computing resources to multiple users that remain to be satisfactorily addressed.

### BRIEF SUMMARY OF THE INVENTION

The present invention relates to computer processors, computer systems, computer housings, computer encasement modules, computer system configurations, computer resources, and/or computer system interactivity. More particularly, implementations of the present invention relate to a virtually-modularized computer system, an interactive computing system, and/or storage and other modular systems devices for use with computer systems. At least some implementations of the present invention relate to systems and methods that increase the capability and performance of a portable computer device (“PCD”) by linking the PCD with a stationary processing control unit (“PCU”). In some implementations, the present invention further relates to systems and methods that increase the usability of a PCD by creating and associating scripts to defined movements or orientations of the PCD, thereby providing a desired processing function.

At least some implementations of the present invention provide a system for distributing computing resources that includes a base module having certain processing resources. The system also includes a peripheral module communicatively connected to the base module and configured to utilize processing resources of the base module using one or more input/output devices connected to the peripheral module, whereby the peripheral module facilitates a user's opening a session on the base module while using significantly less power for the peripheral module itself than any existing computer system.

Further implementations of the present invention provide a system for distributing computing resources that includes a base module having certain processing resources. The system also includes a peripheral module communicatively connected to the base module and configured to utilize processing resources of the base module using one or more input/output devices connected to the peripheral module, wherein the peripheral module utilizes only enough computing resources to pass input/output signals between the input/output devices at the peripheral module and the base module.

Still further implementations of the present invention provide a system for efficiently managing and distributing computing resources including a base module having certain processing resources and providing a first user with a graphical user interface providing access to a first session of an operating system of the base module. The system also includes a peripheral module communicatively connected to the base module and providing a second user with a graphical user interface providing access to a second session of the operating system of the base module without requiring that a separate instance of the operating system be loaded into memory of the base module.

Additional implementations of the invention provide an intelligent mounting bracket having a structural shell configured to be mounted to an underlying surface and to securely hold or retain a mounted item. The structural shell contains a computer system configured to distribute processing resources from a remote computer system to one or more computer resources proximate to the mounting bracket.

At least some implementations of the present invention provide a modular computing device having a housing defining an internal volume. A printed circuit board is mounted within the housing. The printed circuit board has a first major surface and an opposite second major surface, and a first computing component is communicatively connected to the printed circuit board and disposed along the first major surface. The printed circuit board is configured to receive a second computing component communicatively connected to the printed circuit board and disposed along the second major surface, and, optionally, a second computing component is communicatively connected to the printed circuit board and disposed along the second major surface.

In some implementations, a processing power of a PCD is expanded by establishing communication between the PCD and a PCU having increased processing power. Thus, the PCD utilizes the increased processing power of the PCU to perform a function or execute a program that would otherwise exceed the processing power of the PCD. In other implementations, the storage capacity of the PCD is expanded by establishing communication between the PCD and a PCU having increase storage capacity. Further, in some implementations a PCD utilizes the processing power of a supercomputer by establishing communication with an external PCU having supercomputer processing capabilities.

In some implementations, a plurality of PCDs performs an I/O function in combination with an external display unit. The PCDs provide increased surface area, as well as processing power to perform a desired function. For example, in some implementations a touch screen keyboard is capable of being enlarged by dividing the keyboard in half between two PCDs. In some implementations, the ergonomic needs of a user are met by rotating the PCDs to achieve a desired position for the user.

In some implementations, an orientation, position, action or movement of the PCD results in the execution of a desired computer program or application. In other implementations, an angle of the PCD executes a desire computer program or application. Thus, the user may select a desired program or application by simply performing a predetermined, or user established movement, position, orientation, action or sequence of actions.

While the methods and processes of the present invention have proven to be particularly useful in the area of personal computing, those skilled in the art can appreciate that the methods and processes can be used in a variety of different applications and in a variety of different system configurations to yield virtually-modularized computer systems.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a block diagram that provides a representative modular processing unit or processing control unit (“PCU”) connected to peripherals to provide a representative computing enterprise in accordance with an embodiment of the present invention;

FIG. 2 shows a representative embodiment of a durable and dynamically modular processing unit;

FIG. 3A shows another view of the embodiment of FIG. 2 having a non-peripheral based encasement, a cooling process (e.g., thermodynamic convection cooling, forced air, and/or liquid cooling), an optimized layered printed circuit board configuration, optimized processing and memory ratios, and a dynamic back plane that provides increased flexibility and support to peripherals and applications;

FIGS. 3B-3C show other representative embodiments;

FIG. 4 shows a representative enterprise wherein a dynamically modular processing unit, having a non-peripheral based encasement, is employed alone in a personal computing enterprise;

FIG. 5 shows a representative enterprise wherein a dynamically modular processing unit, having a non-peripheral based encasement, is employed in another representative computing enterprise;

FIG. 6 shows another representative enterprise similar to FIG. 5 that includes additional peripherals, such as removable drives or other modular peripherals;

FIG. 7 shows another representative enterprise wherein a dynamically modular processing unit is utilized in an electronic enterprise;

FIG. 8 shows another representative enterprise, wherein a dynamically modular processing unit is utilized as a handheld enterprise;

FIG. 9 shows a utilization of the embodiment of FIG. 8 in another representative enterprise;

FIG. 10 shows another representative handheld enterprise having a non-peripheral based encasement combined with an external flip-up I/O peripheral;

FIG. 11 shows another view of the embodiment of FIG. 10;

FIG. 12 shows a representative enterprise wherein a dynamically modular processing unit is employed in a representative consumer electrical device;

FIG. 13 shows another representative enterprise wherein a dynamically modular processing unit is employed in a representative electrical device;

FIG. 14 shows a representative enterprise wherein one or more dynamically modular processing units are employed in another electrical device;

FIG. 15 shows a representative enterprise wherein one or more dynamically modular processing units are employed in another representative device;

FIG. 16 shows a representative enterprise wherein multiple dynamically modular processing units, each having a non-peripheral based encasement, are oriented and employed in a computing enterprise to provide increased processing capabilities;

FIG. 17 shows a representation of a computer system that can be used in conjunction with embodiments of the invention;

FIG. 18 shows a representative networked computer system that can be used in conjunction with embodiments of the invention;

FIG. 19 shows a representative networked computer system according to embodiments of the invention;

FIG. 20 shows a representative configuration of a base module and several peripheral modules in conjunction with embodiments of the invention;

FIG. 21 shows a representative redundant base module configuration;

FIG. 22 shows an exploded perspective view of a representative peripheral module;

FIG. 23 shows a perspective view of a structural attachment between a representative base module and a representative peripheral module;

FIG. 24 shows an end view of a representative peripheral module;

FIG. 25 shows a perspective view of a representative peripheral module;

FIG. 26 shows a perspective view of a representative peripheral module;

FIG. 27 shows an end view of an outer structural shell of an alternative representative peripheral module;

FIG. 28 shows a perspective view of a representative mounting plate;

FIG. 29 illustrates a representative system in accordance with embodiments of the invention;

FIG. 30 illustrates a representative mobile system in accordance with embodiments of the invention;

FIG. 31 shows a representative mobile system in accordance with embodiments of the invention interacting with a representative stationary system;

FIG. 32 shows a modular computer system adapted for use with modular virtualization;

FIG. 33 shows a comparative representative configuration between a system having a base module and multiple peripheral modules and a system having a base module and a multi-peripheral-module unit.

FIG. 34 shows a representative networked computer system that can be used in conjunction with embodiments of the invention;

FIG. 35 shows various representative configurations of a modular device according to embodiments of the invention;

FIGS. 36-38 show various perspective views of a representative printed circuit board in a housing according to embodiments of a modular device;

FIGS. 39-41 show views of a representative printed circuit board;

FIG. 42 shows a side view of a T-shaped connector disposed within a slot of a printed circuit board;

FIG. 43 illustrates a representative mobile system in accordance with embodiments of the invention.

FIG. 44 is a perspective view of a portable computer device (PCD) and stationary processing computer unit (PCU) in accordance with a representative embodiment of the present invention;

FIG. 45 is a side view of a PCD and a PCU in accordance with a representative embodiment of the present invention;

FIG. 46 is a flow chart of a process whereby the processing powers of a PCD and a PCU are used to run a program on a PCD in accordance with a representative embodiment of the present invention;

FIG. 47 is a plan view of a PCD and a PCU used in combination with a storage unit in accordance with a representative embodiment of the present invention;

FIG. 48 is a plan view of a PCD and a PCU coupled to a power supply in accordance with a representative embodiment of the present invention;

FIG. 49 is a schematic view of a PCD used in combination with a PCU and a remote storage unit accessed via a network in accordance with a representative embodiment of the present invention;

FIG. 50 is a plan view of a PCD used in combination with a PCU and graphical computing unit (GCU) in accordance with a representative embodiment of the present invention;

FIG. 51 is a plan view of a pair of PCDs operating together as an input device in accordance with a representative embodiment of the present invention;

FIGS. 52A-52B show a plan view of a pair of PCDs operating together as an ergonomic input device in accordance with a representative embodiment of the present invention;

FIG. 53 is a schematic view of a PCD being moved throughout various orientations in accordance with a representative embodiment of the present invention;

FIG. 54 is a flow chart of a method for associating a computer program with an orientation of a PCD in accordance with a representative embodiment of the present invention;

FIG. 55 is a flow chart of a method for associating a computer program with an angle of a PCD in accordance with a representative embodiment of the present invention;

FIG. 56 is a flow chart of a method for associating a computer program with an action of a PCD in accordance with a representative embodiment of the present invention; and

FIG. 57 is a perspective view of a PCD illustrating the various possible planes of movement in accordance with a representative embodiment of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

The present invention relates to computer processors, computer systems, computer housings, computer encasement modules, computer system configurations, computer resources, and/or computer system interactivity. More particularly, implementations of the present invention relate to a virtually-modularized computer system, an interactive computing system, and/or storage and other modular systems devices for use with computer systems. At least some implementations of the present invention relate to systems and methods that increase the capability and performance of a portable computer device (“PCD”) by linking the PCD with a stationary processing control unit (“PCU”). In some implementations, the present invention further relates to systems and methods that increase the usability of a PCD by creating and associating scripts to defined movements or orientations of the PCD, thereby providing a desired processing function.

The following disclosure of the present invention is grouped into four subheadings, namely “Representative Operating Environments,” “Distribution of Base Module Processing Power through the Peripheral Module(s),” “Provision of Computing Resources Using Modular Device(s),” and “Interactive Computing System.” The utilization of the subheadings is for convenience of the reader only and is not to be construed as limiting in any sense.

### Representative Operating Environments

Modern computers and computing systems play an indispensable role in driving invention, enabling lightning speed technological advancement, simplifying tasks, recording and storing data, connecting the world, and enhancing innumerable applications in virtually every industry and every country around the world. Indeed, the computer has become an indispensable tool for individuals, businesses, and governments alike. Computing systems have been incorporated into innumerable machines, applications, and systems and have enhanced their functionality, efficiency, and speed, while reducing costs.

At the heart of modern computers and computing systems is the computer motherboard. A motherboard is the main circuit board in electronic, processing systems. The motherboard provides electronic connections by which components of a computing system operate. Historically, motherboards have been made of a single electronic circuit board, to which is attached the core components of the computer system. These core components generally include a processor or a socket into which a processor is installed, a clock, electronic memory or slots into which the system's main memory is installed, memory (typically non-volatile memory) containing the system's firmware or basic input/output system (“BIOS”), power connectors, and power circuits. In addition, some motherboards include slots for expansion cards, peripheral controllers, and connectors for peripheral devices.

Current motherboards only support minor upgrades and modifications to their components and configuration. For example, most motherboards only support a narrow range of processor types. If computer user wants to replace the current, supported processor with different type of processor he may need to replace the entire motherboard. Likewise, most motherboards don't allow a user to add an additional processor or add a processor that requires a different processor socket than that included on the motherboard. In these cases a user will need to replace the motherboard entirely.

By its very nature, the two-dimensional motherboard configuration limits the size of corresponding computer encasements. Two-dimensional motherboards require overly large encasements to keep out dust and house the motherboard, its components, a cooling system, and internal peripherals. Such encasements take up large amounts of office and desk space and are not easily portable.

In summary, current motherboard configurations are limited in their ability to adapt, to be upgraded, and to support various system components. Further current motherboard configurations impose size constraints on encasements and computing systems. Thus, it would be desirable to provide a motherboard that overcame the deficiencies of current motherboards.

In response to problems and needs in the art that have not yet been fully resolved by currently available motherboards, a modular motherboard and a method for providing a modular motherboard is presented herein. In particular, implementation of the present invention takes place in association with a modular motherboard that is made of two or more electronic circuit boards, each performing at least one designated function. The electronic circuit boards are operably coupled together as an integrated logic board that can be used in a computer or computing system. Exemplary functions include, processing, providing system memory, providing system storage, and providing system BIOS.

In one implementation, a processing unit includes a modular motherboard having a tri-board configuration. A first circuit board includes a processor and a memory device, a second circuit board includes system BIOS, and a third circuit board includes an electronic storage device. This processing unit can further include a non-peripheral based encasement and a dynamic backplane.

In another implementation, a processing unit includes a modular motherboard having a four-board configuration. A first circuit board includes a processor, a second circuit board includes a memory device, a third circuit board includes system BIOS, and a fourth circuit board includes an electronic storage device. This processing unit can also include a non-peripheral based encasement and a dynamic backplane.

In another implementation, a modular motherboard is connected together with motherboard connectors. These connectors have corresponding geometries which prevent noncompliant connectors from connecting to the motherboard. The connector geometry includes two sub-geometries: a connection sub-geometry and a security sub-geometry. The connection sub-geometry includes the necessary shapes, forms, and structure to mechanically and electrically connect with another motherboard connector. The security sub-geometry includes one or more security key structures that prevent the connector from mating with another motherboard connector that does not have a corresponding security key structure(s).

Implementation of the present invention provides a platform that may be employed in association with all types of computer enterprises. The platform allows for a plethora of modifications that may be made with minimal impact to the processing unit, thereby enhancing the usefulness of the platform across all type of applications.

While the methods and processes of the present invention have proven to be particularly useful in the area of personal computing enterprises, those skilled in the art will appreciate that the methods and processes of the present invention can be used in a variety of different applications and in a variety of different areas of manufacture to yield customizable enterprises, including enterprises for any industry utilizing control systems or smart-interface systems and/or enterprises that benefit from the implementation of such devices. Examples of such industries include, but are not limited to, automotive industries, avionic industries, hydraulic control industries, auto/video control industries, telecommunications industries, medical industries, special application industries, and electronic consumer device industries. Accordingly, the systems and methods of the present invention provide massive computing power to markets, including markets that have traditionally been untapped by current computer techniques.

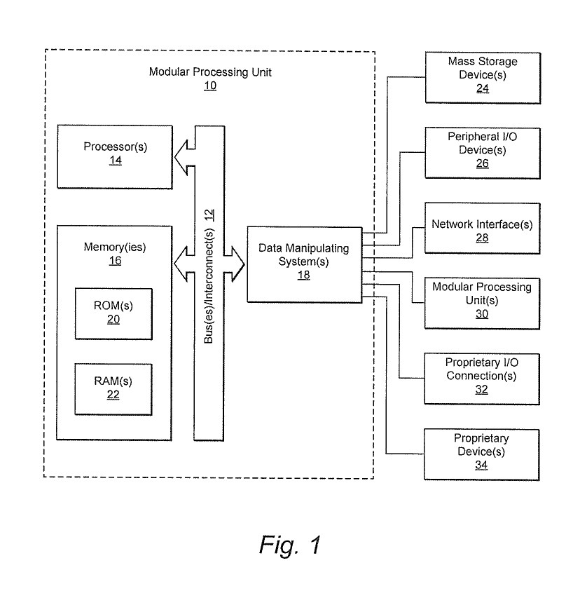

FIG. 1 and the corresponding discussion are intended to provide a general description of a suitable operating environment in accordance with embodiments of the present invention. As will be further discussed below, some embodiments embrace the use of one or more modular processing units in a variety of customizable enterprise configurations, including in a networked or combination configuration, as will be discussed below.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose modular processing unit capable of performing various different functions or one associated with a special-purpose modular processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), any solid state storage device (e.g., flash memory, smart media, etc.), or any other device or component that is capable of providing data or executable instructions that may be accessed by a processing unit.

With reference to FIG. 1, a representative enterprise includes modular processing unit 10, which may be used as a general-purpose or special-purpose processing unit. For example, modular processing unit 10 may be employed alone or with one or more similar modular processing units as a personal computer, a notebook computer, a personal digital assistant (“PDA”) or other hand-held device, a workstation, a minicomputer, a mainframe, a supercomputer, a multi-processor system, a network computer, a processor-based consumer device, a smart appliance or device, a control system, or the like. Using multiple processing units in the same enterprise provides increased processing capabilities. For example, each processing unit of an enterprise can be dedicated to a particular task or can jointly participate in distributed processing.

In FIG. 1, modular processing unit 10 includes one or more buses and/or interconnect(s) 12, which may be configured to connect various components thereof and enables data to be exchanged between two or more components. Bus(es)/interconnect(s) 12 may include one of a variety of bus structures including a memory bus, a peripheral bus, or a local bus that uses any of a variety of bus architectures. Typical components connected by bus(es)/interconnect(s) 12 include one or more processors 14 and one or more memories 16. Other components may be selectively connected to bus(es)/interconnect(s) 12 through the use of logic, one or more systems, one or more subsystems and/or one or more I/O interfaces, hereafter referred to as “data manipulating system(s) 18.” Moreover, other components may be externally connected to bus(es)/interconnect(s) 12 through the use of logic, one or more systems, one or more subsystems and/or one or more I/O interfaces, and/or may function as logic, one or more systems, one or more subsystems and/or one or more I/O interfaces, such as modular processing unit(s) 30 and/or proprietary device(s) 34. Examples of I/O interfaces include one or more mass storage device interfaces, one or more input interfaces, one or more output interfaces, and the like. Accordingly, embodiments of the present invention embrace the ability to use one or more I/O interfaces and/or the ability to change the usability of a product based on the logic or other data manipulating system employed.

The logic may be tied to an interface, part of a system, subsystem and/or used to perform a specific task. Accordingly, the logic or other data manipulating system may allow, for example, for IEEE1394 (firewire), wherein the logic or other data manipulating system is an I/O interface. Alternatively or additionally, logic or another data manipulating system may be used that allows a modular processing unit to be tied into another external system or subsystem. For example, an external system or subsystem that may or may not include a special I/O connection. Alternatively or additionally, logic or other data manipulating system may be used wherein no external I/O is associated with the logic. Embodiments of the present invention also embrace the use of specialty logic, such as for ECUs for vehicles, hydraulic control systems, etc. and/or logic that informs a processor how to control a specific piece of hardware. Moreover, those skilled in the art will appreciate that embodiments of the present invention embrace a plethora of different systems and/or configurations that utilize logic, systems, subsystems and/or I/O interfaces.

As provided above, embodiments of the present invention embrace the ability to use one or more I/O interfaces and/or the ability to change the usability of a product based on the logic or other data manipulating system employed. For example, where a modular processing unit is part of a personal computing system that includes one or more I/O interfaces and logic designed for use as a desktop computer, the logic or other data manipulating system may be changed to include flash memory or logic to perform audio encoding for a music station that wants to take analog audio via two standard RCAs and broadcast them to an IP address. Accordingly, the modular processing unit may be part of a system that is used as an appliance rather than a computer system due to a modification made to the data manipulating system(s) (e.g., logic, system, subsystem, I/O interface(s), etc.) on the back plane of the modular processing unit. Thus, a modification of the data manipulating system(s) on the back plane can change the application of the modular processing unit. Accordingly, embodiments of the present invention embrace very adaptable modular processing units.

As provided above, processing unit 10 includes one or more processors 14, such as a central processor and optionally one or more other processors designed to perform a particular function or task. It is typically processor 14 that executes the instructions provided on computer readable media, such as on memory(ies) 16, a magnetic hard disk, a removable magnetic disk, a magnetic cassette, an optical disk, or from a communication connection, which may also be viewed as a computer readable medium.

Memory(ies) 16 includes one or more computer readable media that may be configured to include or includes thereon data or instructions for manipulating data, and may be accessed by processor(s) 14 through bus(es)/interconnect(s) 12. Memory(ies) 16 may include, for example, ROM(s) 20, used to permanently store information, and/or RAM(s) 22, used to temporarily store information. ROM(s) 20 may include a basic input/output system (“BIOS”) having one or more routines that are used to establish communication, such as during start-up of modular processing unit 10. During operation, RAM(s) 22 may include one or more program modules, such as one or more operating systems, application programs, and/or program data.

As illustrated, at least some embodiments of the present invention embrace a non-peripheral encasement, which provides a more robust processing unit that enables use of the unit in a variety of different applications. In FIG. 1, one or more mass storage device interfaces (illustrated as data manipulating system(s) 18) may be used to connect one or more mass storage devices 24 to bus(es)/interconnect(s) 12. The mass storage devices 24 are peripheral to modular processing unit 10 and allow modular processing unit 10 to retain large amounts of data. Examples of mass storage devices include hard disk drives, magnetic disk drives, tape drives and optical disk drives.

A mass storage device 24 may read from and/or write to a magnetic hard disk, a removable magnetic disk, a magnetic cassette, an optical disk, a solid state storage device (such as a flash memory storage device) or another computer readable medium. Mass storage devices 24 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

Data manipulating system(s) 18 may be employed to enable data and/or instructions to be exchanged with modular processing unit 10 through one or more corresponding peripheral I/O devices 26. Examples of peripheral I/O devices 26 include input devices such as a keyboard and/or alternate input devices, such as a mouse, trackball, light pen, stylus, or other pointing device, a microphone, a joystick, a game pad, a satellite dish, a scanner, a camcorder, a digital camera, a sensor, and the like, and/or output devices such as a monitor or display screen, a speaker, a printer, a control system, and the like. Similarly, examples of data manipulating system(s) 18 coupled with specialized logic that may be used to connect the peripheral I/O devices 26 to bus(es)/interconnect(s) 12 include a serial port, a parallel port, a game port, a universal serial bus (“USB”), a firewire (IEEE 1394), a wireless receiver, a video adapter, an audio adapter, a parallel port, a wireless transmitter, any parallel or serialized I/O peripherals or another interface.

Data manipulating system(s) 18 enable an exchange of information across one or more network interfaces 28. Examples of network interfaces 28 include a connection that enables information to be exchanged between processing units, a network adapter for connection to a local area network (“LAN”) or a modem, a wireless link, or another adapter for connection to a wide area network (“WAN”), such as the Internet. Network interface 28 may be incorporated with or peripheral to modular processing unit 10, and may be associated with a LAN, a wireless network, a WAN and/or any connection between processing units.

Data manipulating system(s) 18 enable modular processing unit 10 to exchange information with one or more other local or remote modular processing units 30 or computer devices. A connection between modular processing unit 10 and modular processing unit 30 may include hardwired and/or wireless links. Accordingly, embodiments of the present invention embrace direct bus-to-bus connections. This enables the creation of a large bus system. It also eliminates hacking as currently known due to direct bus-to-bus connections of an enterprise. Furthermore, data manipulating system(s) 18 enable modular processing unit 10 to exchange information with one or more proprietary I/O connections 32 and/or one or more proprietary devices 34.

Program modules or portions thereof that are accessible to the processing unit may be stored in a remote memory storage device. Furthermore, in a networked system or combined configuration, modular processing unit 10 may participate in a distributed computing environment where functions or tasks are performed by a plurality of processing units. Alternatively, each processing unit of a combined configuration/enterprise may be dedicated to a particular task. Thus, for example, one processing unit of an enterprise may be dedicated to video data, thereby replacing a traditional video card, and provides increased processing capabilities for performing such tasks over traditional techniques.

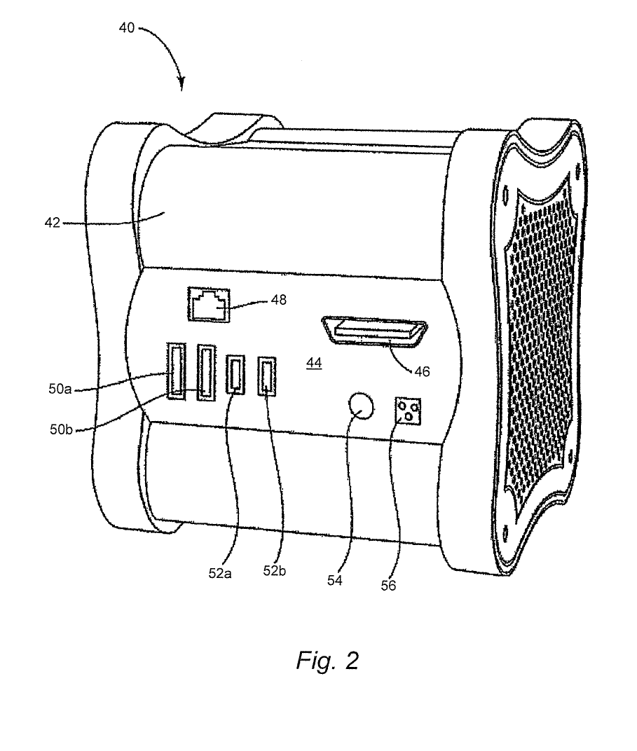

While those skilled in the art will appreciate that embodiments of the present invention may comprise a variety of configurations, reference is made to FIG. 2, which illustrates a representative embodiment of a durable and dynamically modular processing unit. In the illustrated embodiment of FIG. 2, processing unit 40 is durable and dynamically modular. In the illustrated embodiment, unit 40 is a 3½-inch (8.9 cm) cube platform that utilizes an advanced thermodynamic cooling model, eliminating any need for a cooling fan.

However, as provided herein, embodiments of the present invention embrace the use of other cooling processes in addition to or in place of a thermodynamic cooling process, such as a forced air cooling process and/or a liquid cooling process. Moreover, while the illustrated embodiment includes a 3½-inch cube platform, those skilled in the art will appreciate that embodiments of the present invention embrace the use of a modular processing unit that is greater than or less than a ½-inch cube platform. Similarly, other embodiments embrace the use of shapes other than a cube.

Processing unit 40 also includes a layered motherboard configuration, that optimizes processing and memory ratios, and a bus architecture that enhances performance and increases both hardware and software stability, each of which will be further discussed below. Those skilled in the art will appreciate that other embodiments of the present invention also embrace non-layered motherboards. Moreover, other embodiments of the present invention embrace embedded motherboard configurations, wherein components of the motherboard are embedded into one or more materials that provide insulation between components and embed the components into the one or more materials, and wherein one or more of the motherboard components are mechanical, optical, electrical or electro-mechanical. Furthermore, at least some of the embodiments of embedded motherboard configurations include mechanical, optical, electrical and/or electro-mechanical components that are fixed into a three-dimensional, sterile environment. Examples of such materials include polymers, rubbers, epoxies, and/or any non-conducting embedding compound(s).

Embodiments of the present invention embrace providing processing versatility. For example, in accordance with at least some embodiments of the present invention, processing burdens are identified and then solved by selectively dedicating and/or allocating processing power. For example, a particular system is defined according to specific needs, such that dedication or allocation of processing power is controlled. Thus, one or more modular processing units may be dedicated to provide processing power to such specific needs (e.g., video, audio, one or more systems, one or more subsystems, etc.). In some embodiments, being able to provide processing power decreases the load on a central unit. Accordingly, processing power is driven to the areas needed.

While the illustrated embodiment, processing unit 40 includes a 3 GHz processor and 2 GB of RAM, those skilled in the art will appreciate that other embodiments of the present invention embrace the use of a faster or slower processor and/or more or less RAM. In at least some embodiments of the present invention, the speed of the processor and the amount of RAM of a processing unit depends on the nature for which the processing unit is to be used.

A highly dynamic, customizable, and interchangeable backplane 44 provides support to peripherals and vertical applications. In the illustrated embodiment, backplane 44 is selectively coupled to encasement 42 and may include one or more features, interfaces, capabilities, logic and/or components that allow unit 40 to be dynamically customizable. In the illustrated embodiment, backplane 44 includes DVI Video port 46, Ethernet port 48, USB ports 50 (50a and 50b), SATA bus ports 52 (52a and 52b), power button 54, and power port 56. Backplane 44 may also include a mechanism that electrically couples two or more modular processing units together to increase the processing capabilities of the entire system as indicated above, and to provide scaled processing as will be further disclosed below.

Those skilled in the art will appreciate that backplane 44 with its corresponding features, interfaces, capabilities, logic and/or components are representative only and that embodiments of the present invention embrace back planes having a variety of different features, interfaces, capabilities and/or components. Accordingly, a processing unit is dynamically customizable by allowing one back plane to be replaced by another back plane in order to allow a user to selectively modify the logic, features and/or capabilities of the processing unit.

Moreover, embodiments of the present invention embrace any number and/or type of logic and/or connectors to allow use of one or more modular processing units 40 in a variety of different environments. For example, the environments include vehicles (e.g., cars, trucks, motorcycles, etc.), hydraulic control systems, and other environments. The changing of data manipulating system(s) on the back plane allows for scaling vertically and/or horizontally for a variety of environments, as will be further discussed below.

Furthermore, embodiments of the present invention embrace a variety of shapes and sizes of modular processing units. For example, in FIG. 2 modular processing unit 40 is a cube that is smaller than traditional processing units for a variety of reasons.

As will be appreciated by those skilled in the art, embodiments of the present invention are easier to support than traditional techniques because of, for example, materials used, the size and/or shape, the type of logic and/or an elimination of a peripherals-based encasement.

In the illustrated embodiment, power button 54 includes three states, namely on, off and standby for power boot. When the power is turned on and received, unit 40 is instructed to load and boot an operating system supported in memory. When the power is turned off, processing control unit 40 will interrupt any ongoing processing and begin a shut down sequence that is followed by a standby state, wherein the system waits for the power on state to be activated.

USB ports 50 are configured to connect peripheral input/output devices to processing unit 40. Examples of such input or output devices include a keyboard, a mouse or trackball, a monitor, printer, another processing unit or computer device, a modem, and a camera.

SATA bus ports 52 are configured to electronically couple and support mass storage devices that are peripheral to processing unit 40. Examples of such mass storage devices include floppy disk drives, CD-ROM drives, hard drives, tape drives, and the like.

As provided above, other embodiments of the present invention embrace the use of additional ports and means for connecting peripheral devices, as will be appreciated by one of ordinary skill in the art. Therefore, the particular ports and means for connecting specifically identified and described herein are intended to be illustrative only and not limiting in any way.

As provided herein, a variety of advantages exist through the use of a non-peripheral processing unit over larger, peripheral packed computer units. By way of example, the user is able to selectively reduce the space required to accommodate the enterprise, and may still provide increased processing power by adding processing units to the system while still requiring less overall space. Moreover, since each of the processing units includes solid-state components rather than systems that are prone to breaking down, the individual units may be hidden (e.g., in a wall, in furniture, in a closet, in a decorative device such as a clock).

The durability of the individual processing units/cubes allows processing to take place in locations that were otherwise unthinkable with traditional techniques. For example, the processing units can be buried in the earth, located in water, buried in the sea, placed on the heads of drill bits that drive hundreds of feet into the earth, on unstable surfaces in furniture, etc. The potential processing locations are endless. Other advantages include a reduction in noise and heat, an ability to provide customizable “smart” technology into various devices available to consumers, such as furniture, fixtures, vehicles, structures, supports, appliances, equipment, personal items, etc.

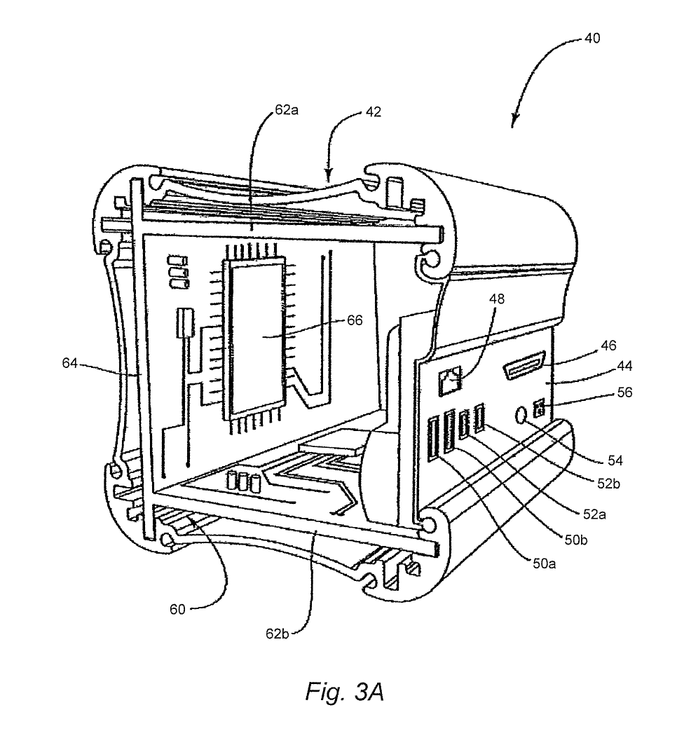

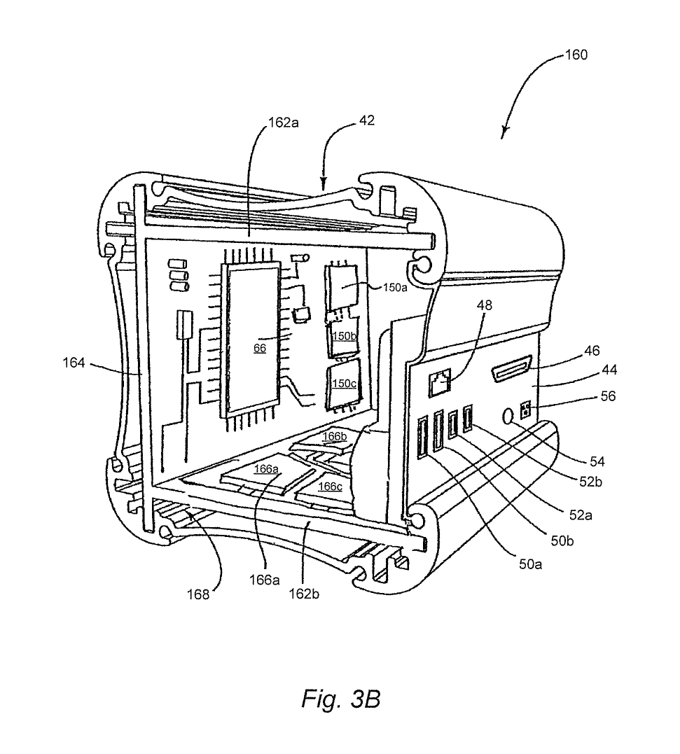

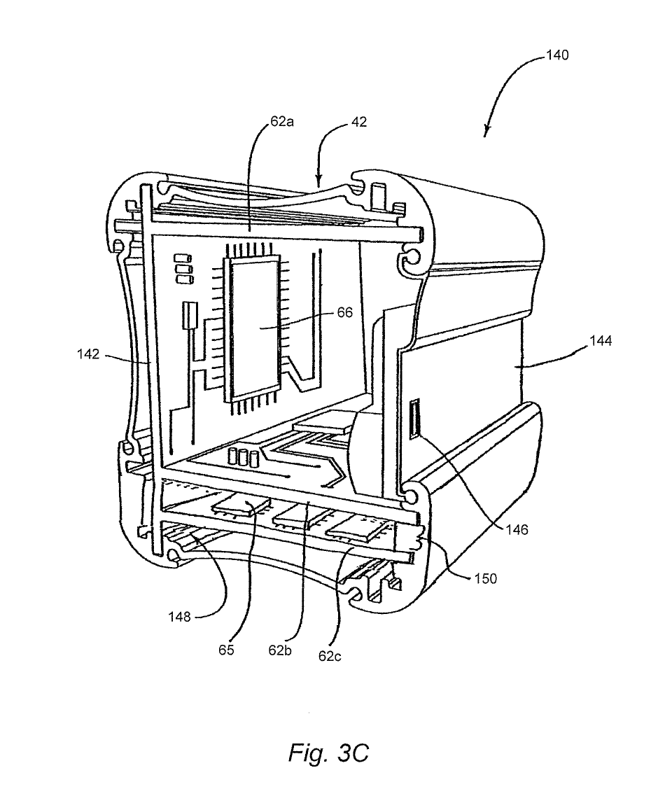

With reference now to FIG. 3A, another view of the embodiment of FIG. 2 is provided, wherein the view illustrates processing unit 40 with the side walls of the cube removed to more fully illustrate the non-peripheral based encasement, cooling process (e.g., thermodynamic convection cooling, forced air, and/or liquid cooling), optimized layered circuit board configuration, and dynamic back plane. In the illustrated embodiment, the various boards are coupled together by using a force fit technique, which prevents accidental decoupling of the boards and enables interchangeability. The boards provide for an enhanced EMI distribution and/or chip/logic placement. Those skilled in the art will appreciate that embodiments of the present invention embrace any number of boards and/or configurations. Furthermore, board structures may be modified for a particular benefit and/or need based on one or more applications and/or features. In FIG. 3A, processing unit 40 includes a layered circuit board/motherboard configuration 60 that includes two parallel sideboards 62 (62a and 62b) and a central board 64 transverse to and electronically coupling sideboards 62. While the illustrated embodiment provides a tri-board configuration, those skilled in the art will appreciate that embodiments of the present invention embrace board configurations having less than three boards, and layered board configurations having more than three boards. Moreover, embodiments of the present invention embrace other configurations of circuit boards, other than boards being at right angles to each other.

In the illustrated embodiment, the layered motherboard 60 is supported within encasement 42 using means for coupling motherboard 60 to encasement 42. In the illustrated embodiment, the means for coupling motherboard 60 to encasement 42 include a variety of channeled slots that are configured to selectively receive at least a portion of motherboard 60 and to hold motherboard 60 in position. As upgrades are necessary with the advancing technology, such as when processor 66 is to be replaced with an improved processor, the corresponding board (e.g., central board 64) is removed from the encasement 42 and a new board with a new processor is inserted to enable the upgrade. Accordingly, embodiments of the present invention have proven to facilitate upgrades as necessary and to provide a customizable and dynamic processing unit.

Processing unit 40 also includes one or more processors that at are configured to perform one or more tasks. In FIG. 3A, the one or more processors are illustrated as processor 66, which is coupled to central board 64. As technology advances, there may be a time when the user of processing unit 40 will want to replace processor 66 with an upgraded processor. Accordingly, central board 64 may be removed from encasement 42 and a new central board having an upgraded processor may be installed and used in association with unit 40. Accordingly, embodiments of the present invention embrace dynamically customizable processing units that are easily upgraded and thus provide a platform having longevity in contrast to traditional techniques.

According to some embodiments a processor cooling system may be attached to the processor 66. A number of devices can be used to cool the processor including a heat sink, fan, combinations thereof, and various other devices known in the art.

Similarly, processing unit 40 can include one or more memory devices (not shown).

Memory may be coupled to an electronic circuit board in various ways, including a memory card removably coupled to a slot on a circuit board or a memory card directly couple to the circuit board. In some embodiments of the present invention, an entire circuit board of a modular motherboard may be substantially dedicated to providing one or more memory devices. As technology advances, there may be a time when the user of processing unit 40 will want to replace a memory device with an upgraded memory device. Accordingly, the circuit board containing the memory device may be removed from encasement 42 and a new circuit board having an upgraded processor may be installed and used in association with unit 40.

The motherboard 60 of the present invention is modular and easily upgradeable. The modular motherboard 60 is comprised of a plurality of electronic circuit boards that makes an integrated logic board equal in ability and performance to that of a non-modular motherboard having the same components. The modular motherboard 60 is composed of several electronic circuit boards 64, 62a, and 62b, which interconnect to form a complete logic board, or motherboard. Thus, each electronic circuit board can be easily removed and replaced without substantially affecting the remaining circuit boards. For example, a user may replace a circuit board 64 having a processor 66 and replace it with another circuit board having a different processor to provide increasing processing power to the processing unit 40.

Each board includes a bus system which connects to the bus system of another circuit board. The bus system provides electronic communication between the interconnected circuit boards forming the modular motherboard 60. The modular motherboard can be comprised of any number of circuit boards. For example, in one embodiment, a motherboard includes four circuit boards, each having a particular function, such as processing, providing memory, providing storage, and providing BIOS. In another embodiment, a circuit board has more than one function, such as processing and memory capabilities. In another embodiment, a single function is performed by more than one circuit board. Additional functions performed by individual circuit boards include, but are not limited to, providing a clock generator, providing a cooling system, and other motherboard functions as understood by those of skill in the art.

The modular motherboard 60 provides a number of advantages over single-circuit-board motherboards. For example, when the modular motherboard 60 doesn't support a specific component, a user need only replace a single circuit board with a compatible circuit board rather than replacing the entire motherboard. Additionally, a modular motherboard is not constrained to a two-dimensional area like single-circuit-board motherboards. As such, the modular mother board 60 may be configured to fit within smaller, three-dimensional encasements. For example, where the modular motherboard includes four circuit boards, the boards can be configured to utilize one fourth the footprint area used by an equivalent single-circuit-board motherboard. Finally, a modular motherboard 60 is easily scalable. For example, a user may easily attach an additional circuit board (not shown) to the preexisting motherboard configuration to scale the processing power of the whole structure. One of skill in the art will appreciate that the modular motherboard 60 provides an unlimited number of advantages when used in conjunction with specific applications and computer systems.

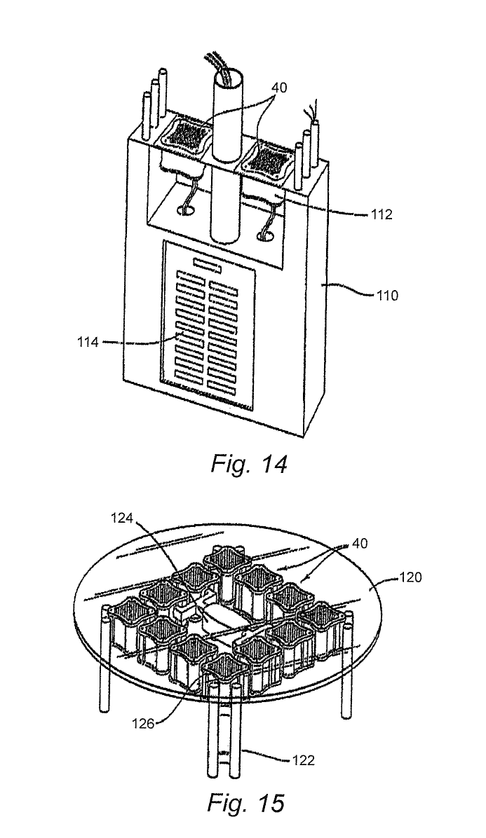

According to some embodiments of the processing unit of the present invention one or more electronic storage devices are included with the modular motherboard. The addition of electronic storage, such as a mass storage device, has the ability to enhance the processing and computing abilities of the processing unit. For example, a processing unit with electronic storage capacity can be used as a personal computer by merely attaching the essential peripheral devices, such as a monitor, mouse, and keyboard. Also a processing unit with electronic storage capacity can be effective and useful as an engine that drives and controls the operation of a component, structure, assembly, equipment module, as shown in FIGS. 14-16. For example a processing unit may store a digital log of the functions or performance of equipment in electronic storage. In another example, a processing unit may control both a stereo system and store a user's digital music library.

Referring now to FIG. 3B, another embodiment of the present invention is provided, wherein the view illustrates processing unit 160 with the side walls of the cube removed to more fully illustrate the non-peripheral based encasement, a plurality of layered circuit boards, and dynamic backplane 44. The layered circuit boards include two parallel sideboards 162 (162a and 162b) and a central board 164 transverse to and electronically coupling sideboards 162a and 162b.

In the embodiment of FIG. 3B, the central board 164 includes a processor 66 and memory devices 150a, 150b, and 150c, and sideboard 162b includes a plurality of electronic storage devices 166a, 166b, and 166c. As described above, the motherboard 168 is easily upgraded by removing a sideboard 162 or the central board 164 and replacing them with another circuit board. In another embodiment, boards are replaced with upgraded boards with improved abilities. A user interchanges one or more circuit boards 162a, 162b, or 164 to decrease the processing power, available memory, storage capacity, or other properties of the processing unit 160. Such upgrades or downgrades are possible and easily accomplished with the modular motherboard.

Various types of electronic storage devices can be utilized with the present processing unit 160. For example, solid state memory, such as flash memory, provides a number of benefits to modular processing units. Solid state memory uses low levels of power, which result in low levels of heat dissipations. As such, it is possible for one or more such solid state storage devices to be included in a relatively small processing unit 160 without substantially increasing the heat dissipated by the unit. For example, in one particular embodiment a sideboard 162b includes a plurality of flash memory storage devices 166a, 166b, and 166c that together provide 128 Gb of data storage. As configured, these storage devices uses less than five watts of energy, which will create minimal heat that is easily dissipate into the environment through natural convection, or another cooling method.

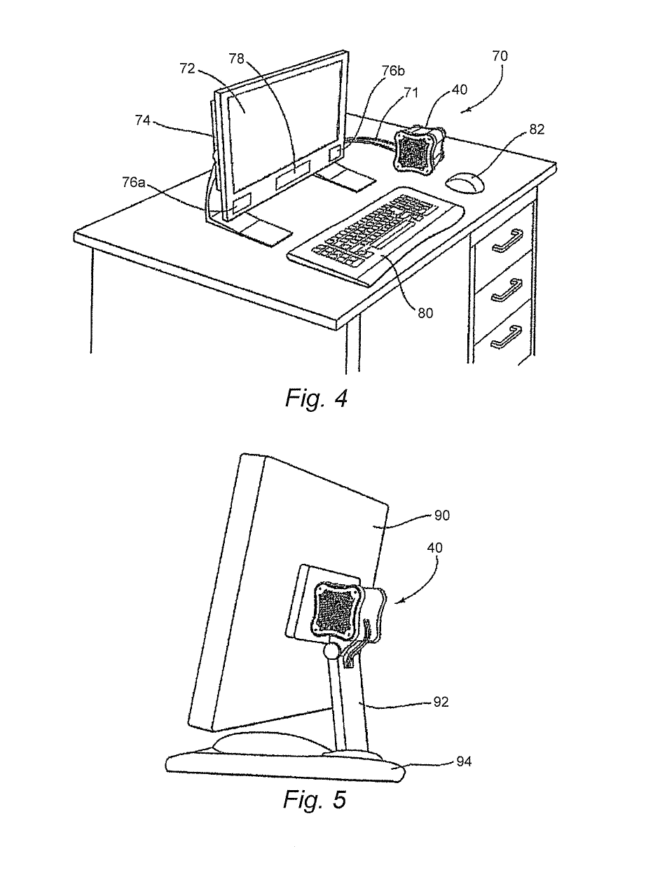

With reference now to FIG. 3C, another embodiment of the present invention is provided, wherein the view illustrates processing unit 140. Processing unit 140 includes an encasement, a modular motherboard 148, and a dynamic backplane 144. In this embodiment the modular motherboard 148 includes three parallel sideboards 62a, 62b, and 62c and a central board 142 transverse to and electronically coupling sideboards 62. Unlike the three-board configuration of FIGS. 3 and 4, the four-board configuration includes a third parallel sideboard 62c. The third parallel sideboard is configured beneath and parallel to sideboard 62b. One of skill in the art will appreciate that the four circuit boards may be configured in a variety of orientations. In some embodiment, a four-board configuration may be configured to positioning hot components strategically for maximum heat dissipation.

According to one embodiment encasement 42 is elongated to accommodate fourth sideboard 62c. In another embodiment, central board 142 is elongated to accommodate fourth sideboard 62c. In yet another embodiment, sideboard 62b is repositioned along central board 142 and sideboard 62c is positioned below it (as shown in FIG. 5) to accommodate fourth sideboard 62c. In yet another embodiment, the encasement can be elongated to accommodate fourth sideboard 62c.

The increased number of circuit boards in the four-board configuration provides additional surface area on the modular motherboard 148 for computer components. In one embodiment, the additional surface area provided by the four-board configuration is used for additional components, such as additional memory devices or an additional processor. As previously explained, storage devices utilize relatively low levels of energy and thus dissipate relatively low levels of heat. Thus, in some embodiments, a storage device is stored in relative proximity to other computer components without producing damaging heat or requiring a designated cooling device.

In one embodiment, one or more of the circuit boards in the four-board configuration includes a storage device 65 that provide electronic storage capabilities to the processing unit 140. In another embodiment, the storage device 65 is a solid state storage device, such as a flash memory device or another similar storage device. In another embodiment, an entire sideboard 62c is substantially dedicated to electronic storage, such as one or more flash memory device(s). Due to the relatively low levels of heat dissipated from the solid state storage devices the gap 150 between sideboard 62c and sideboard 62b is narrow and compact. Thus, the relative size of a processing unit 140 is relatively similar or equal to the size of a processing unit that doesn't include an electronic storage device.

The storage device 65 or plurality of storage devices may provide the processing unit 140 with sufficient electronic storage for it to perform one or more designated functions. According to one embodiment, the one or more storage device(s) may provide sufficient electronic storage to use the processing unit 140 as a personal computer. For example, a plurality of storage devices 65 are includes on sideboard 62c which may provide the processing unit between 16 Gb and 256 Gb of electronic storage. In another embodiment, the storage device 65 provides only 256 Mb of electronic storage, and the processing unit 140 is utilized to control the functions of home appliance.

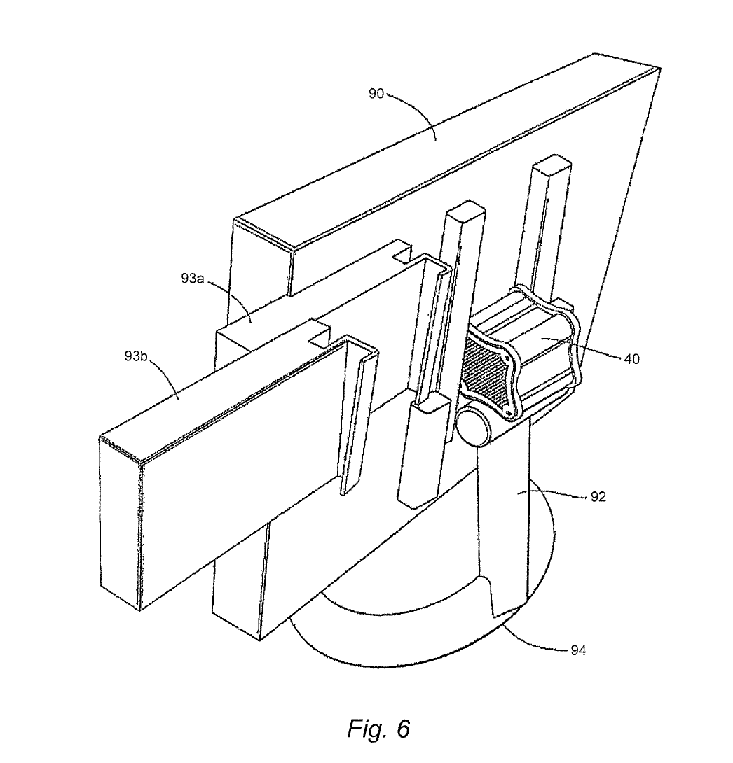

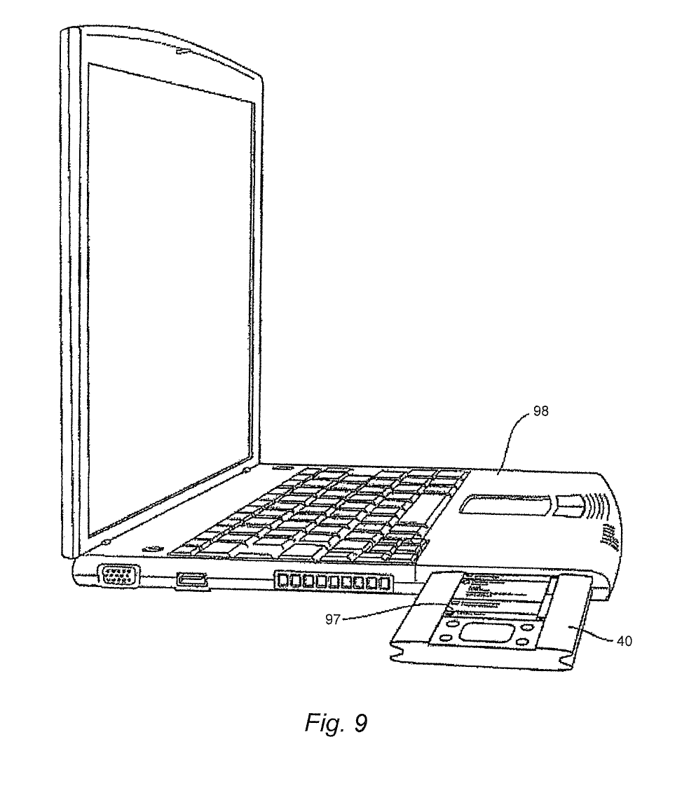

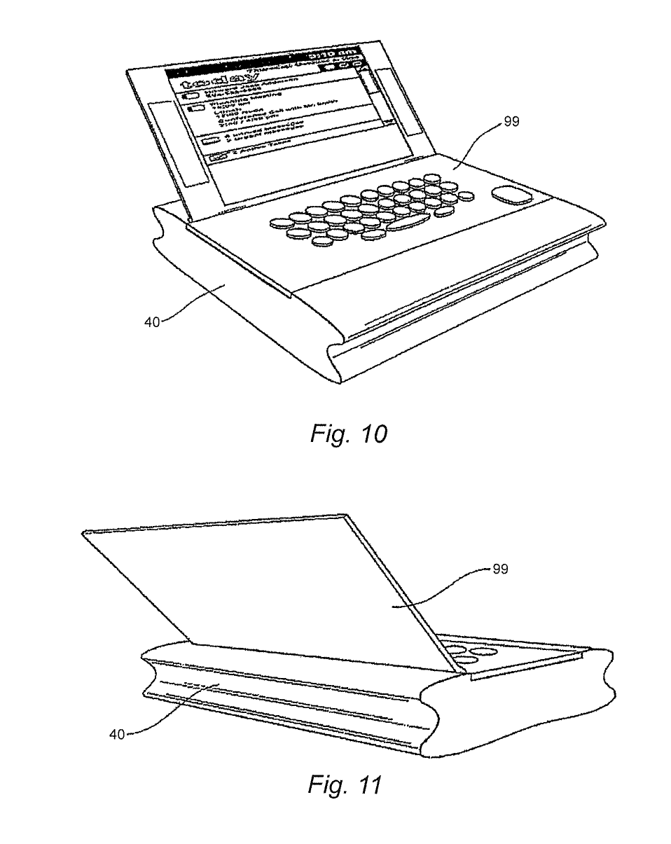

In the illustrated embodiment, the dynamic backplane 144 includes a single port 146. It will be understood that any number of ports, buttons, switches, or other like components may be included in the dynamic backplane 144. For example, in one embodiment the dynamic backplane can have wireless communication capabilities. In another embodiment, the dynamic backplane 144 includes only a single port which may be configured to connect to a number of external devices. In one embodiment, the single port 146 is configured to connect to a power supply, a personal computer, a computer server, a docking station, or other external device as will be understood by one of skill in the art. Finally, in one embodiment, single port 146 is a proprietary port that connects to a proprietary docking station. Representative devices that can function as docking stations are shown in FIGS. 6 and 9.

With reference now to FIG. 4, a representative enterprise 70 is illustrated, wherein a dynamically modular processing unit 40 having a non-peripheral based encasement, is employed alone in a personal computing enterprise. In the illustrated embodiment, processing unit 40 includes power connection 71 and employs wireless technology with the peripheral devices of enterprise 70. The peripheral devices include monitor 72 having hard disk drive 74, speakers 76, and CD ROM drive 78, keyboard 80 and mouse 82. Those skilled in the art will appreciate that embodiments of the present invention also embrace personal computing enterprises that employ technologies other than wireless technologies.

Processing unit 40 is the driving force of enterprise 70 since it provides the processing power to manipulate data in order to perform tasks. The dynamic and customizable nature of the present invention allows a user to easily augment processing power. In the present embodiment, processing unit 40 is a 3½ inch (8.9 cm) cube that utilizes thermodynamic cooling and optimizes processing and memory ratios. However, as provided herein, embodiments of the present invention embrace the use of other cooling processes in addition to or in place of a thermodynamic cooling process, such as a forced air cooling process and/or a liquid cooling process. Furthermore, while the illustrated embodiment includes a 3½ inch cube platform, those skilled in the art will appreciate that embodiments of the present invention embrace the use of a modular processing unit that is greater than or less than a 3½ inch cube platform. Similarly, other embodiments embrace the use of shapes other than a cube.

In particular, processing unit 40 of the illustrated embodiment includes a 3 GHz processor, 2 G RAM, a 512 L2 cache, and wireless networking interfaces. So, for example, should the user of enterprise 70 determine that increased processing power is desired for enterprise 70, rather than having to purchase a new system as is required by some traditional technologies, the user may simply add one or more modular processing units to enterprise 70. The processing units/cubes may be selectively allocated by the user as desired for performing processing. For example, the processing units may be employed to perform distributive processing, each unit may be allocated for performing a particular task (e.g., one unit may be dedicated for processing video data, or another task), or the modular units may function together as one processing unit.

While the present example includes a processing unit that includes a 2 GHz processor, 1.5 G RAM, and a 512 L2 cache, those skilled in the art will appreciate that other embodiments of the present invention embrace the use of a faster or slower processor, more or less RAM, and/or a different cache. In at least some embodiments of the present invention, the capabilities of the processing unit depend on the nature for which the processing unit will be used.

While FIG. 4 illustrates processing unit 40 on top of the illustrated desk, the robust nature of the processing unit/cube allows for unit 40 to alternatively be placed in a non-conspicuous place, such as in a wall, mounted underneath the desk, in an ornamental device or object, etc. Accordingly, the illustrated embodiment eliminates traditional towers that tend to be kicked and that tend to produce sound from the cooling system inside of the tower. No sound is emitted from unit 40 as all internal components are solid states when convection cooling or liquid cooling is employed.

With reference now to FIG. 5, another example is provided for utilizing a modular processing unit in a computing enterprise. In FIG. 5, an ability of modular processing unit 40 to function as a load-bearing member is illustrated. For example, a modular processing unit may be used to bridge two or more structures together and to contribute to the overall structural support and stability of the structure or enterprise. In addition, a modular processing unit may bear a load attached directly to a primary support body. For example, a computer screen or monitor may be physically supported and the processing controlled by a modular processing unit. In the illustrated embodiment, monitor 90 is mounted to modular processing unit 40, which is in turn mounted to a stand 92 having a base 94.

With reference now to FIG. 6, another representative enterprise is illustrated, wherein a dynamically modular processing unit 40 having a non-peripheral based encasement, is employed computing enterprise. In FIG. 6, the representative enterprise is similar to the embodiment illustrated in FIG. 5, however one or more modular peripherals are selectively coupled to the enterprise. In particular, FIG. 6 illustrates mass storage devices 93 that are selectively coupled to the enterprise as peripherals. Those skilled in the art will appreciate that any number (e.g., less than two or more than two) and/or type of peripherals may be employed. Examples of such peripherals include mass storage devices, I/O devices, network interfaces, other modular processing units, proprietary I/O connections; proprietary devices, and the like.

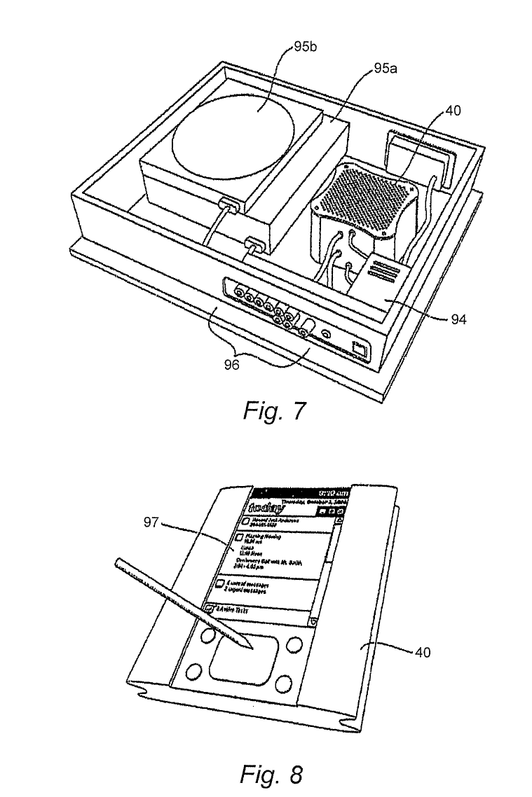

With reference now to FIG. 7, another representative embodiment is illustrated, wherein a dynamically modular processing unit 40 having a non-peripheral based encasement, is employed in an enterprise. In accordance with at least some embodiments of the present invention, a modular processing unit having a non-peripheral based encasement may be employed in a central processing unit or in other electronic devices, including a television, a stereo system, a recording unit, a set top box, or any other electronic device. Accordingly, the modular processing unit may be selectively used to in the enterprise to monitor, warn, inform, control, supervise, record, recognize, etc. In FIG. 7, modular processing unit is coupled to a power source 94, one or more other peripherals 95, and connections 96 for use in the enterprise.

As provided herein, embodiments of the present invention embrace a variety of shapes and sizes for a modular processing unit. With reference now to FIG. 8, a modular processing unit 40 is illustrated that is employed as a hand-held computing enterprise, such as a personal digital assistant (“PDA”). An I/O peripheral 97 is coupled to the modular processing unit 40. In the illustrated embodiment, the I/O peripheral 97 includes a monitor and a stylus to enable input and output. Those skilled in the art will appreciate that additional peripherals may be included, such as speakers, a microphone, a cellular telephone, keyboard, or any other type of peripheral, representative examples of such will be provided below.

In the embodiment of FIG. 8, the hand-held computing enterprise has the dimensions of 3.5″×4.75″×0.75″, however those skilled in the art will appreciate that the present invention also embraces embodiments that are larger or smaller than the illustrated embodiment. In FIG. 8, the I/O peripheral 97 is a slide on pieces that is selectively coupled to modular processing unit 40, which includes a non-layered board design to allow unit 40 to be more slender. Additional peripherals include a power source and mass storage device. In one embodiment, the mass storage device is a 40 G hard drive that enables the user to always have all of his/her files. Accordingly, the embodiment of FIG. 8 enables a user to employ a complete computer in the palm of his/her hand. Moreover, because of the solid state components, the embodiment of FIG. 8 is more durable than traditional techniques. Furthermore, in at least some embodiments, the casing includes metal to increase the durability. Accordingly, if unit 40 is dropped, the core will not be broken.

With reference now to FIG. 9, another representative enterprise is illustrated that includes a dynamically modular processing unit 40 having a non-peripheral based encasement. In FIG. 9, processing unit 40, having an I/O peripheral 97, is selectively coupled to peripheral 98 to allow the representative enterprise to function as a high-end laptop computer. Utilizing a liquid cooling technique, for example, processing unit 40 can be a very powerful handheld machine. And, as illustrated in FIG. 9, unit 40 may be selectively inserted like a cartridge into a large I/O peripheral 98, which includes a keyboard, monitor, speakers, and optionally logic depending on end user application. Once unit 40 is decoupled/ejected from peripheral 98, unit 40 can retain the files to allow the user to always have his/her files therewith. Accordingly, there is no need to synchronize unit 40 with peripheral 98 since unit 40 includes all of the files. While the embodiment illustrated in FIG. 9 includes one modular processing unit, other embodiments of the present invention embrace the utilization of multiple processing units.

Similarly, modular processing unit 40 may be inserted or otherwise coupled to a variety of other types of peripherals, including an enterprise in a vehicle, at home, at the office, or the like. Unit 40 may be used to preserve and provide music, movies, pictures or any other audio and/or video.

With reference now to FIGS. 10-11, another representative enterprise is illustrated, wherein a dynamically modular processing unit 40 having a non-peripheral based encasement, is employed in a personal computing enterprise. In FIGS. 10-11, modular processing unit 40 is coupled to a flip top peripheral 99, which includes a monitor, thumb keyboard and mouse device. The flip top peripheral 99 runs at full speeds with a hand top computer to do spreadsheets, surf the internet, and other functions and/or tasks. The embodiment illustrated in FIGS. 10-11 boots a full version of an operating system when the flip top is open. In another embodiment, flip top peripheral 99 and I/O peripheral 97 are simultaneously coupled to the same modular processing device such that the enterprise boots a full version of an operating system when the flip top is open and runs a modified version when closed that operates on minimal power and processing power.

In further embodiments, modular processing units are employed as MP3 players and/or video players. In other embodiments, a camera is employed as a peripheral and the images/video are preserved on the modular processing unit.

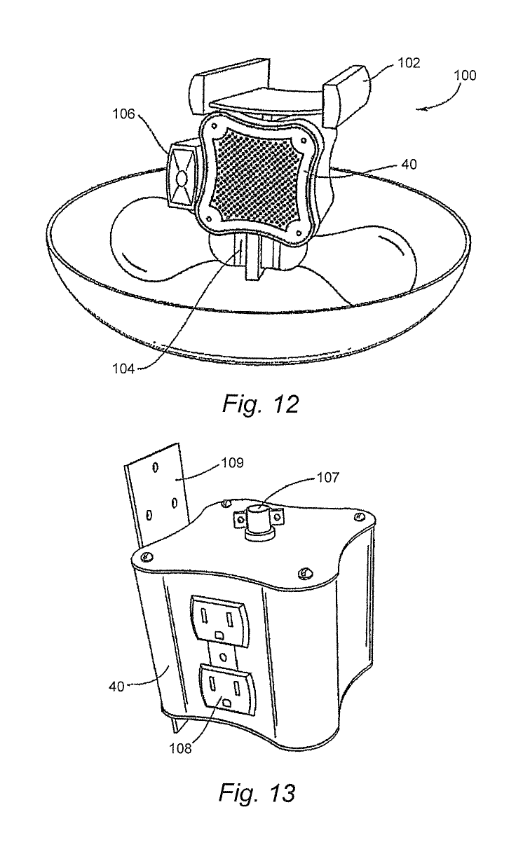

As provided above, embodiments of the present invention are extremely versatile. As further examples, processing control unit 40 may be used to physically support and/or provide processing to various fixtures or devices, such a lighting fixture (FIG. 12), an electrical outlet (FIG. 13), or a breaker box (FIG. 14). As provided herein, at least some embodiments of the present invention embrace a modular processing unit that functions as an engine that drives and controls the operation of a variety of components, structures, assemblies, equipment modules, etc.

With reference now to FIG. 12, a representative enterprise is illustrated wherein a dynamically modular processing unit is employed in a representative consumer electrical device. In FIG. 12, modular processing unit 40 is incorporated a lighting fixture 100. For example, modular processing unit 40 may be used to control the on/off, dimming, and other attributes of lighting fixture 100, such as monitoring the wattage used by the bulb and alerting a control center of any maintenance required for lighting fixture 100 or any other desirable information. In the illustrated embodiment, modular processing unit 40 is mounted to a ceiling structure via slide-on mounting bracket 102 and to lighting fixture 100 using a mounting bracket slide-on lighting module 104 that is slid into slide receivers (not shown) located in the primary support body of modular processing unit 40. Lighting module 104 may support one or more light bulbs and a cover as shown. In the illustrated embodiment, modular processing unit 40 is also mounted to a slide on dimmer 194.

With reference to FIG. 13, a representative enterprise is illustrated, wherein a dynamically modular processing unit 40 having a non-peripheral based encasement is employed in another representative electrical device, wherein the representative device is an electrical outlet or plug that is used for 802.11x distribution. In FIG. 13, modular processing unit 40 is coupled to an AC interface 107, AC plug peripheral 108, and mounting bracket 109. AC plug peripheral 108 and mounting bracket 109 are slide-on peripherals. Modular processing unit 40 is powered by the ac distribution into unit 40 and is used as a smart plug to monitor, control, oversee, and/or allocate power distribution.

In one embodiment, unit 40 is utilized as a router. In another embodiment, unit 40 is employed as a security system. In another embodiment, unit 40 monitors electrical distribution and disconnects power as needed to ensure safety. For example, unit 40 is able to detect is an individual has come in contact with the electrical distribution and automatically shuts off the power. In some embodiments, technologies, such as X10 based technologies or other technologies, are used to connect multiple enterprises, such as the one illustrated in FIG. 13, over copper wire lines. In further embodiments, the multiple enterprises exchange data over, for example, a TCP/IP or other protocol.

Accordingly, embodiments of the present invention embrace the utilization of a modular processing unit in association with a mundane product to form a smart product. Although not exhaustive, other examples of products, systems and devices with a modular processing unit may be used to provide a smart product, system and/or device include a heating system, a cooling system, a water distribution system, a power distribution system, furniture, fixtures, equipment, gears, drills, tools, buildings, artificial intelligence, vehicles, sensors, video and/or audio systems, security systems, and many more products, systems and/or devices.

For example, a modular processing unit in association with a furnace may be used to control the efficiency of the furnace system. If the efficiency decreases, the modular processing unit may be programmed to provide the owner of the building, for example in an email communication, to change filters, service the system, identify a failure, or the like. Similarly, a modular processing unit may be used in association with a water supply to monitor the purity of the water and provide a warning in the event of contamination. Similarly, appliances (e.g., washers, dryers, dishwashers, refrigerators, and the like) may be made smart when used in association with a modular processing unit. Furthermore, the modular processing units may be used in association with a system that provides security, including detecting carbon monoxide, anthrax or other biological agents, radiological agents, or another agent or harmful substance. Moreover, due to the stability and versatility of the processing units, the modular processing units may be placed in locations previously unavailable. In at least some embodiments, the use of a modular processing unit with a super structure allows the modular processing unit to take on qualities of the super structure.

With reference now to FIG. 14, a representative enterprise is illustrated wherein one or more dynamically modular processing units are employed in another representative device, namely a voltage monitoring breaker box. In the illustrated embodiment, modular processing units 40 are used to transform a standard breaker box 114 into a voltage monitoring breaker box 110. Dual redundant modular processing units 40 function to process control breaker box 110 and monitor the voltage, in real-time, existing within breaker box 110 and throughout the house. Attached to each modular processing unit 40 is a voltage monitoring back plate 112, which attach using slide receivers. While the illustrated embodiment provides two modular processing units, those skilled in the art will appreciate that other embodiments embrace the use of one modular processing units or more than two processing units.

With reference now to FIG. 15, another representative enterprise is illustrated wherein one or more dynamically modular processing units are employed in a representative device. In FIG. 15, modular processing units 40 are used in a load-bearing configuration of a table assembly 120, which employs slide-on leg mounts 122 that couple to respective slide receivers on corresponding modular processing units 40 to comprise the legs of table assembly 120. In the illustrated configuration, a plurality of modular processing units 40 is physically and electronically coupled together, and comprises the primary physical structure of table assembly 120. Also shown is a slide-on DVD and hard drive module 124 that allow table assembly 120 to perform certain functions. Also illustrated is a plurality of modular processing unit bearing connectors 126.

These illustrations are merely representative of the capabilities of one or more modular processing units in accordance with embodiments of the present invention. Indeed, one of ordinary skill in the art will appreciate that embodiments of the present invention embrace many other configurations, environments, and set-ups, all of which are intended to be within the scope of embodiments of the present invention.

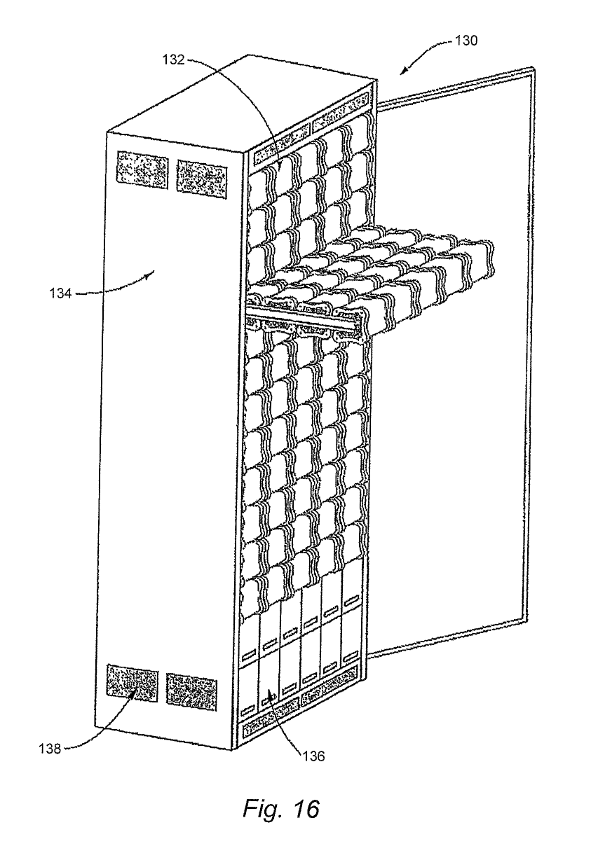

As provided herein, the dynamic and modular nature of the processing units allow for one or more processing units that may be used with all types of enterprises. With reference now to FIG. 16, enterprise 130 is a server array that is configured for server clustering and includes multiple dynamically modular processing units 132, each having a non-peripheral based encasement, which are housed in cabinet 134 and are available for use in processing data. In the illustrated embodiment, cabinet 134 includes drawers that receive modular processing units 132. Enterprise 130 further includes mass storage devices 136 for preserving data.

While FIG. 16 illustrates a cabinet that includes drawers configured to receive the individual processing units/cube, other embodiments of the present invention include the use of mounting brackets that may be used in association with processing units/cubes to mount the units/cubes onto the bars or drawers. The illustrated embodiment further includes a cooling system (not show) that allows for temperature control inside of cabinet 134, and utilizes vents 138.

In some embodiments, the cabinet is provided on wheels to allow for mobility of the cabinet as needed. In some embodiments, an air conditioning unit is included in combination with the cabinet to maintain the temperature of the inside of the cabinet at a desired temperature range. In some embodiments, the air conditioning unit is coupled to the cabinet and is mobile along with the cabinet. In some embodiments, the cabinet includes a drive mechanism to allow for ease in moving the cabinet as needed. In some embodiments, the processing units within the cabinet are used for processing and/or storing data.

The modular nature of the processing units/cubes is illustrated by the use of the processing units in the various representative enterprises illustrated. Embodiments of the present invention embrace chaining the units/cubes in a copper and/or fiber channel design, coupling the cubes in either series or parallel, designating individual cubes to perform particular processing tasks, and other processing configurations and/or allocations.

Each unit/cube includes a completely re-configurable motherboard. In one embodiment, the one or more processors are located on the back plane of the motherboard and the RAM modules are located on planes that are transverse to the back plane of the motherboard. In a further embodiment, the modules are coupled right to the board rather than using traditional sockets. The clock cycle of the units are optimized to the RAM modules.

While one method for improving processing powering an enterprise includes adding one or more additional processing units/cubes to the enterprise, another method includes replacing planes of the motherboard of a particular unit/cube with planes having upgraded modules. Similarly, the interfaces available at each unit/cube may be updated by selectively replacing a panel of the unit/cube. Moreover, a 32-bit bus can be upgraded to a 64-bit bus, new functionality can be provided, new ports can be provided, a power pack sub system can be provided/upgraded, and other such modifications, upgrades and enhancements may be made to individual processing units/cubes by replacing one or more panels.

The following description of operating environments should be understood to be illustrative of the types of environments in which embodiments of the invention may be utilized and implemented, and it is not intended that all embodiments of the invention include every feature discussed herein or be utilized in environments containing every feature discussed herein. The following is therefore intended to assist in understanding the various embodiments of the invention only.

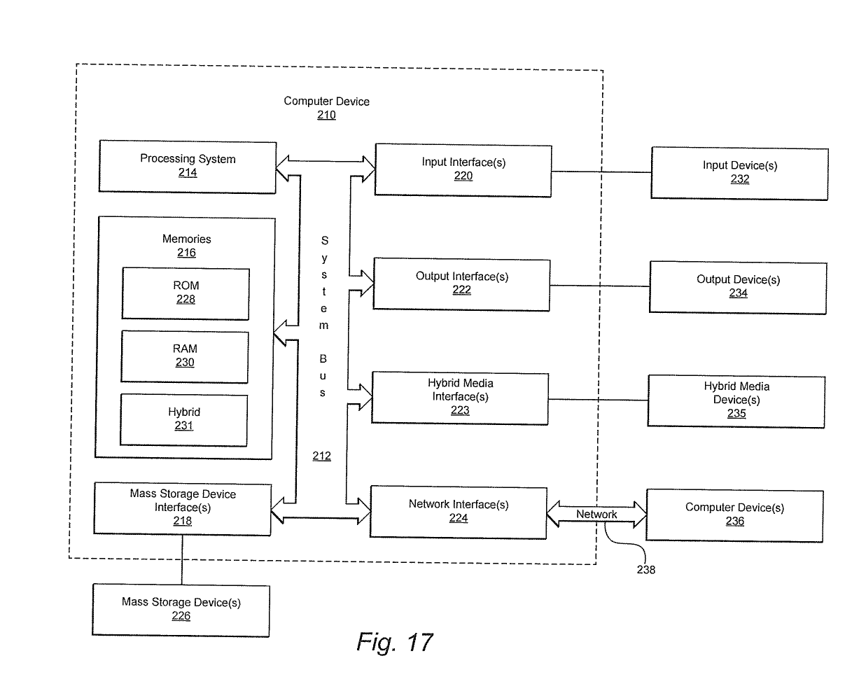

FIG. 17 and the corresponding discussion are intended to provide a general description of a suitable operating environment in which embodiments of the invention may be implemented, taken in conjunction with the disclosure of the related applications incorporated herein by reference. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 17, a representative system for implementing embodiments of the invention includes computer device 210, which may be a general-purpose or special-purpose computer or any of a variety of consumer electronic devices. For example, computer device 210 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, a modular computer as disclosed in the related applications or the like.

Computer device 210 includes system bus 212, which may be configured to connect various components thereof and enables data to be exchanged between two or more components. System bus 212 may include one of a variety of bus structures including a memory bus or memory controller, a peripheral bus, or a local bus that uses any of a variety of bus architectures. Typical components connected by system bus 212 include processing system 214 and memories 216. Other components may include one or more mass storage device interfaces 218, input interfaces 220, output interfaces 222, and/or network interfaces 224, each of which will be discussed below.

Processing system 214 includes one or more processors, such as a central processor and optionally one or more other processors designed to perform a particular function or task. It is typically processing system 214 that executes the instructions provided on computer-readable media, such as on memories 216, a magnetic hard disk, a removable magnetic disk, a magnetic cassette, an optical disk, or from a communication connection, which may also be viewed as a computer-readable medium.

Memories 216 includes one or more computer-readable media that may be configured to include or includes thereon data or instructions for manipulating data, and may be accessed by processing system 214 through system bus 212. Memories 216 may include, for example, ROM 228, used to permanently store information, RAM 230, used to temporarily store information, and/or hybrid memories 231. ROM 228 may include a basic input/output system (“BIOS”) having one or more routines that are used to establish communication, such as during start-up of computer device 210. RAM 230 may include one or more program modules, such as one or more operating systems, application programs, and/or program data. Hybrid memories 231 may have features and capabilities hybridized from those of ROM 228 and RAM 230.

One or more mass storage device interfaces 218 may be used to connect one or more mass storage devices 226 to system bus 212. The mass storage devices 226 may be incorporated into or may be peripheral to computer device 210 and allow computer device 210 to retain large amounts of data. Optionally, one or more of the mass storage devices 226 may be removable from computer device 210. Examples of mass storage devices include hard disk drives, magnetic disk drives, tape drives, solid state drives/flash drives and optical disk drives. A mass storage device 226 may read from and/or write to a magnetic hard disk, a removable magnetic disk, a magnetic cassette, an optical disk, or another computer-readable medium. Mass storage devices 226 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 220 may be employed to enable a user to enter data and/or instructions to computer device 210 through one or more corresponding input devices 232. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 220 that may be used to connect the input devices 232 to the system bus 212 include a serial port, a parallel port, a game port, a universal serial bus (“USB”), an integrated circuit, a firewire (IEEE 1394), or another interface. For example, in some embodiments input interface 220 includes an application specific integrated circuit (ASIC) that is designed for a particular application. In a further embodiment, the ASIC is embedded and connects existing circuit building blocks.

One or more output interfaces 222 may be employed to connect one or more corresponding output devices 234 to system bus 212. Examples of output devices include a monitor or display screen, a speaker, a printer, a multi-functional peripheral, and the like. A particular output device 234 may be integrated with or peripheral to computer device 210. Examples of output interfaces include a video adapter, an audio adapter, a parallel port, and the like.

One or more hybrid media interfaces 223 may be employed to connect one or more hybrid media devices 235 to the system bus 212. A hybrid media interface 223 may include multiple single input/output ports and/or buses combined on a single connector to provide added value. Non-limiting examples of the types of ports/buses that can be combined in the hybrid media interface(s) 223 and/or associated buses/ports include PCIe, I²C, power, a proprietary secure bus, SATA, USB, and the like. The hybrid media devices 235 so connected to the computer device 210 may include a variety of peripheral devices, storage systems, PCIe devices, USB devices, SATA devices and the like.

One or more network interfaces 224 enable computer device 210 to exchange information with one or more other local or remote computer devices, illustrated as computer devices 236, via a network 238 that may include hardwired and/or wireless links. Examples of network interfaces include a network adapter for connection to a local area network (“LAN”) or a modem, wireless link, or other adapter for connection to a wide area network (“WAN”), such as the Internet. The network interface 224 may be incorporated with or peripheral to computer device 210. In a networked system, accessible program modules or portions thereof may be stored in a remote memory storage device. Furthermore, in a networked system computer device 210 may participate in a distributed computing environment, where functions or tasks are performed by a plurality of networked computer devices.

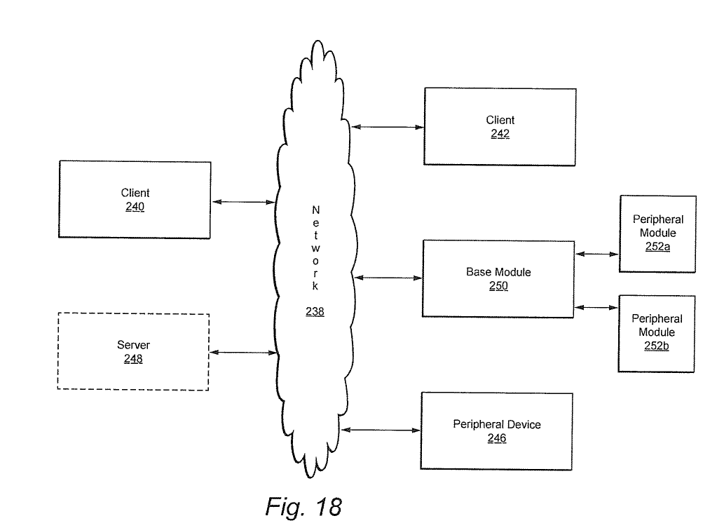

Thus, while those skilled in the art will appreciate that embodiments of the present invention may be practiced in a variety of different environments with many types of system configurations, FIG. 18 provides a representative networked system configuration that may be used in association with embodiments of the present invention. The representative system of FIG. 18 includes a computer device, illustrated as client 240, which is connected to one or more other computer devices (illustrated as client 242 and base module 250) and one or more peripheral devices 246 across network 238. While FIG. 18 illustrates an embodiment that includes a client 240, one additional client, client 242, one base module 250, one peripheral device 246, and optionally a server 248, which may be a print server or other server device, connected to network 238, alternative embodiments include more or fewer clients, more base modules 250, more than one peripheral device, no peripheral devices, no server 248, and/or more than one server 248 connected to network 238. Where a base module such as base module 250 is present, including instances where one of the client 240 or the client 242 is a base module, the base module 250 may be connected to one or more peripheral modules 252, as will be discussed in more detail below. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

### Distribution of Base Module Processing Power through the Peripheral Module(s)

The peripheral module is made up of a small processor, memory (e.g. RAM), and is basically a very small computer that is very light and performs very little local processing other than managing the connection back to the base module and manage whatever the medium is for transferring files to and from it. It does not necessarily have any drives hooked to it and does not have any internal drives. It is basically similar to a system on a chip (SOC), but it is broken out and has a basic/small processor, memory/RAM, and flash memory (providing enough non-volatile software capacity to establish the functionality discussed herein) working together to be a small computer. In comparison with today's “thin” clients, the processing power of the peripheral module may effectively be so small that they may be referred to in comparison as “zero” modules or “zero” clients.

The specific protocol used for the peripheral module is considered to be unimportant—it can be any of a variety of protocols, either protocols currently existing or later invented. It can also use any type of input/output (IO) bus system, such as USB, Ethernet, Bluetooth, any of the various IEEE 802.11 standards, PCI, PCIe, or anything that allows 10 and the transfer of information to and from the peripheral module whether now in existence or later created.

One base module may be connected to one or more peripheral modules. The proliferation of or number of peripheral modules that can be connected to a base module is based on several considerations, namely 1) the width of the bus connecting the peripheral module(s) to the base module and 2) the type of data being driven across the connecting bus, and 3) the total processing power of the base module. Thus, if the data to be driven across the bus is, for example, 1080p video data streams, the number of such streams that can be driven across a USB 1.0 bus is lower than the number of such streams that can be driven across a USB 3.0 bus. Additionally, the number of such streams may be higher for a higher-processing-power base module driving peripheral modules connected to a USB 3.0 bus than for a lower-processing-power base module driving peripheral modules connected to a USB 3.0 bus. The number of peripheral modules that can be operated and driven by the base module is therefore dictated somewhat by the processing capabilities of the base module, the width of the bus or buses connected to the peripheral module(s) and is also dictated by the amounts of data to be driven by the base module on the bus or buses at a given time.

Thus, the peripheral module is designed to share the processing power of the base module in a way that allows more users to access the base module's processing power simultaneously than is otherwise possible with existing systems. For example, an existing computer system and even a stand-alone base module of the type used with embodiments of the invention typically contains a single video port, and most modern operating systems (OS) typically provide for a single keyboard, and a single mouse or other pointing device, so only a single person may sit in front of and use the computer system. In many to most situations and circumstances, the processing power of the existing computer system is only lightly used by a single user, and even in instances where the processing power of the computer system is more-heavily used, such situations are typically fleeting.

Thus, much of the time much of the processing power of the processor in the single-user computer system goes unused. If, however, a base module according to embodiments of the invention is connected to one or more peripheral modules, some to much of the previously-unused processing power may be distributed not only to a native user of the base module but to users of the peripheral modules as well. Thus, if three peripheral modules are connected to the base module, three additional users can fairly-efficiently use the processing power of the base module at the same time as the native user of the base module. The sharing of the processing power of the base module may provide for any of the standard uses of computer systems at each of the peripheral modules and at the base module, such as word processing, video streaming and/or editing, Internet browsing, and the like. Thus, where the standard access devices (e.g. monitor, keyboard, mouse, etc. of the base module effectively provide a single “window” by which the native user can “view” or access the processing power of the base module, the peripheral module(s) serve to provide additional “windows” into the processing power of the base module for additional users. This provision of access may be termed “modular virtualization.”

As the available processing power and speed of the base module is increased, such as due to upgrades from time to time as with processor upgrades (from, for example, current processors having 60 nm features, to processors having 45 nm features, to 22 nm features, etc.), or due to replacement of the base module, and as the communications buses get faster, additional peripheral modules may be added to the system and can be driven by the system. Thus, the base module may be used to handle not just one user experience, but may handle the user experience of four users, ten users, a hundred users, or however many users the base module is able to handle.

One benefit of this distribution of processing power may be realized in conjunction with the current trend toward providing processors with multiple cores. Where current application programming structures and practices struggle to efficiently use multiple-core processors and to distribute portions of the processing power to the different cores, a system including the base module and one or more peripheral modules may more readily account for the performance of multiple tasks where the processing power of the multiple cores may be better utilized by the users of the multiple peripheral modules.

Embodiments of the invention may utilize protocols such as or similar to the existing remote desktop protocol (RDP) for any of a variety of OSs, including various versions of Microsoft Windows, Linux, Unix, Mac OS X, and the like, or any other protocol achieving similar functions whether now known or later created.

There are various efficiencies that are achieved using embodiments of the invention. Where today's stand-alone computer systems each require loading a separate instance of the OS into local memory, thus using a significant portion of the available memory (and requiring purchase of additional copies of the OS), a distributed system such as described herein only uses the memory and other resources of a single instance of the OS. Thus, the addition of a peripheral module to the system does not require the same memory and other resources as would be required with an existing stand-alone desktop computer system. The use of the peripheral modules thus efficiently allows multiple users different computer experiences merely with the addition of a peripheral module and its accompanying input/output devices, e.g. monitor(s), keyboard, pointing device(s), and the like.

Traditional virtual desktop infrastructure/virtual desktop implementation (VDI) requires that each instance of users' OS be loaded into memory on the server. Thus, a server providing thirty virtual desktop environments has thirty instances of the OS loaded on it. In contrast, embodiments of the invention utilize what may be termed “modular virtualization” in that only a single instance of the OS is loaded into memory and is shared out to the peripheral modules from a software side.

The peripheral module allows a user to utilize a small processor, some memory, and flash memory to access the power of the base module. When the base module includes some or all of the various features discussed in the related applications incorporated by reference above, the use of the peripheral modules as discussed herein allows for the efficient sharing of computational power among users at a very low wattage and in a very small volume. By way of example only, a base module as described in the related applications may have a size and shape of an approximately four-inch cube and may have power requirements of around only eighteen to twenty watts as opposed to a standard mini-tower configuration having dimensions of approximately six by sixteen by sixteen inches and power requirements of one hundred and ten watts. While such power and space savings are significant, each peripheral module may use as little as one additional watt and may take up only a third or less as much space as the base module, so a system according to embodiments of the present invention may include a base module and three peripheral modules in the volume of approximately two base modules and using only twenty-one to twenty-three watts, or roughly five watts per station. In contrast, adding three additional standard desktop computer systems uses significantly more space and over three hundred additional watts of power consumption.

Thus, embodiments of the invention provide significant per-seat savings in a variety of ways. First, savings are achieved in power consumption as discussed immediately above. Second, savings are achieved in hardware costs, as the cost of each peripheral module is significantly less than the cost of a new base module or even budget desktop computer; additionally, savings are achieved in the reduced hardware needs for loading the OS as only one instance of the OS and memory therefore is needed for the whole system instead of per seat. Third, savings are achieved in software licensing costs and the like, as in many instances only a client access license (CAL) or no extra license at all is needed to run software on the base module and accessed via the various peripheral modules and the base module, as the software is only actually loaded on a single machine.

Fourth, significant savings are achieved in connecting the systems to existing networks and the like. Using current systems, each workstation or location requires a separate Ethernet line with its accompanying switches, routers, and the like. Thus, the addition of an additional capacity to the system requires significant hardware costs and often the additional work of laying new communications lines and adding new communications capability. Embodiments of the invention permit the addition of multiple new users at each communications location. Because the peripheral modules each utilize the resources of a single base module, multiple users can be added to a network while only using the communications resources of a single computer system.

Similar efficiencies can be achieved with power, as the power demands of the peripheral modules are small enough to permit powering of the peripheral modules over the communications bus connecting the peripheral modules to the base module (e.g. USB). Thus, the addition of a peripheral module to the system does not require either a new communications (e.g. Ethernet) jack at the location with its accompanying switch/router, or a new power outlet other than whatever power source is used for the attached input/output device(s) (e.g. monitor or other display device, printer, etc.). Thus, additional users can be added at locations where traditional communications and power resources might dictate that the addition of users at the location would be impossible or very difficult or costly using existing standard desktop computer systems.

Many of the features of embodiments of the present invention are further enhanced by the size and power efficiencies provided by incorporating the features of the embodiments disclosed in the related applications into the base module. Such features include smaller size, better power efficiencies, lower weight, and structural features. Thus, a transition can be effectuated from a standard server connected to one or more thin clients to base modules effectively serving as mini servers all over an organization, with the peripheral modules connected thereto. The small size and small power requirements allow each base module to be placed in almost any location, and the even-smaller size and power requirements of the peripheral module (with the minimal power requirements of at least some embodiments being delivered over the communicating bus, thus eliminating the need of a separate power supply) allow the peripheral modules to be placed in even more-flexible locations.

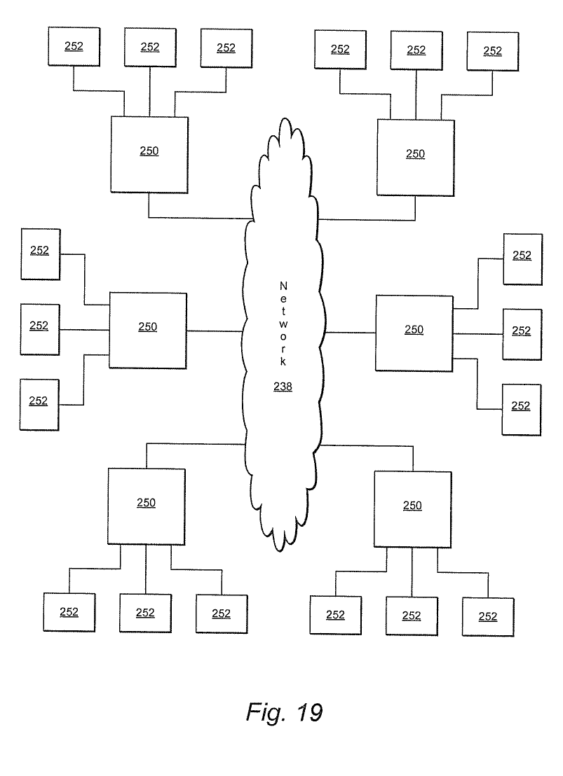

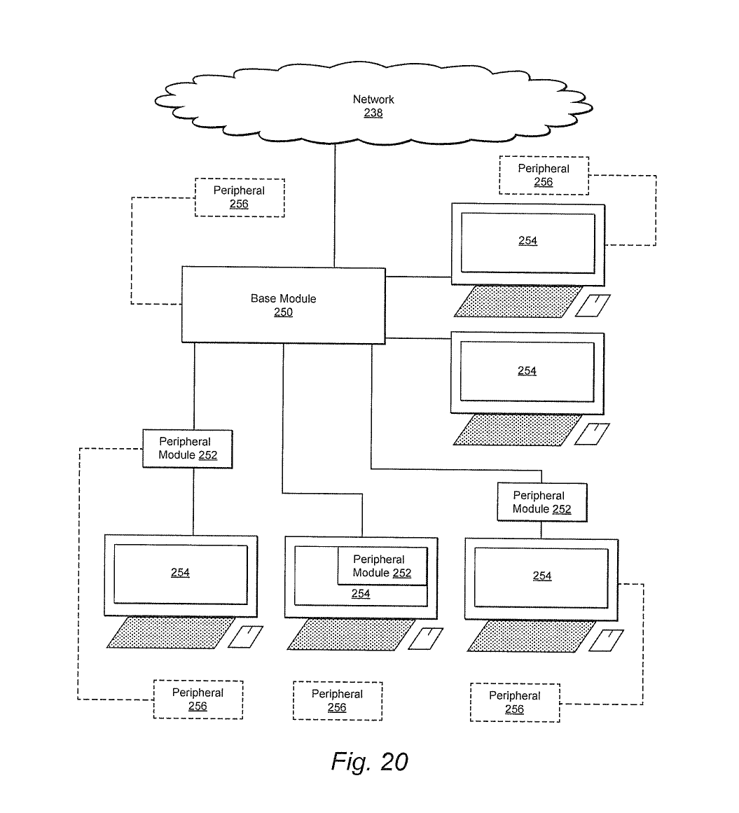

The base modules and connected peripheral modules may serve essentially as miniature servers and clients with greatly-reduced use of traditional network resources as illustrated in FIGS. 19 and 20. In FIG. 19, a plurality of base modules 250 are connected to the network 238. The network 238 may be any type of local or wide-area network now known or later created, and the base modules 250 may be connected to the network 238 using any wired connection, wireless connection, optical connection, any combination thereof, and the like now known or later created, and any communications protocol now known or later created. Each base module 250 may have one or more input/output devices (e.g. a monitor, keyboard, and/or pointing device) (not shown in FIG. 19) connected to it to allow a native user to utilize the processing and other resources of the base module 250.

In the illustrated example of FIG. 19, each base module 250 is connected to three peripheral modules 252. The illustrated number of peripheral modules 252 connected to each base module 250 is intended to be illustrative only, as more or fewer peripheral modules 252 may be connected to any one base module 250 for a variety of reasons discussed in more detail herein. Each connection between a particular peripheral module 252 and its base module 250 may be a wired connection, a wireless connection, an optical connection, any combination thereof, or any other type of communicative connection now known or later created. Indeed, any communicative connection discussed herein should be understood to include any of these types of connections to the full extent such types of connections comport with the specific topic and example being discussed. Each peripheral module 252 may have one or more input/output device(s) (e.g. a monitor, keyboard, and/or pointing device) (not shown in FIG. 19) connected to it to allow a peripheral user to utilize the processing and other resources of the connected base module 250.

The users of the peripheral modules 252 may access additional resources across the network 238 through their connected base modules 250. For example, users of the peripheral modules 252 may browse the Internet, print to a network printer (not shown) connected to the network 238, access server-based resources provided by a server (not shown) connected to the network 238, send and receive electronic mail and a variety of other communications over the network 238, and access a variety of other network resources across the network 238 through their connected base modules 250. Thus, users of the peripheral modules 252 need not be limited in essentially any way as to the standard and special functions expected to be available to a computer user.

In addition, however, certain benefits may be provided within the local group of an individual base module 250 and its connected peripheral module(s) 252 as illustrated in more detail in FIG. 20. FIG. 4 shows a more-detailed view of a single base module 250 connected to the network 238 and connected to several peripheral modules 252. Again, there may be more or fewer peripheral modules 252 connected to the base module 250, depending on a variety of factors and needs as discussed herein, and the specific example is only illustrative. As shown in FIG. 20, each peripheral module 252 is connected to a set of input/output devices 254 (e.g. monitor, keyboard, and/or mouse or other pointing device(s)), and sets of input/output devices 54 are also connected to the base module. Thus, this particular embodiment may allow up to five users to simultaneously access and utilize the processing and other resources of the base module 50, each with his or her own input/output devices 54. As the base module 50 is connected to the network 38, any of the users may access a variety of the resources available over the network 38, as discussed above.

In addition, however, resources may also be shared among the five users in a type of mini-network. For example, any of the base module 50, the peripheral modules 52, or the various attached input/output devices 54 (such as through an integrated hub, e.g. an integrated USB hub) may optionally have additional resources (each illustrated as a peripheral 56) attached thereto. When a peripheral 56 is thus attached, its resources may be made available to any of the users of the base module 50 or the peripheral modules 52, not necessarily just the user of the module or input/output device to which the peripheral 56 is attached.

Thus, for example, if the native user of the base module 50 attaches a USB printer to the base module 50 as a peripheral 56, the users of the peripheral modules 52 may be allowed to see the printer and print to it. In this way, the printer essentially performs as a network-attached printer for the “network” of the base module 50 and its attached peripheral modules 52. One major advantage of this arrangement is that an effective network-attached printer (or other resource) is effectively provided to the users without ever utilizing the resources of the network 38: any of the users of the base module 50 and its attached peripheral modules 52 can print to the printer and no data need be sent to or over the network 238, thus minimizing network traffic so the network's bandwidth is available for other uses.

One or more of the input/output devices 254 attached to the base module 250 may have the capability to serve as a hub by which other devices may be attached to the system (e.g. a USB hub). In such a case, the native user of the base module 250 may elect to attach another device, such as a web camera, as a different peripheral 256 (the web camera could alternatively be attached directly to the base module 250). If desired, the web camera may be made available to any of the users on the mini-network of the base module 250/peripheral module 252 system, or use of and access to the web camera may be limited to the native user of the base module 250. If several of the users of the peripheral modules 252 and/or the base module 250 are provided with web cameras and are separated from each other by walls, multiple connected web cameras can provide the users with the ability to video conference with each other without any data passing over the network 238, again assisting to reserve network bandwidth for other network traffic.

Peripherals 256 may be attached to the peripheral modules 252 and/or the input/output devices 254 (e.g. using one or more hubs built into the input/output devices 254) attached to the peripheral modules 252, and such resources may optionally be made available to all users using the local peripheral modules 252 and/or base module 250. Thus, if one user of a peripheral module 252 attaches a portable mass storage device (e.g. a flash drive or a portable hard drive) to his or her peripheral module 252 to be a peripheral 256, the files or other data on the portable mass storage device may be made available to any of the users. Similarly, if another user of a peripheral module 252 attaches a digital picture frame (as a peripheral 256) through his or her input/output devices 254, the other users may be allowed to access the picture frame and to upload pictures to be displayed on the picture frame. Again, in both instances resources are made available to multiple users without any use of the network 238, saving network bandwidth for other uses.

The base module 250 handles all the network connections and manages load balancing and other considerations. Thus, the base module 250 performs in large part as the server for each of the peripheral modules 252, even though the base module 250 may still be connected to a standard server back end or to a server back end formed from low-power modules similar to the base module 250. In some ways, a network of mini networks formed in this way resembles old star networks. In instances where each user is to have his or her own IP address, the base module 250 manages virtual IP addresses assigned to each peripheral module 252.

Several other features of embodiments of the invention should be noted with respect to FIG. 20. First, it should be noted that several sets of input/output devices 254 are attached to the base module 250. This illustrates that while certain embodiments utilize the peripheral modules 252 to facilitate modular virtualization and sharing of resources of the base module 250, other embodiments rely solely on the base module 250 itself to provide modular virtualization. Thus, embodiments of the invention may provide multiple layers of modular virtualization. The base module 250 itself may provide a first layer (e.g. the native user of the base module 250). Session-based software operating on the base module 250 may provide another layer such as by segmenting input/output for multiple users as shown in FIG. 20. Additionally, the peripheral module 252 or some other control module may provide a third layer of modular virtualization.

Another feature of embodiments of the invention is illustrated in FIG. 20. As may be noted, the illustrated system includes three peripheral modules 252. The center peripheral module 252, however, is incorporated directly into a set of the input/output devices 254. This illustrates that the peripheral module 252 may be incorporated into a wide variety of devices and may essentially appear for all intents and purposes to simply be an additional set of input/ouput devices 254 connected to the base module 250.

Of course, as mentioned above, any communicative connection between devices illustrated in FIG. 20 may be a wired connection, a wireless connection, an optical connection, a combination thereof, and the like. The input/output devices 254 need not be identical or even similar—one set of input/output devices 254 may simply be a touch screen monitor, while another set may include a standard monitor, keyboard and mouse. Thus, the illustration of FIG. 20 is intended in all respects only to illustrate features of embodiments of the invention.

Embodiments of the invention provide some significant advantages over existing thinnet systems implementing VDI. In such systems, the server may implement many (such as three hundred) VDI desktop implementations. One problem with such systems is that when the central server goes down, all the VDI implementations go down with it and none of the users are able to access their systems. This is especially problematic in critical applications such as medical or legal. Most companies simply cannot afford to have large numbers of their employees unable to work. Thus, many companies shy away from implementing VDI with thin clients and have tended to stay with traditional desktop computers.

Embodiments of the invention address the cost and performance redundancy gaps between traditional thinnet VDI implementations and implementations relying solely on traditional desktops. Because groups of systems such as shown in FIG. 19, including very large groups of systems, utilize individual base modules 250 to provide the processing power and capabilities, there is no risk of a single system failure causing a widespread outage that affects many or even hundreds of users. Instead, the single system failure may only affect a very small number of users and can be readily addressed by simply replacing the affected base module 250. In addition, when some of the features disclosed in the related applications are incorporated into the base module 250, the risk of even a single system failure is greatly reduced. The cost of implementing each system versus implementation as a traditional desktop is also greatly reduced, as the peripheral modules are relatively inexpensive. Thus, cost is low and overall risk is very low.

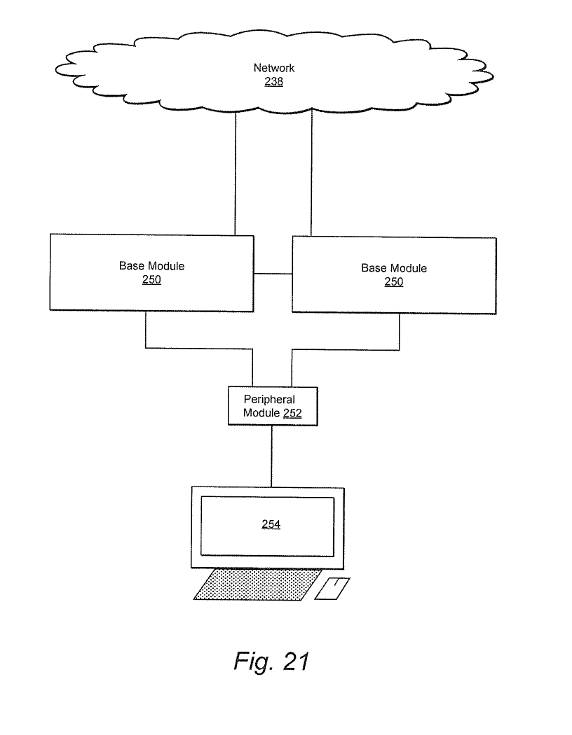

If additional redundancy is desired, each peripheral module 252 may be connected to multiple base modules 250, as illustrated in FIG. 21. While only one peripheral module 252 is shown in FIG. 21, it should be understood that more than one peripheral module 252 may be attached to multiple base modules 250 in a manner similar to that shown for the single shown peripheral module 252. Additionally, although FIG. 21 does not show any input/output devices 254 attached to the base modules 250, it should be understood that a set of input/output devices 254 may be attached to allow a native user to use the base modules 250. Regardless, configurations similar to that of FIG. 21 provide additional redundancy such that even if one of the base modules 250 were to fail, the other base module 250 would continue functioning and would allow the user(s) to continue working without interruption or to ensure that all working data is saved while the failed base module 250 is replaced.

Of course, it should be understood that systems in accordance with embodiments of the invention are highly resistant to failures in any event, as they are comprised largely or entirely of solid state devices running at low voltages and wattages that tend to minimize the chances of failure. For example, the peripheral module 252 may operate at an operating voltage of five volts and an operating wattage of one watt, all running from and provided by the base module 250.

Of course, it is anticipated that the technology incorporated into each of the base modules 250 and the peripheral modules 252 will become outdated over time. One benefit of embodiments of the invention, including the incorporation of features discussed in the related applications, is the ability to readily incorporate upgrades into the base modules. Another benefit is that as features of the base module 250 improve, such as the incorporation of higher-speed buses (e.g. USB 3.0 vs. 2.0), the base module 250 typically remains backward compatible with the peripheral modules 252. When the peripheral modules are to be upgraded or replaced, the cost of upgrade or replacement is relatively low as so little is contained within the peripheral modules 252.

It is anticipated that it may be possible that increases in computer power will make it so that the base modules 50 are essentially obsolete in terms of serving as the base module 250 (e.g. as a mini server for multiple users). However, it may well be that if such obsolescence occurs, the base modules 50 of today may become the peripheral modules 252 of the future and may thus have an extended lifetime. There is essentially no rule that requires the peripheral modules 252 to only include the bare minimum hardware, firmware, and/or software to distribute the processing power and other resources of the base modules 250. There are energy efficiencies obtained by keeping the peripheral modules as low-power and simple as possible, but even today, modules essentially identical to the base modules 250 can effectively serve as the peripheral modules 252. If, however, the power requirements are less of a concern and/or upgrade costs are a concern, the base modules 250 of today could readily serve as the peripheral modules 252 of the future.

In the mini-network structure as shown in FIG. 20, there are several power banding schemes. In the peripheral modules 252, which have very small processors and very small OSs, the power use is very low, the configurability is also very low as the OS, application layer, and hardware layer are more difficult to upgrade. In contrast, with the three-board structure of the base modules 250 in some embodiments (as described in the related applications), there are essentially no limitations on the types of OS that can be run, the ability to modify the application layer and any of the planes or boards of the hardware layer as needed. Of course, some applications will never need more power than what can be provided by today's peripheral modules 252 (e.g. time clocks for checking employees in and out). For other applications that have higher processing demands, it may become desirable for the peripheral modules 252, even if still distributing processing power and resources of one or more base modules 250, to be able to provide more functions locally without having to rely on the abilities of the base modules 250.

The peripheral modules 252 of embodiments of the invention have value in their relatively low cost and further in the fact that the processing resources are low enough that they are essentially worthless standing alone. For example, a peripheral module 252 may be installed in a location where there is a significant risk of attempted theft. Because a stolen peripheral module 252 will not function without the processing abilities of a connected base module 250, the peripheral module 252 is less likely to be stolen. Even if the peripheral module 252 is stolen, the replacement cost of the peripheral module 252 is significantly less than the replacement cost of essentially any other computer device that could be installed at that location.

Embodiments of the invention as described herein are highly customizable to satisfy the processing needs of almost any situation. For example, in a situation where the processing needs of individual users are relatively low, each base module 50 may be connected to and share processing and other resources with a relatively higher number of peripheral modules. As one example, consider an automated airline kiosk where customers can check themselves and their bags in for a flight. At any one time, one to many of the stations of the kiosk may be essentially unused. Additionally, even when a station of a kiosk is being used, the total data throughput can be very low (some basic visual displays on a monitor or touchscreen monitor, a barcode scanner, and possibly a keyboard, and minimal data moving back and forth) and may further be essentially intermittent. Thus, a single base module 250 may have ample resources and processing power to drive many stations.

Even if the maximum possible load exceeds the processing power of the base module 250, chances are very high that the maximum possible load will never or only very rarely be reached. Further, even if the maximum possible load exceeds the processing power of the base module 250 and is actually reached from time to time, the base module 250 simply performs load balancing and some kiosk users have a slightly-reduced customer experience until the load is naturally reduced in time. In situations where the available processing power is exceeded, certain embodiments of the invention load balance in a way that maintains or largely maintains the user experience of a native user of the base module 250 as opposed to user(s) of the peripheral modules 252, although other schemes are embraced by embodiments of the invention.

If it is discovered that the processing capabilities and other resources of a single base module 250 are insufficient to satisfy the needs of a certain situation, there are several actions that may be taken in response. One possible action is to perform an upgrade to all or a portion of the base module 250 to provide additional processing power or other resources. Another possible action is to simply add an additional base module 250 to the system, with each base module 250 handling a portion of the previous load. Thus, embodiments of the invention are particularly flexible for dealing with various anticipated load situations, and purchasers of the systems may customize the system and purchase only the processing power and other resources specifically needed for their situation.

Thus, if it is anticipated that the users will each need modest processing power, a configuration such as shown in FIGS. 19 and 20 may be provided, with a few (e.g. two to four) peripheral modules 252 connected to each base module 250. In a fairly-standard situation, it may be desirable to ensure there is sufficient processing power and other resources at the base module 250 to more than meet the anticipated needs of all users, so that all users have a good computing experience. In a typical office environment, most users are only modest users of computing resources, commonly operating a word processing program, an e-mail program, and limited web browsing and the like. Only on rare occasions do the typical user's processing needs get larger, and in such instances, it will be most common for other users to have lower processing needs or to not be using their computers (e.g. peripheral modules 252) at all. Thus, in most situations, even four office workers can readily share the processing power and other resources of a single base module 250.

As may be appreciated by reference to FIG. 4, the native user of the base module 250 has the most processing power available to him or her, as his or her input/output devices 254 are natively connected to the base module 250, while the other input/output devices 254 are only connected to the base module 250 through the peripheral modules 252 and the connecting bus and are therefore limited by the maximum speed of the connecting bus. Thus, whichever user among the users of a single base module 250 and its attached peripheral modules 252 is the “power user” should be assigned as the native user of the base module 250. The system may bias system resources to service the native user's needs over the needs of other users when demands on the resources of the base module 250 exceed what the base module 250 can provide. If the various users' needs are not known at the time of installation, it is relatively simple to allow the users to operate their systems for a time, determine which user more-heavily uses system resources, and assign that user to be the native user of the base module 250.

If, during such testing, it is determined that the overall processing needs of the group of users is greater than what can be provided using a single base module 250, an additional one or more base module(s) 250 replace(s) one or more of the peripheral modules 252 (and connection of the peripheral module(s) 252 may be redistributed among the base modules 250) until the computing needs of the users are satisfied. Thus, some users may find that they are capable of using essentially all the computing resources of a single base module 250 and may be assigned an individual base module 250 with no attached peripheral modules 252. Other groups of users may find that they still do not need all of the resources of a single base module 250, and additional peripheral modules 252 may be added to the system to further share resources of the base module 250 with still other users. In this way, system resources may be adjusted on the fly to meet a variety of changing needs as they change, and only the necessary computing power need be purchased.

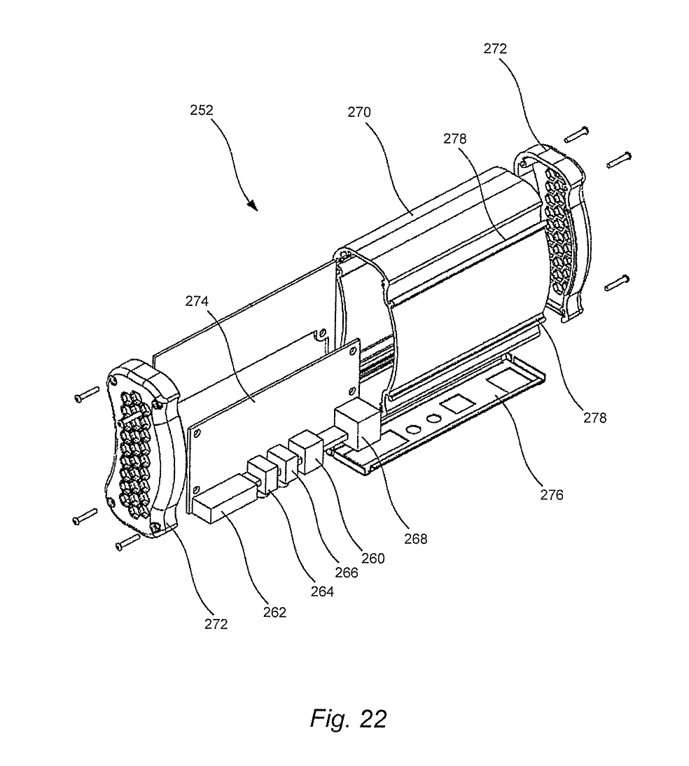

FIG. 22 shows an exploded perspective view of one illustrative embodiment of the peripheral module 252. The peripheral module 252 includes a bus port 260 for connecting a bus (not shown) to be connected to the base module 250. In one example, the bus port 260 is a USB port, but as mentioned above, the bus may be any type of bus. The bus is used to drive input/output commands (e.g. keyboard, mouse, and video commands) between the base module 250 and the peripheral module 252, and faster buses simply allow more commands to pass between the modules, but only enough is required to take in inputs and display or otherwise output the outputs from the base module 250.

The peripheral module 252 also includes several other types of ports to allow the connection of the input/output devices 254. For example, the illustrated embodiment includes a video port 262, an audio input port 264, an audio output port 266, and some additional bus (e.g. USB) ports 268. The audio input port 264 and the audio output port 266 of this embodiment allow this embodiment to be used, for example, in a call center. The USB or other bus ports 68 may be used to connect other input/output devices such as a keyboard and mouse. The illustrated ports are intended to be only illustrative and not restrictive. The peripheral module 252 uses and manages these various ports to create a user experience essentially as a session on the base module 250.

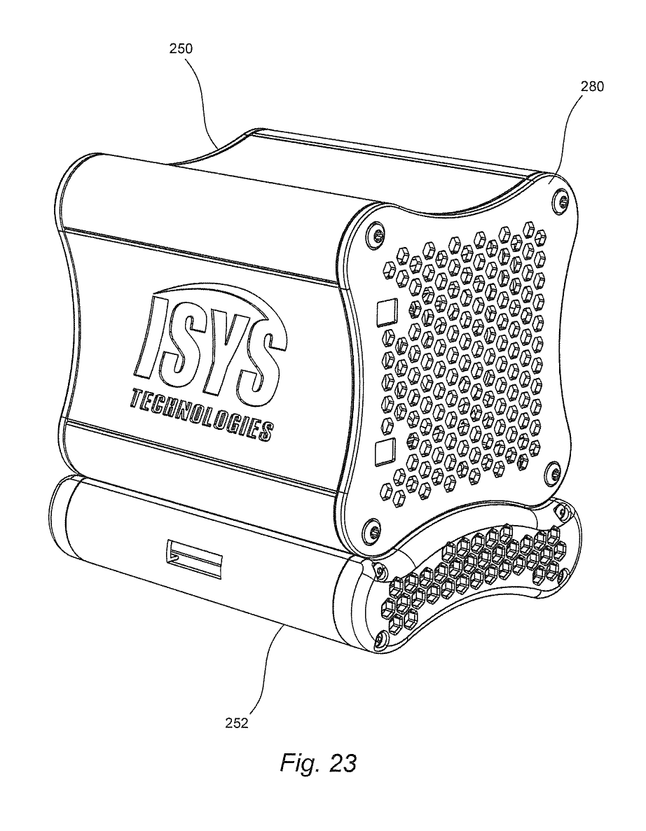

FIG. 22 shows how the peripheral module 252 may be constructed. As may be seen in this Figure, the peripheral module 252 includes an outer structural shell 270 and two end caps 272. The structural shell 270 and end caps 272 serve to enclose and protect a system board 274 of the peripheral module 252. The structural shell 270 may be made of a variety of materials, including plastics and metals, including aluminum and/or metal alloys, and may be formed in a way so as to provide structural functions as discussed in the related applications. Additionally, the structural shell 270 may be formed so as to mate with the structure of the base module 250 as is illustrated in FIG. 23. As shown in FIG. 22, the various ports discussed above are attached to the system board 274. A port cover plate 276 may serve to cover any gaps between the different ports.

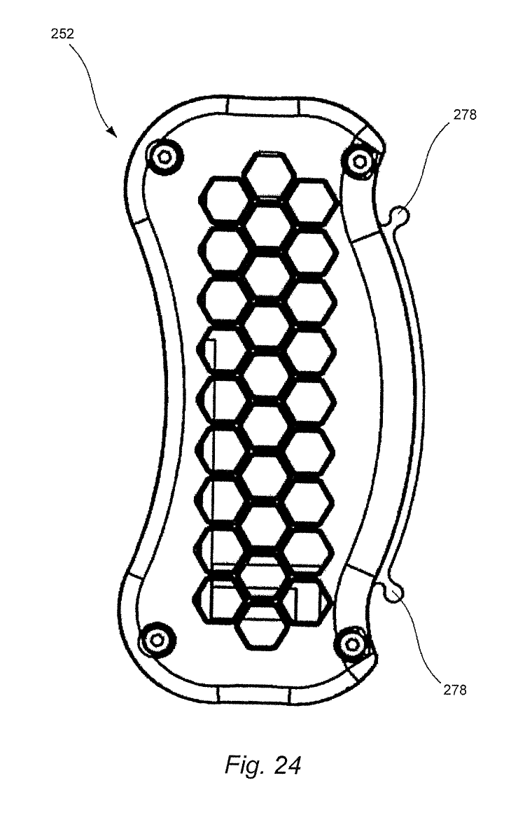

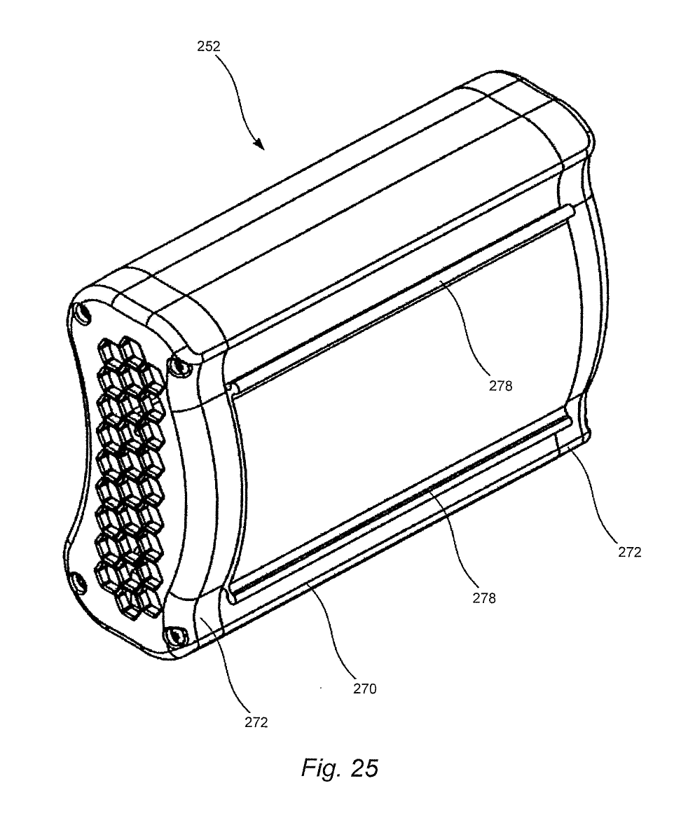

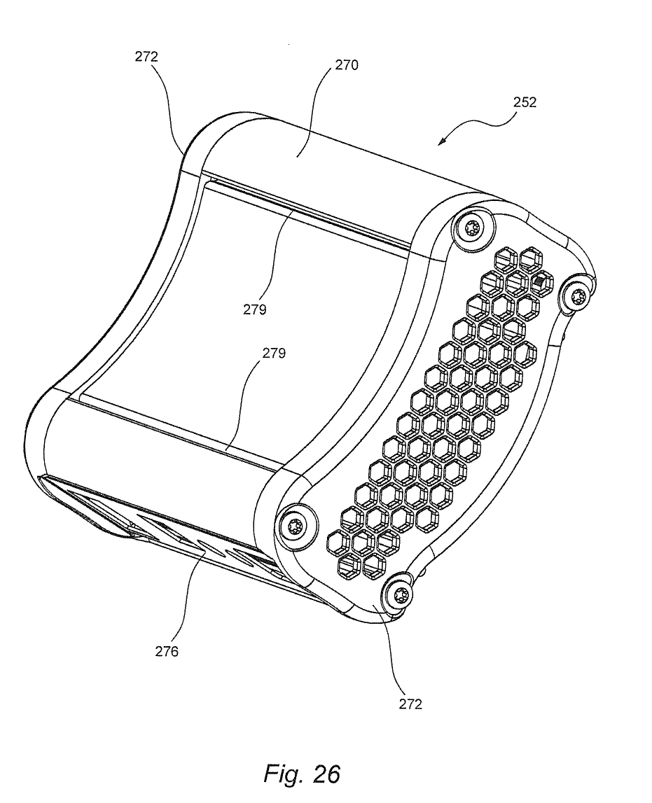

FIGS. 24 and 25 show end and perspective views of the peripheral module 252, respectively. In these views, some features of the structural shell 270 are visible that show one way in which mating with the base module 250 or other peripheral modules 252 may be accomplished. As may be seen in FIGS. 24 and 25, the structural shell 270 may be formed (e.g. extruded) to have a pair of mating protrusions 278 on one major side of the peripheral module 252. As may be seen in FIG. 26, the opposite major side of the structural shell 270 in this embodiment is formed to have a corresponding pair of mating channels 279 that can accept the mating protrusions 278. As may also be seen in FIGS. 24 through 26, the end caps 272 do not include either the mating protrusions 278 or the corresponding mating channels 279. The base module 250 includes corresponding mating channels 279 on at least one of its sides, and possibly on as many as three of its sides (but again, not on its end caps).

To structurally attach the peripheral module 252 to the base module 250 in the manner shown in FIG. 23, an end cap 280 of the base module 250 is removed (tamper-resistant fasteners may be used to deter theft or vandalism), and the mating protrusions 278 of the peripheral module 252 are slidingly engaged with the corresponding mating channels 279 of the base module 250. The peripheral module 252 slides until it is fully mated with the base module 250. The end cap 280 of the base module 250 is reattached to the base module 250 and thereby locks the peripheral module 252 to the base module 250. Additional peripheral modules 252 or other components may be attached to the system using the mating channels 279 of either the peripheral module 252 or of other sides of the base module 250 as desired, with the corresponding end cap (272 or 280) being removed to facilitate such attachment.

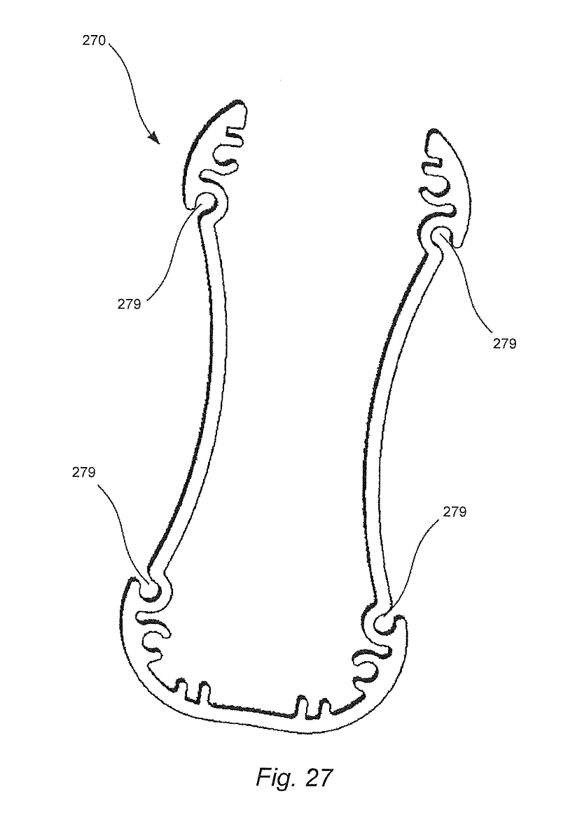

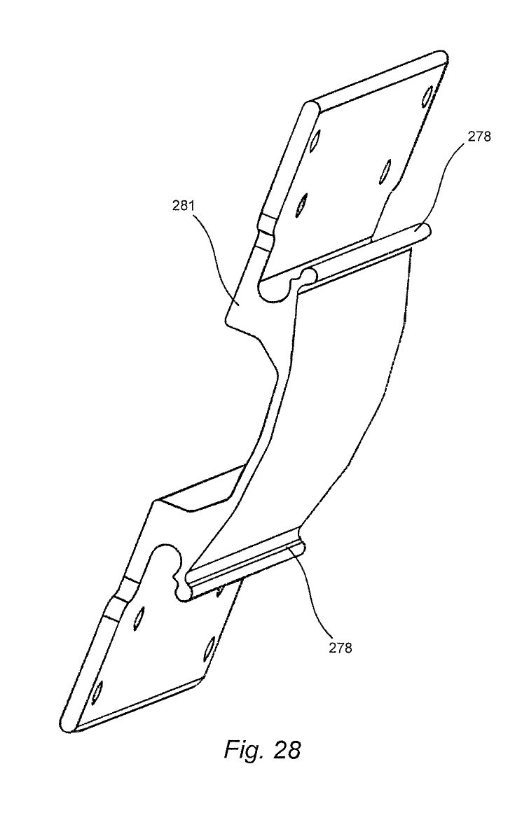

The illustrated embodiments shown in FIGS. 22-26 are merely illustrative of ways that embodiments may be constructed to permit structural connections between modules and with other devices. Thus, for example, while the illustrated peripheral module 252 has mating protrusions 278 on one major side and mating channels 279 on another major side, another embodiment may have mating channels 279 on both major sides, as illustrated in the end view depiction of an alternate outer structural shell 270 shown in FIG. 27.

The structural shell 270 of the peripheral module 252 may be load bearing as disclosed in one or more of the related applications. The peripheral module 252 may therefore be used as a mount from which to hang a monitor or other device, may be embedded or mounted in a wall, may be a part of a frame, and may perform any of the structural functions disclosed in the related applications. For example, a plate may be mounted to a wall and another plate may be mounted to a monitor, and the two plates may be connected together through the structural features of the peripheral module 252. One illustrative embodiment of a plate 281 is shown in FIG. 28. The plate 281 is an extruded and cut plate that has mating protrusions 278 similar to those discussed above, although it could alternatively have mating channels 279. The plate 281 could be mounted to any of a variety of modules discussed herein such as the peripheral module 252. Thus, the peripheral module 252 may essentially serve as an intelligent mounting bracket.

A system including peripheral modules 252 differs somewhat from a system composed entirely of base modules 250, even if the base modules 250 are of varying types. For example, as disclosed in the related applications, base modules 250 may be connected to each other and may include varying features (such as one or more cubes containing a GPU instead of a CPU) so as to increase the processing abilities of the combined units. For example, some combinations of units may essentially work together to form a supercomputer or provide supercomputer-like functions. In contrast, the addition of peripheral modules 252 to the system (regardless of the number and configuration of base modules 250) primarily functions to allow the distribution of computing capabilities of the base module(s) 50 through the peripheral modules 252. (As discussed above, peripheral modules 252 having more than a minimum computing capability may be used and may therefore add some processing capability to the system, and additional system resources (e.g. printers, mass storage devices, web cameras and the like) may be attached to the peripheral modules 252 and thus become available to the combined system.)

Thus, the addition of peripheral modules 252 to the system allows resources to be shared to the human element by driving graphical user interfaces (GUIs) using that power. Thus, the users are thereby permitted to view and manipulate data that is available on the one or more connected base modules. The peripheral modules 252 need not be designed to do work at the peripheral modules 252 other than passing data to and from the input/output devices 254. The peripheral modules 252 instead permit the accessing of a GUI session on the base module 250, thereby providing access to the data, programs, and other resources available on the base module 250. The primary computing functions are handled by the base module(s) 250, and each peripheral module 252 serves to open a window to access the resources of the base module(s) 250.

As may be appreciated, embodiments of the invention may be implemented in a huge variety of situations, only some of which are discussed herein. Some specific examples have been illustrated herein, but other examples include in office and school environments, in a variety of embedded computer situations, in automated teller machines, in remote sensors, in industrial equipment, and the like. The embodiments described herein are therefore intended to be only illustrative and not restrictive.

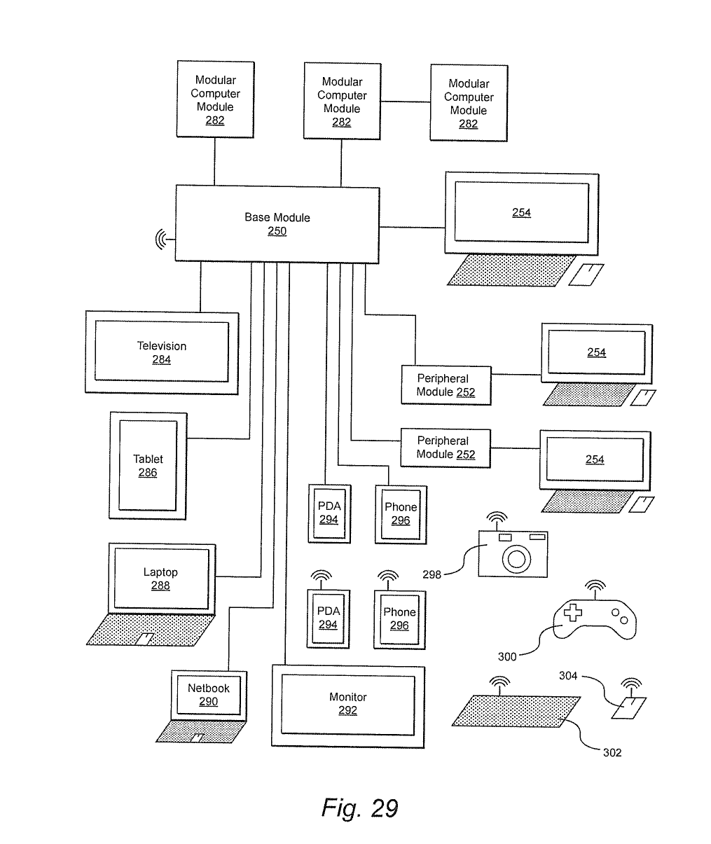

FIG. 29 illustrates a representative enterprise configuration that shows certain benefits that can be achieved with some embodiments of the invention. The devices and configurations shown in FIG. 29 are intended to be illustrative of certain concepts associated with embodiments of the invention, and should not be deemed limiting of the invention. In the enterprise configuration of FIG. 29, there are one or more connected base modules 250, as well as one or more connected modular computer modules 282. The modular computer modules 282 can be any of a variety of modules for modular computing as discussed in the related application, including units having graphics processors thereby providing supercomputing functions to the configuration. The modular computer modules 282 could also be additional base modules 250 providing additional processing power as discussed herein, modules providing storage, and/or modules providing any other desired computing functionality. Additionally, the number of base modules 250 and modular computer modules 282 is only illustrative, as differing numbers of such modules may be provided to suit a particular computing need.

As shown, the system includes input/output devices 254 connected to the base module 250, serving to provide a native user a “window” into the enterprise in a fashion similar to that discussed herein. The virtual modularization provided by embodiments of the current invention also allows a wide variety of traditional and non-traditional additional “windows” into the enterprise. For example, as discussed above, one or more peripheral modules 252, with their associated input/output devices 254 provide additional “windows” into the enterprise. Additionally, as shown in FIG. 213, a variety of other devices may utilize wired and/or wireless connections to the enterprise to provide “windows” into the enterprise, whether the “window” is provided by a single device or by multiple devices in combination.

For example, as illustrated in FIG. 29, a variety of devices have wired, wireless, optical, hybrid, or other connections to the primary base module 250. In at least some instances, the connection may be made using one or more repeating devices to extend the range between the base module 250 and the communicatively-connected device. Such devices are merely illustrative of general types of devices that could be connected to the base module 250 and assist in understanding embodiments of the invention. As shown in FIG. 213, a television 284 is attached to the base module. The television 284 provides a viewing “window” into the enterprise, and may, for example, serve a variety of functions, including displaying of computer games, changeable signage such as a menu or advertisement, or any of a variety of other purposes that will be readily apparent. The television 284 may or may not have controls or inputs that allow inputs to be sent directly from the television 284 to the base module 250. Optionally, one or more other devices connected to the enterprise may provide inputs to the base module 250, effectively controlling what is displayed on the television 284.

Also connected to the base module 250 is a tablet computer 286. The tablet computer 286 may provide much functionality similar to the functionality of the television 284, with additional input options (e.g. touch screen, virtual keyboard, hardware keyboard, built-in camera, etc.) that may or may not be provided to the television 284. Thus, the tablet computer 286 may provide a more fully-interactive “window” into the enterprise than may be provided by the television 284 alone. In some embodiments, the tablet computer 286 and the television 284 may work in conjunction to provide a “window” into the enterprise, such as by the tablet computer 286 functioning as an input device to the base module 250 to control what is displayed on the television 284 (as a sort of remote control, for example).

A laptop 288 and a netbook 290 are shown connected to the base module 250. These devices may provide functionality similar to the functionality provided by the tablet computer 286, as well as any other functionality provided by such devices. A monitor 292 is also connected to the base module 250 and can serve as an alternative “window” into the enterprise, similar in function to the television 284, possibly with or without sound functions depending on the features of the monitor 292. Two PDAs 294 are shown as being connected to the base module 250, one possibly with a wireless connection and one possibly with a wired connection. It should be understood that in each instance where only a wired or wireless connection is shown in FIG. 29 to a particular device, an alternative connection type would be the type of connection not specifically shown, an optical (e.g. infrared) connection, a hybrid connection, or any other type of connection. The PDAs 294 may provide alternative “windows” into the enterprise or may function in conjunction with other device(s) to provide such “windows.” For example, the PDAs may effectively serve their normal functions while simultaneously interacting with the enterprise to provide remote control functionality to control the display on the television 284 or monitor 292. Additionally, the PDAs 94 may be greatly-simplified devices, as discussed with respect to the peripheral modules 252 herein, with the PDA functionality largely being delivered by the base module 250. As may be appreciated, providing PDA functionality in this way may greatly reduce the battery draw of the PDAs 294 such that the PDAs 294 last significantly longer on a single charge than today's standard PDAs.

Two phones 296 (which may be similar to cell phones or any other phones) are also shown connected to the base module 250. These may be smart phones and may provide functionality similar to that described with respect to the PDAs 294. Additionally, the phones 296 may use the base module 250 to provide telephone calls, such as VOIP telephone calls. Again, the phones 296 may be drastically simpler devices than the smart cell phones of today, and may therefore be able to last significantly longer than today's devices. Additionally, the phones 296 may be provided with access to significantly more content (readily accessible through the base module 250) than can be stored on even the most advanced of today's smart phones, while such a phone 296 could be drastically simpler due to the reduced hardware and in-device processing needs while still providing much functionality and even increased functionality in conjunction with the base module 250 in comparison with today's phones.

Thus a variety of devices can provide “windows” into the enterprise configuration shown in FIG. 29. In at least some instances, a variety of controllers can be used to control some functionality of the various “windows.” Thus, FIG. 29 shows a camera 298, which may be a surveillance camera or any other camera, and which may interact with the enterprise, a controller 300, which may be a remote control or a game controller, a keyboard 302, and a pointing device or mouse 304. Each of these devices may be used to interact with one or more of the “windows” in a fashion similar to that described previously. The various controllers may be used to provide input or manipulate data in the enterprise.

The enterprise can be customized to include one or more virtualization links, and a user may elect to show certain data on the television 284 and certain other data on the monitor 292 for example. All the data that is to be accessed on the enterprise is very secure, since it is all stored on a single computer (e.g. the system of the base module 250). Thus, enterprises such as that of FIG. 29 are extraordinarily robust and are highly customizable as a specific spinoff of networking. The robust enterprise can be accessed in different ways than with a traditional server and monitor. The PDAs 294 may receive data in a lower resolution, for example, than is received at the television 284.

As disclosed in the related applications, one form of input that may be received by the enterprise is data from an accelerometer included in one of the attached devices. Thus, a device including an ability to determine accelerometer data may communicate to the enterprise that it is at a certain angle, say ninety degrees or forty-five degrees from horizontal, and may then request whatever data corresponds to that state. The enterprise may then serve up applications based on that input data. Thus, modular virtualization allows sending out only straight video data that is provided in a variety of ways by the small memory, processor, and flash memory of the devices, e.g. various monitors etc., and gets past the standard single monitor, keyboard, and mouse. Thus, the enterprise may have multiple (e.g. twenty) different virtualized desktops that the user can choose how to display, such as by tablet computer 286, television 284, PDA 294, phone 296, etc. delivered in different ways using the capabilities of different devices. Because the system allows for the adding and subtracting devices such as the base module 250, it allows for the addition of an increasing number of devices to access the enterprise as desired with any available device connected in any applicable fashion. This allows the generation of enterprises without the use of traditional networking systems. The access devices rely on the enterprise itself for a variety of levels of processing and data depending on the characteristics of the access device. All attached devices rely to some extent on the enterprise, but embodiments of the invention allow the devices to rely on the capabilities of the enterprise for as much or as little as necessary.

Thus, a device with higher processing capabilities, such as the laptop 288, might locally (internally to the laptop 288) cache the top ten files that a user is working on, or it might alternatively determine that its entire environment is to be virtualized and supplied by the enterprise (e.g. the base module 250 and its connected resources). In contrast, a simpler device such as the peripheral module 252 may only provide an option for the completely virtualized environment. In either case, the same data is provided to the user.

As an example, if the user is watching a television show on the television 284, and the system recognizes that the user has received an e-mail that the user was expecting, the system may provide a notification to the user over the television 284. The user could then access his or her phone 296 and discover that the e-mail is waiting right at the top of his or her list, without having to go search for the e-mail. As all the functions are integrated in a single system, they can all be provided to the user seamlessly. A variety of local and remote alerts can be provided in this or a similar fashion, including alerts related to communications, house alarm systems, surveillance systems, etc. The enterprise is allowed to bring multiple streams of data, dependant on one another to the user and blend or un-blend the streams to the user as needed.

A user watching a television show may not want or need a full e-mail client displayed on the television 284, for example, but may want notifications provided so that the user can access a separate device to read the e-mails. This is only one example of the integration possible between multiple devices. For example, if one user controls what is displayed on the television 284 using his or her phone 296 and then leaves the area with the television 284, the system may optionally reset and wait for another controlling device. When another user arrives with his or her phone 296 (or other controlling device), he or she can then use the phone 296 to take over control of what is displayed on the television 284 (e.g. play a game, watch a movie, etc.). Data specific to the controlling device can thus be displayed on the television.

Thus, while today's existing devices allow a user of a traditional network to consolidate inputs from a variety of different sources (e.g. web servers) and to supply the inputs to the user as desired and consolidated by the device, such devices are required to have large amounts of local power and processing to handle and consolidate the inputs so that the inputs all appear to be on the device. In contrast, embodiments of the present invention essentially provide a super server having so much power that it can be accessed using a very inexpensive device with very little internal processing power or energy demands (input/output, display, and a minimal battery or power source). Because all the data is still available, massive amounts of data can be provided to a very small device that only provides minimal caching or viewing without caching. As such devices move from location to location, different data can be served by the local enterprises of each location, and the devices can call on any available data at any time through any accessible enterprise.

Embodiments of the invention therefore allow devices to access enterprises of miniature servers located in a variety of diverse locations. A user might use his access device to access his home server when he is at home, and the home server provides access to the user's personal data and provides the great majority of the data and processing power accessed by the user's access device. When the user then goes to work, he or she takes the access device to work, and uses the access device to access a work server, having full access to any necessary work data and processing power, including suites of applications that might not be available to the user at home. Again, the great majority of the data and processing power accessed by the access device are provided by the work server, and the data may inherently be more secure as it never leaves the work server.

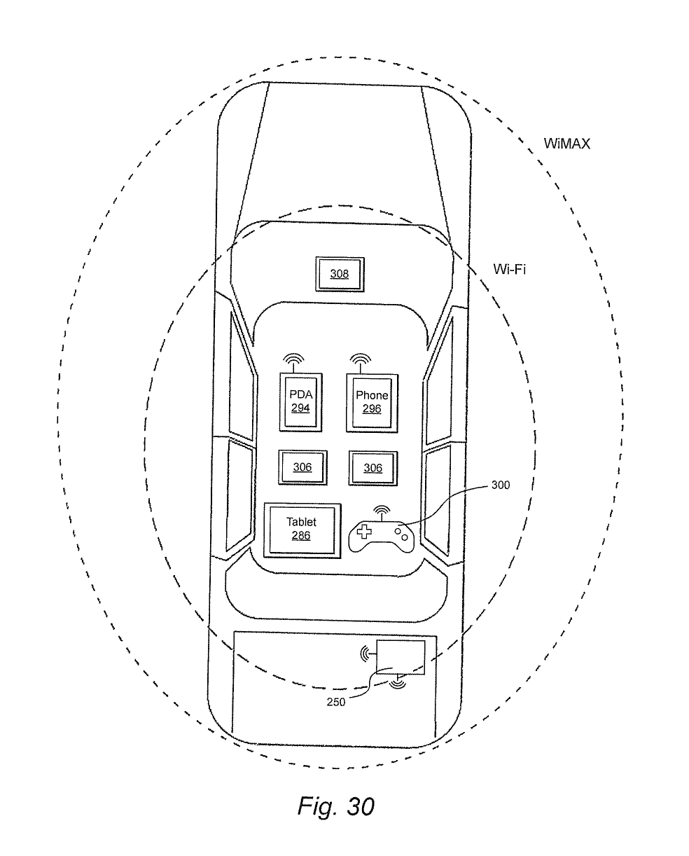

The access device may also provide access to other “servers” other than the user's work server and home server. For example, base modules 250 and peripheral modules in accordance with embodiments of the invention use so little power that they can readily be used in an automobile and be powered by a standard, essentially-unmodified (e.g. requiring no additional batteries, etc.) automobile electrical system, as illustrated in FIG. 30. A vehicle as illustrated in FIG. 30 is merely one example of this type of application, as a variety of devices can readily become “smart” devices by way of incorporating a base module 250 or a peripheral module 252 or a derivative thereof into such devices.

In the example illustrated in FIG. 30, the automobile has a base module 250 mounted in the vehicle's trunk. As base modules 250 in accordance with embodiments of the invention utilize very little volume (e.g. a cube four inches on a side), the base module 250 could be mounted essentially anywhere in the vehicle. If desired, the base module 250 could be connected to a module or device providing storage capabilities. The base module 250 may be connected to a variety of displays 306, either using a wired or wireless connection. In addition, the base module 250 may be configured to connect to or to selectively permit connection to a user's access device when the user's access device is within wireless range of the base module 250 (e.g. in or close to the vehicle). Such access devices may include essentially any devices that can communicatively connect to the base module 250 using any type of communicative connection (e.g. wireless, wired, optical, hybrid, etc.), and may include any of the devices illustrated and discussed with respect to FIG. 29. While the displays 306 may optionally be configured to essentially remain in the vehicle, users of the other devices may bring such devices to the vehicle and leave with them.

The displays 306 may be used to provide a variety of functions permitted by the processing power of the base module. For example, one or more displays 306 may be readily viewable by the driver of the vehicle, and may therefore be used to display gauges (e.g. speedometer, tachometer, fuel, temperature, oil, etc.), GPS or other navigational aid displays, audio system displays and controls, environmental displays and controls and the like. All of these features may be electively displayed by one or more displays 306 accessible to the driver and/or front seat passenger. Touch screen features or other buttons may be used to interact with the displays and permit control of vehicle functions. As the base module 250 may encompass computing power greatly exceeding what is currently available with most current automobile computers, the sophistication of controls and displays, as well as the ability to customize the controls and displays for the users' preferences may be greatly enhanced. One user may want gauges on the left and controls on the right, and another user may want different gauges on the right and controls on the left. Another user may want gauges in the middle, certain controls on the right, and other controls on the left. The possibilities are essentially endless.

Other of the displays 306 may be used to deliver content to passengers of the vehicle, such as to back seat passengers. One passenger may elect to use a display 306 to watch a movie while another passenger may elect to play a game using a different display 306. Each display 306 provides access to the computing power of the base module 250 as described herein with respect to the peripheral modules 252. In this way, multiple different “windows” into the processing power of the base module 250 may be provided by units dedicated to the automobile system or units only temporarily associated with the automobile system.

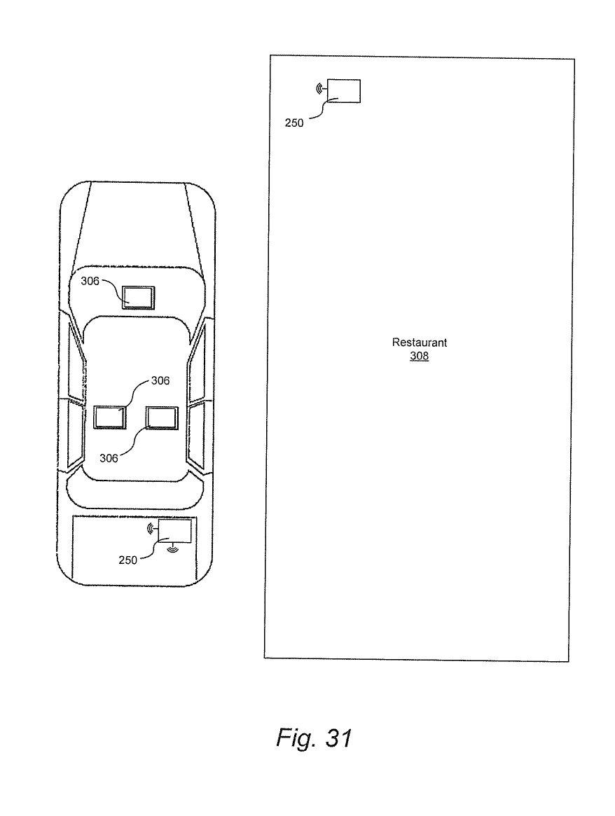

If the base module 250 includes wireless communications features, it may therefore also act essentially as a wireless hot spot for any external resources accessible to it. For example, the base module 250 may be provided with two or more forms of wireless communication. One form may be a longer-range form of communication (e.g. WiMAX, cellular (3 G, 4 G), etc.) permitting the base module 250 to access additional resources such as network or Internet resources. Another form may be a shorter-range form of communications (e.g. 802.11_ formats, Bluetooth, etc.) permitting wireless devices within the vehicle to access resources of the base module 250. Of course, multiple longer-range and/or shorter-range forms of communication may be provided where desirable.

Where wireless communications are available, the base module 250 and/or any devices in the automobile may be used to access resources external to the automobile in a fashion similar to that used to access resources within the vehicle. For example, as illustrated in FIG. 31, a restaurant 308 may have a base module 250 having wireless capabilities of a type permitting the restaurant's base module 250 to communicate with any devices in automobiles that are within a certain range of the restaurant 308. In one example, the range may be limited to automobiles approximately within a drive-through area associated with the restaurant 308. In another example, the range may be such permitting contact with automobiles approaching the restaurant 308 along a nearby road.

Regardless of the range of communication available to the restaurant's base module 250, when the automobile's system enters wireless communications range with restaurant's system, certain actions may optionally be taken. In one example, the user of the automobile system may have elected for the automobile system to not interact with any external systems, and so no connection between the systems would be made. In another example, the user of the automobile system may be set to notify the user that an external system is within range and is offering to establish a connection with the automobile's system. If the user opts to connect to the external system, a connection is then made. Alternatively, the automobile system may be configured or set to automatically establish a connection with all or only with certain external systems.

Regardless of whether a connection is made automatically or only upon some input by the user of the automobile system, when a connection is made, the automobile's system (e.g. the base module 250 and any attached displays 306, peripheral modules 252 (not shown), or other devices (such as PDAs 294, phones 296, controllers 300, etc., not shown) effectively serves as a window into the base module 250 of the restaurant 308 similar in fashion to the way in which the peripheral modules 252 serve as a window into the base module 250 as discussed with reference to FIGS. 19-20 and 29. Thus, the restaurant 308 can serve up advertising to vehicles approaching the restaurant 308 on a nearby roadway, or can serve up an interactive or non-interactive menu to the automobile system. When this is done, no software of the restaurant 308 is running on the automobile system, but a window into the restaurant's system is simply provided.

If the menu is non-interactive, the car's passengers can be better prepared to order when the time comes to order. If the menu is interactive, it may permit the car's occupant(s) to place an order through the system. Because multiple displays 306 or other devices may be available in the automobile for interaction with various passengers, a wide variety of potential interactions with an interactive menu may be possible. For example, each passenger may be able to individually view different parts of the menu (e.g. some screens may show a kids' menu) and make selections therefrom. Each automobile may be able to place one combined or multiple individual orders. Even more-nuanced orders may be possible. For example, if a child in a rear seat attempts to order a meal with unhealthy choices, a parent in the front seat may be able to review and void or change part or all of the child's menu selections.

As may be appreciated, these types of interactions may be facilitated through a system that is a part of the automobile or may also be facilitated by a separate user device that is not a part of or connected to the automobile system (e.g. a phone 286, a PDA 294, a netbook 290, etc.) either because no automobile system is present or because a passenger of the automobile elected not to connect to the automobile system. Even when no automobile system is used, the interaction may be essentially identical, with the base module 250 of the restaurant providing the processing power and other resources accessed by the accessing device. As discussed previously, the various systems are secure regardless of whether an automobile system is used or not, as the only information passed between systems is the input/output data, e.g. for the menu and order.

In at least some instances, the user's access device (as part of the automobile system or not) may further interact with the system of the restaurant 308 to permit using the accessing system to convey payment to the system of the restaurant 308. For example, the accessing system may “know” the identity of the user. Additionally the accessing system may identify that one or more of the user's credit cards is present along with the user's phone 296 (e.g. using RFID or other proximity tags) and may therefore provide an option to the user to use one of the available credit cards for completing the purchase. In this way, the user's interaction with the restaurant 308 can be further streamlined.

If multiple cars are in line at the restaurant, the system of the restaurant 308 may optionally spatially locate each connected system placing an order to thereby ensure that each correct order or orders is ready for each automobile as it arrives at a pick-up window. This may be provided regardless of the time order in which each automobile's order is received. Alternatively, as an order is readied, the applicable automobile system may be notified to proceed to the pickup location. A wide variety of similar or different features may be provided in similar fashion. As another example, the restaurant's system may store a user's previous orders and when connecting to a known mobile system may provide an option to repeat a past (e.g. a favorite) order.

While the restaurant's base module 250 (or its enterprise) may provide drive-up menus and ordering as discussed above, it may simultaneously provide displays throughout the restaurant. It may also simultaneously run the cash registers (essentially peripheral modules 252) inside the restaurant used by the employees to take walk-in orders. Thus, the system may provide both semi-permanent (e.g. cash registers and advertisement displays) and temporary “windows” into the restaurant system's world/enterprise (e.g. drive-through menu ordering).

The stationary system associated with the restaurant 108 shown in FIG. 31 is merely one example of interactions that may occur between mobile and stationary systems. For example, a user may have a variety of media stored on his or her mobile (e.g. automobile) system for ready access. Eventually, however, the user may decide that additional media is needed, such as after all available media has been viewed or otherwise accessed. From time to time as desired, the user may have the mobile system obtain new media from the user's home system and/or synchronize data with the home system. Thus, when the user pulls into his or her garage, the mobile system may connect to the user's home system and obtain new media, synchronize mail messages, or do a variety of other tasks. The foregoing examples are merely illustrative of the variety of types of interaction between mobile and stationary systems that becomes possible with embodiments of the present invention.

While some of the examples discussed above utilize mobile systems to temporarily access resources on stationary systems, such as the restaurant's menu and ordering options. Other examples may allow a user to obtain more persistent data from a stationary system for later use on the mobile system. For example, the mobile system may be presented with one or a series of advertisements while travelling down a road and passing various businesses and/or billboards. In some instances, the user's system may automatically or manually store such advertisements for later access by the user. Thus, if the user is intrigued by a particular advertisement or simply recalls that he or she needs the services of a particular advertiser, he or she may select to store the advertisement for later recall and viewing.

Today's computing devices typically have their own identities and pass files and data back and forth to each other. While some devices in accordance with embodiments of the invention may have individual identities and can pass files to and from devices with other identities, whether or not the devices have their individual identities, they are able to access other devices (e.g. base modules 250) and with or without their own identities and without passing actual files back and forth simply access resources of the other devices. Data becomes seamlessly available on demand without having to be moved from place to place, without having to be permanently modified (e.g. downgraded, converted to a different file type, converted to a different resolution, etc.) to permit access on a specific device, and without mandating access in a specific way. Data may be moved in different way, without requiring loading up an OS in each accessing device, without requiring each access device to be provided with memory to permit loading the OS in the access device, without requiring a compatible accessing program in the access device, without requiring memory to hold the accessing program, without requiring licenses to the programs, without requiring data be separately and redundantly copied in multiple devices (with questions of whether a copy on one device has been changed or not), etc.

As discussed above, a variety of devices configured for use with embodiments of the present invention may be inexpensively provided. For example, a laptop replacement to replace an existing seventeen-inch laptop and configured for use as an access device to access the processing power of the base module 250 may essentially consist of a screen, a mouse, a keyboard, a tiny processor, a bit of RAM and flash memory, an enclosure, and possibly a CD-ROM drive or other peripheral. The laptop replacement would not have or need an internal storage device. Such a device would be extremely inexpensive to make and, if lost or stolen, would not have any sensitive data on it. Thus, businesses, government agencies, and the like that have sensitive data could replace each user's computer with a replacement device such as this that could access and manipulate sensitive data at work, be taken home and freely used at home to access the user's home data, but never be at risk for losing the sensitive work data, as that data would always remain and reside on the base module(s) 250 at work. Such a device would be drastically less expensive than even inexpensive existing laptops.

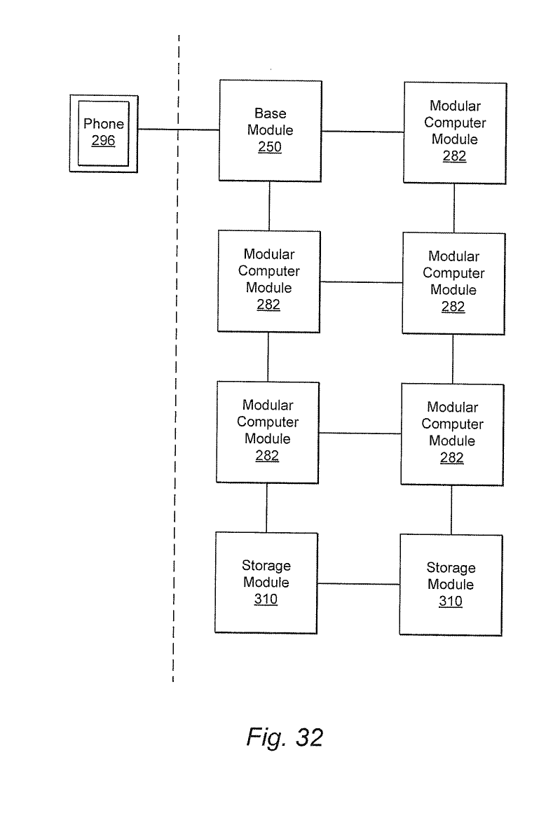

Similar replacements for PDAs, netbooks, smart phones, etc. would also be drastically cheaper than their corresponding current devices. Because of the low cost, a user could easily opt to obtain various devices to access the computing power of the base module(s) 250, and could freely switch between devices depending on the type of screen and input/output desired to be used. And, because of the modular computing capabilities of the base module 250, if the user finds that additional processing power or other resources are needed, the user would simply add another module to the base module 50 having the processing power or resources needed, such as shown in FIG. 32.

In FIG. 32, the phone 296 is shown connected to and accessing a base module 250. In some instances, a single base module might be enough to satisfy the computing and other device needs of the user. However, the particular use of the configuration shown in FIG. 30 might have discovered that additional processing power was needed, and so added additional modular computer modules 282, which may include, for example, two base modules 250. In addition, the user may have added three modular computer modules 282 including a GPU (instead of a CPU) as discussed in the related applications, thereby providing supercomputing power to the user of the phone 296 in a way simply impossible with existing phones 296. To satisfy the user's storage needs, the user might also have added two storage modules 310 (another specific example of a type of modular computer module 282), each essentially dedicated to storage and having a desired storage capacity. By way of example, a storage module 310 may contain a solid state hard drive or a standard hard drive, and may have a size and shape similar to the size and shape of the peripheral module 252 shown in FIGS. 22-25. The storage module 310 may also be capable of physical attachment to the base module 250 in a fashion similar to that shown in and discussed with respect to FIG. 24.

While FIG. 32 shows a single device (e.g. phone 296) accessing the system, and a power user might readily use such power, it should be understood that other devices may be used in addition to or as a replacement to the device shown in FIG. 32. The link between the accessing device(s) can be wired, wireless, optical, a hybrid link, etc., and can be any type of connection having sufficient bandwidth to provide video and input/output. For example, existing communications structures and protocols are easily adequate to provide such communication even over long distances, such as over a cellular network. Embodiments of the invention thus are capable of providing mobile supercomputing power accessible through a wide range of extraordinarily inexpensive mobile devices and over existing communications structures without requiring additional wireless bandwidth that may be harmful to people's health.

Modular virtualization can be scaled over a variety of hybridizations between maximally-simple access devices and today's complex computing devices. When the accessing devices are able to handle some processing and storage locally, it may do so, but at some point, the processing, storage, etc. is passed off to the base device 250, especially with more sensitive types of data. The border between the two types of processing may be essentially transparent. This is now possible because of modular computing such as shown in FIG. 32 and disclosed in the related applications, as additional processing power is simply added by adding a new module, where an existing computer must be essentially torn apart and rebuilt or completely replaced to add new features.

Consider, for example, a high frame rate game being played using the configuration of FIG. 32. The phone 296 (or whatever access device) does nothing other than display the video feed and pass inputs from the user back to the system. The base modules 250 allow the GPUs of the modular computer modules 282 to process and deliver the polygon calculations and provide the frames to the virtual client—no data crunching occurs in the phone 296. Thus, the battery needs of the phone 296 are greatly reduced (no energy for processing is needed) and the phone 296 is able to be used to play games that were impossible to play on a phone previously due to processing limitations and energy limitations.

Each access device (e.g. phone 296) would essentially become an access device that could be usable for life, as it might simply contain a display and input/output. As improvements are made in processing power and other features, they could simply be added to the user's home or work systems (the portion right of the dashed line in FIG. 32). The home or work systems are typically more secure than a mobile system. The user's experience at the phone 296 is thus capable of large changes in capabilities with no change to the phone 296 whatsoever. If the user somehow forgets his phone 296 in a cab or airport, very little is lost (no data is lost), and a replacement costing a few dollars easily gets the user going again.

Even if upgrades are available to the phone 296 (e.g. an improved screen or input/output), it can readily be replaced at low cost. The new device does not include costly memory, storage, etc. and is therefore much less expensive. The system can easily be adapted to new protocols, communications buses, structures etc., and only the affected device or structure may be replaced.

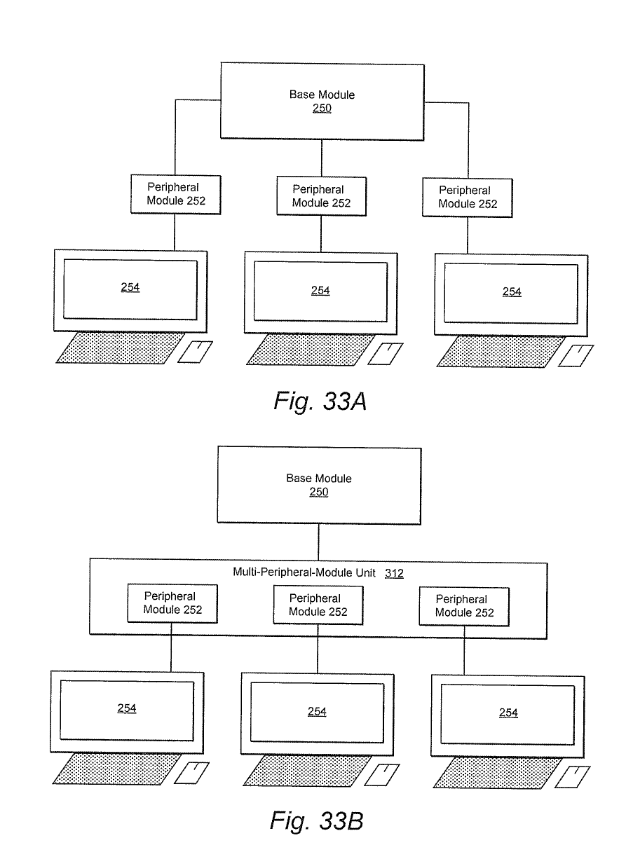

Although various systems and configurations illustrating features of embodiments of the invention have been discussed herein with respect to individual peripheral modules 252 and devices incorporating individual peripheral modules 252 therein, embodiments of the invention are not limited to such configurations. By way of example, FIG. 33 shows a comparison between a representative system having individual peripheral modules 252 (similar to the system illustrated and discussed with respect to FIG. 20) and a system incorporating a multi-peripheral-module unit 312. In the illustrated embodiment, the multi-peripheral-module unit 312 incorporates features and functionality equivalent to the functionality of three peripheral modules 252. Of course, the multi-peripheral-module unit 312 may incorporate features and functionality equivalent to more or fewer peripheral modules 252, and the illustrated number is merely by way of illustration.

There are certain features that differ between the two systems show in FIG. 33. In the upper system, three separate peripheral modules 252 are directly connected to the single base module 250. This may be advantageous and desirable in some situations, and disadvantageous in others. For example, the base module 250 may have a limited number of connection ports, and it may be desirable to conserve the connection ports. As a contrary example, the physical locations of the peripheral modules 252 may be favored by such a connection.

In contrast, the lower system has a single multi-peripheral-module unit 312 connected to the base module 250, thus conserving connection ports on the base module 250 for other uses. This particular configuration may be particularly useful when a base module 250 is to be physically located in a remote location and it is undesirable to have many connecting wires running between the location of the base module 250 and the location of the multi-peripheral-module unit 312. These alternate configurations (and combinations thereof) further illustrate the great flexibility that may be achieved using embodiments of the invention.

In at least some embodiments, a transmitter/receiver repeater is located at each peripheral module 252 and at each device 254. In at least some embodiments, a dongle is located at each peripheral module 252 and at each device 254. In at least some embodiments, multi-peripheral-module unit 312 includes a processor and/or memory. In at least some embodiments, multi-peripheral-module unit 312 does not include a processor or memory. In at least some embodiments, multi-peripheral-module unit 312 is a peripheral module.

Another example of the powerful uses that are enabled by embodiments of the invention may be understood referring back to FIG. 30. If the automobile shown in FIG. 30 were a police car, the base module 250 may be connected to the displays 306 as well as to a dashboard camera, and input/output devices accessible to the officer. As the officer is pulling a car over in a remote location, the system may be used to provide analytics to the officer. For example, the officer could enter the car's license plate, or it may be automatically obtained by the dashboard camera. The system could then utilize a longer-range communication to access records regarding the license plate and/or vehicle being pulled over. Warnings could be provided to the officer as part of the analytics.

For example, the system might warn the officer that the license plates or the car is stolen. Alternatively, the system might indicate that the license plates belong to a red sedan while the officer can see that they are attached to a blue SUV. The system might warn that the driver of the vehicle does not have a license, has a history of DUI/DWI convictions, and a history of violence. The system could also analyze the driving patterns of the car being pulled over, and might indicate that the driving pattern is highly indicative of drunkenness, or that the driving pattern is similar to that seen in other instances where policemen were attacked or shot during a stop. The officer, armed with such information will be better able to judge whether or not to wait for backup before approaching the pulled-over car, or may change his or her anticipated approach. Alternatively, the system might automatically call for backup even before the officer has completed pulling over the suspect, or on occurrence of any of a variety of conditions.

For example, the system may be connected to a mobile system carried by the officer and could be activated by the officer remotely if trouble is discerned. Alternatively, a biometric monitor or sensor could monitor the officer's condition and automatically signal for help if there were a change in vital signs. Any of a variety of occurrences (detection of a gunshot, etc.) could be analyzed and used by the system to request necessary backup manually or automatically. Every part of the interaction between a suspect and the officer could be recorded, including dash cam video, audio at the officer, etc., and could be instantly processed and transmitted elsewhere if needed.

The officer could also have a portable device that could interact with the officer's own systems and/or with any systems of the suspect vehicle, allowing the officer to, for example, remotely enter ticketing information and provide the suspect with a ticket without ever leaving the side of the suspect, reducing danger to the officer possible from the driver attempting to access a weapon while the officer is back in the patrol car. A portable camera or scanner could be used to photograph the driver's license or the driver himself, and to transmit the information out for a check for outstanding warrants and the like. If no reason exists to arrest the driver, the officer could issue an electronic ticket that may be received and stored by the driver's car's system. It could be possible, as with restaurant payment discussed above, for the driver to pay the ticket on the spot.

If both the patrol car and the suspect car have intelligent systems of the type shown in FIG. 30, the systems might be configured to permit the patrol car system to send a signal to the fleeing car to either shut down or slow down to a slow rate of speed, preventing high-speed chases. To prevent such a system from being used by a non-officer, the system may only slow the car to a moderately-slow rate of speed, so that an innocent driver scared that the chasing vehicle is not a police vehicle can still drive to a safe location before pulling over. The officer could even open a communications link (audio and/or video) to the vehicle or vice versa to allow the driver and the police officer to reassure each other of their intentions. Again, the possibilities are essentially endless.

Still other advantages may be obtained by various embodiments of the invention. For example, the user's accessing device may be simply incapable of contracting a computer virus or other harmful software, as it simply doesn't run any software beyond the simple access software contained on the unchanging flash memory. Systems being accessed by various users are therefore also more ensured that they cannot receive a virus from the accessing devices.

In today's digital world, it is very difficult for copyright owners to prevent copying, even perfect copying of their works (e.g. movies). With embodiments of the present invention, however, it may become much easier for the copyright owners to protect their works, as the works may never leave the possession of the copyright owner. Instead, the user simply accesses the system or network of the copyright owner by way of modular virtualization. The work may then be viewed using the “window” into the copyright owner's system or network without the viewed work ever leaving the copyright owner's system or network and through the system or network's own user interface.

### Provision of Computing Resources Using Modular Device(s)

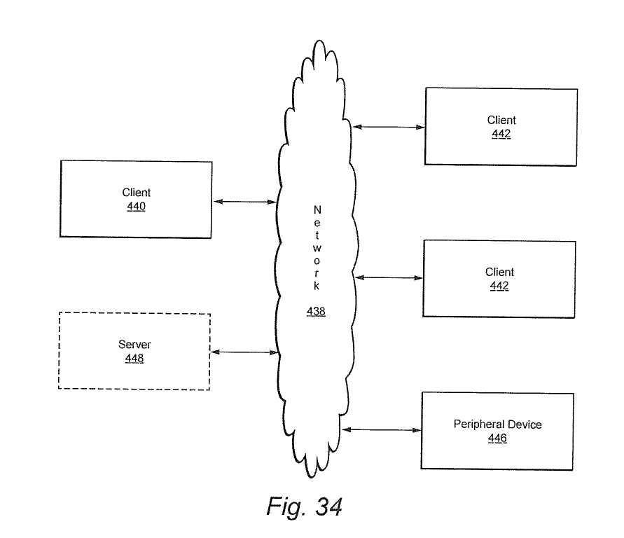

Thus, while those skilled in the art will appreciate that embodiments of the present invention may be practiced in a variety of different environments with many types of system configurations, FIG. 34 provides a representative networked system configuration that may be used in association with embodiments of the present invention. The representative system of FIG. 34 includes a computer device, illustrated as client 440, which is connected to one or more other computer devices (illustrated as clients 442) and one or more peripheral devices 446 across network 438.

While FIG. 34 illustrates an embodiment that includes a client 440, two additional clients 442, peripheral device 46, and optionally a server 448 connected to network 438, alternative embodiments include more or fewer clients, more than one peripheral device, no peripheral devices, no server 448, and/or more than one server 448 connected to network 438. Any of the computer systems illustrated in FIG. 34 may utilize and/or incorporate features discussed herein, such as base modules and/or peripheral modules. Thus, any of the computer device, the client 440, the client 442, the server 448, etc. may include or consist of a base module and/or a peripheral module. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

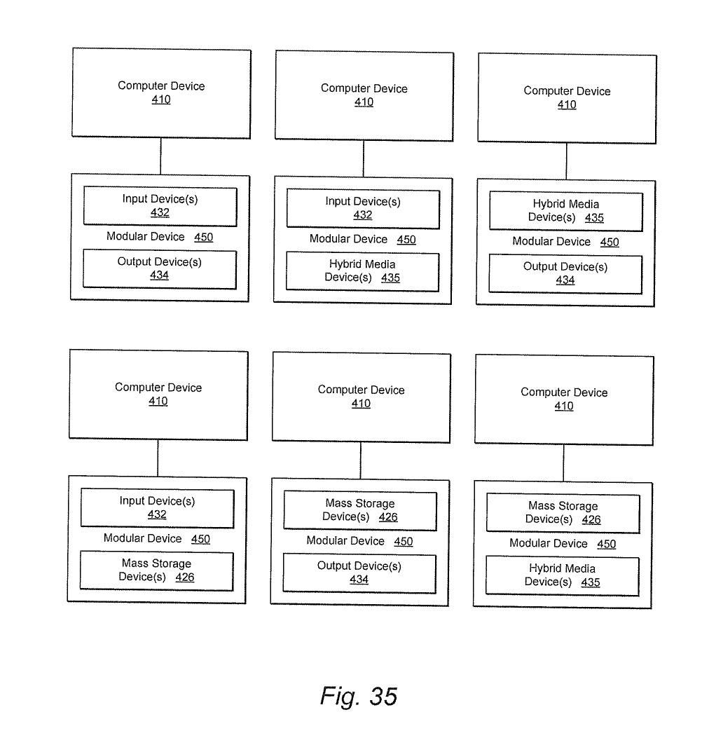

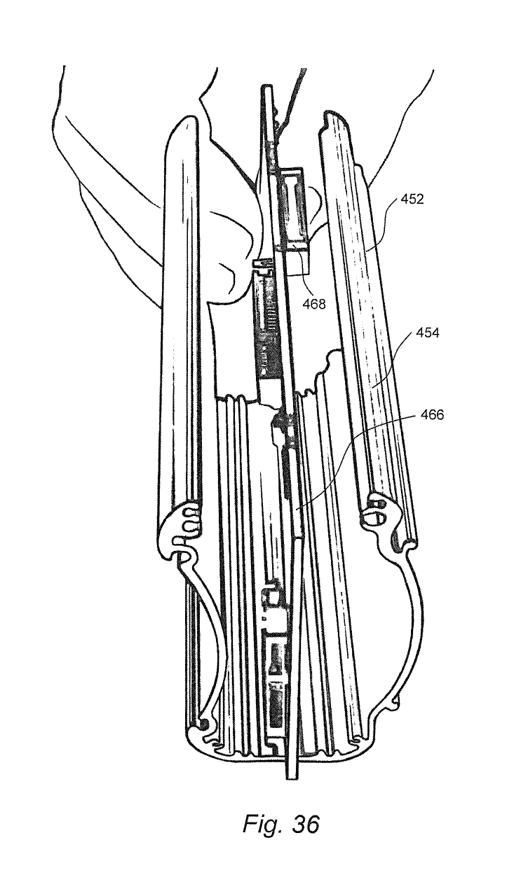

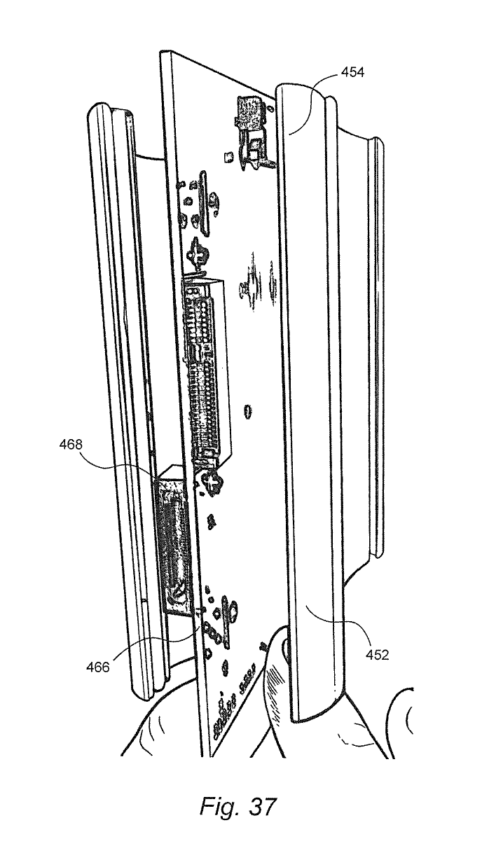

Certain embodiments of the invention permit the unification of multiple devices in a single modular device 4450 as illustrated in FIG. 35. Modular devices 450 may include different devices and may be configured in a variety of ways, as is also illustrated in the depiction of FIG. 35. FIG. 35 depicts six different conceptual configurations of modular devices 450, each of which is further representative of potentially several different types of modular devices 450. Each modular device 450 may be selectively attached to the computer device 410 using any of a variety of communicative connections (e.g. wired connections such as USB, PCIe, IEEE 1394, eSATA, hybrid media bus, fiber optic, or any other standard or proprietary wired connection, wireless connections such as WiFi, WiMAX, infrared, other optical, or any other standard or proprietary wireless connection, and any other type of communicative connection now existing or later invented). The modular device 450 may be communicatively connected to the computer device 410 directly or through one or more additional communicative connections, such as through a network or modular computer system as discussed in some of the related applications.

Each modular device 450 includes one or more devices providing some functionality to the computer device. For example, as illustrated in the upper left depiction of FIG. 35, the modular device 450 may include one or a combination of one or more of the input devices 432 and one or more of the output devices 434. Alternatively, as illustrated in the upper central depiction of FIG. 35, the modular device 450 may include one or a combination of one or more of the input devices 432 and one or more of the hybrid media devices 435. Alternatively, as illustrated in the upper right depiction of FIG. 35, the modular device 450 may include one or a combination of one or more of the output devices 434 and one or more of the hybrid media devices 435. Alternatively, as illustrated in the lower left depiction of FIG. 35, the modular device 450 may include one or a combination of one or more of the input devices 432 and one or more of the mass storage devices 426. Alternatively, as illustrated in the lower central depiction of FIG. 35, the modular device 450 may include one or a combination of one or more of the output devices 434 and one or more of the mass storage devices 426. Alternatively, as illustrated in the lower right depiction of FIG. 35, the modular device 450 may include one or a combination of one or more of the mass storage devices 426 and one or more of the hybrid media devices 435. The specific modular devices 450 depicted and discussed with respect to FIG. 35 are intended to be illustrative only.

In at least some embodiments, the modular device 450 is “modular” in that it includes a single chassis or housing containing some, a majority, or all of the components making up the modular device. By communicatively connecting the modular device 450 to the computer device 410, resources of the modular device 450 are made available to the computer device 410. Because embodiments of the modular device 450 include or have the capability to include multiple devices, the resources of these multiple devices may be made available to the computer device 410 using a single communicative connection and using a single effective modular device.

With reference back to FIG. 25, a perspective view of one illustrative embodiment of a housing 252 is shown that may be used for the modular device 450. As may be seen in this Figure, the housing 252 includes an outer structural shell 270 and two end caps 272. The structural shell 270 and end caps 272 serve to enclose and protect components of the modular device 450. The structural shell 270 may be made of a variety of materials, including plastics and metals, including aluminum and/or metal alloys, and may be formed in a way so as to provide structural functions as discussed in the related applications. Additionally, the structural shell 270 may be formed so as to mate with the structure of other modular devices 450 or other computer components as is illustrated in FIG. 27. Any ports provided to the modular device 450 may be provided at either end (e.g. by passing through one or more of the end caps 272) or along one of the edges of the modular device (e.g. by passing through an open end of the shell 270 or through an opening in a cover plate closing an open end of the shell 254, as shown in FIG. 26.

FIGS. 24 and 26 show end and perspective views of the housing 252, respectively. In these views and in the view of FIG. 25, some features of the structural shell 270 are visible that show one way in which mating with other devices may be accomplished. As may be seen in FIGS. 25 and 24, the structural shell 270 may be formed (e.g. extruded) to have a pair of mating protrusions 278 on one major side of the housing 252. As may be seen in FIG. 26, the opposite major side of the structural shell 270 in this embodiment is formed to have a corresponding pair of mating channels 279 that can accept the mating protrusions 278. As may also be seen in FIGS. 25 through 26, the end caps 272 do not include either the mating protrusions 278 or the corresponding mating channels 279. The other device includes corresponding mating channels 279 or mating protrusions 278 on at least one of its sides (but again, not on its corresponding end caps), as illustrated in FIG. 27.

To structurally attach the modular device 450 to some other device, such as computer device 410 in the manner shown in FIG. 23, an end cap 280 of the computer device 410 is removed (tamper-resistant fasteners may be used to deter theft or vandalism), and the mating protrusions 278 of the modular device 450 are slidingly engaged with the corresponding mating channels 279 of the computer device 410. The modular device 410 slides until it is fully mated with the computer device 410. The end cap 280 of the computer device 410 is reattached to the computer device 410 and thereby locks the modular device 450 to the computer device 410. Additional modular devices 450 or other components may be attached to the system using the mating channels 279 of either the modular device 450 or of other sides of the computer device 410 as desired, with the corresponding end cap being removed to facilitate such attachment.

The illustrated embodiments shown in FIGS. 23-26 are merely illustrative of ways that embodiments may be constructed to permit structural connections between modules and with other devices. Thus, for example, while the illustrated housing 252 has mating protrusions 278 on one major side and mating channels 279 on another major side, another embodiment may have mating channels 279 on both major sides, as illustrated in the end view depiction of an alternate outer structural shell 270 shown in FIG. 27.

The structural shell 270 of the may be load bearing as disclosed in one or more of the related applications. The modular device 450 may therefore be used as a mount from which to hang a monitor or other device, may be embedded or mounted in a wall, may be a part of a frame, and may perform any of the structural functions disclosed in the related applications. For example, a plate may be mounted to a wall and another plate may be mounted to a monitor, and the two plates may be connected together through the structural features of the modular device.

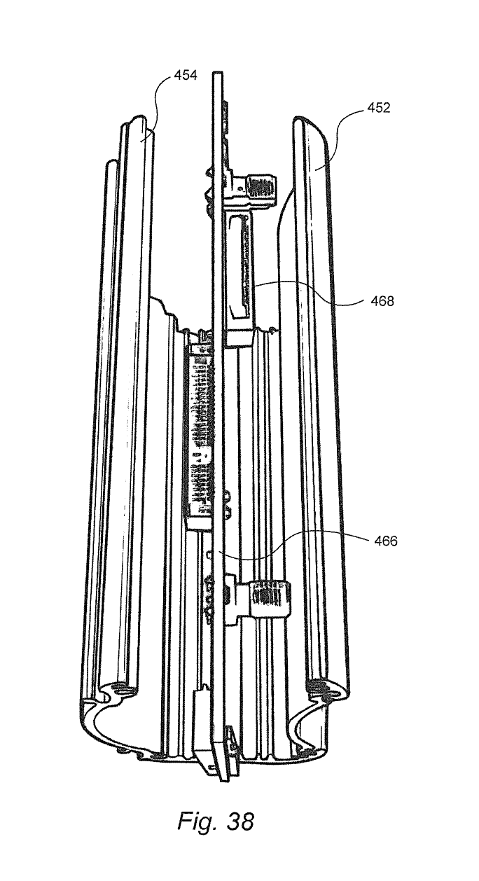

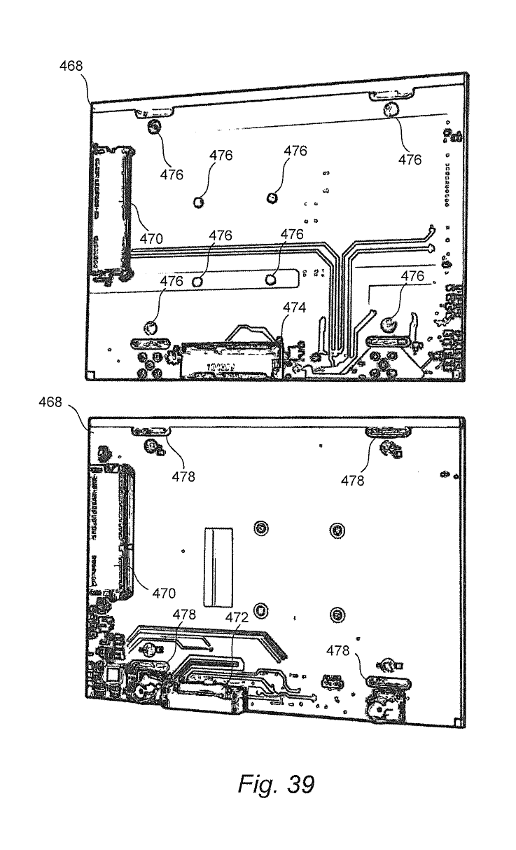

To allow the housing to contain multiple devices as illustrated in FIG. 35, embodiments of the invention utilize a bilateral printed circuit board (PCB 466) that can be mounted within the housing 452 as illustrated in FIGS. 39-38. The PCB 466 may be mounted in a channel (not shown) or other mounting structure provided in the interior of the shell 454 so as to be more-or-less centrally mounted within the housing 452. The PCB 466 provides both structural support for mounting any components or devices thereon and communicative coupling between any components or devices mounted thereon and to one or more ports 468 or other communicative devices providing communication between the components or devices and any computer device communicatively connected to the modular device 450.

The centralized mounting of the PCB 466 permits mounting of components and/or devices on both sides of the PCB 466 in a novel fashion. This mounting facilitates compact modular devices 450 providing functionality not available in current devices. For example, in a modular device 450 providing primarily storage functionality, mass storage devices 426 may be mounted on both sides of the PCB 466, thus providing for two mass storage devices 426 within the same housing a single PCB 466 in a compact amount of space. Meanwhile, if the storage capabilities of multiple mass storage devices 426 are not needed, the same PCB 466 may be used in conjunction with a single mass storage device.

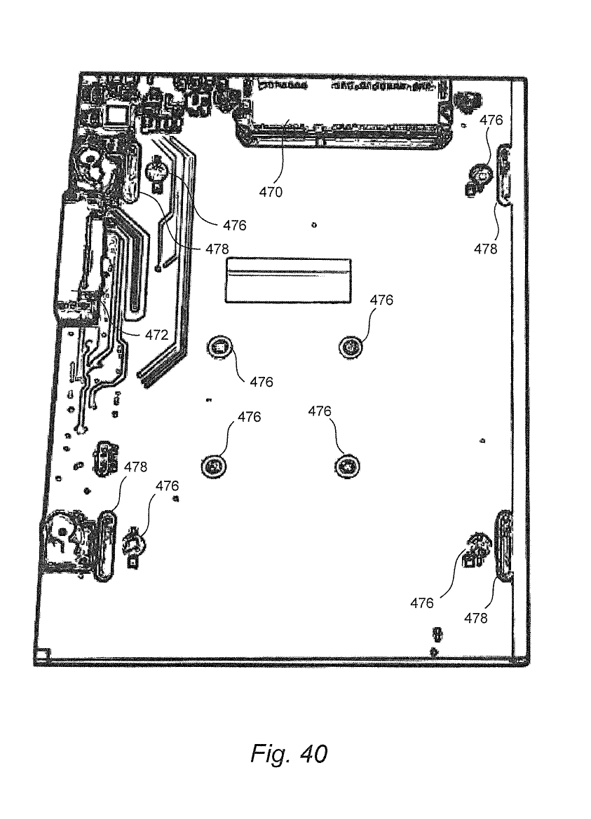

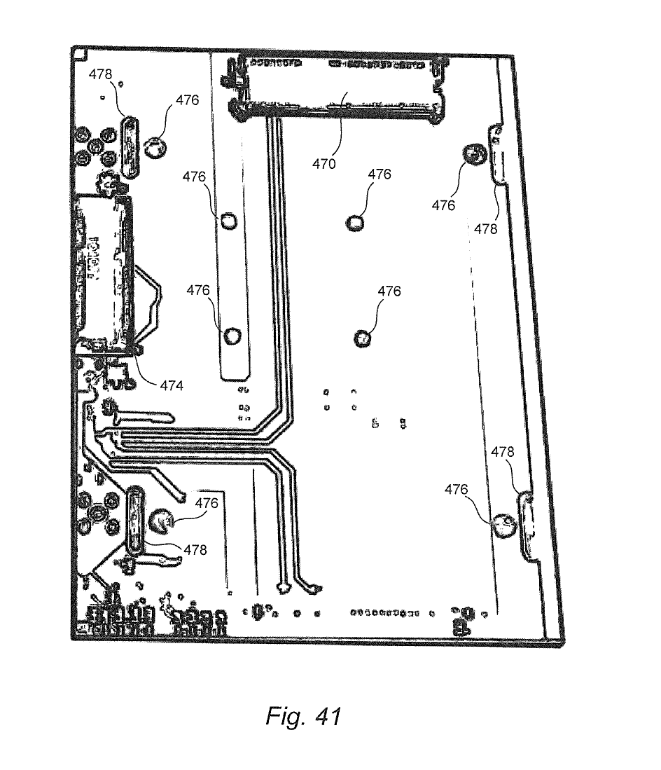

One manner in which this may be achieved may be appreciated by reference to FIGS. 39 through 41, which provide depictions of a representative embodiment of the PCB 466. FIG. 39 shows a side-by-side comparison of front and back views of the PCB 466, while FIG. 40 shows a larger view of just the front side and FIG. 41 show a larger view of just the back side of the PCB 466. As may be seen in these Figures, a connector 470 for connecting a mass storage device (such as a hard drive, solid-state drive, hybrid drive, and the like) is provided on each of the front and back sides of the PCB 466. In the illustrated embodiment, the connectors 470 are disposed to be on opposite longitudinal ends of the PCB 466 as well as on opposite faces of the PCB 466, but in other embodiments, the connectors 470 may be disposed on a single longitudinal end.

One face of the PCB 466 also includes a port connector 472 that provides the port 468 discussed previously. It should be noted that the illustrated port 468 and/or port connector 472 is merely intended to be illustrative: multiple ports 468 and/or port connectors 472 may be provided, these port(s) 468 and/or port connector(s) 472 may be provided at other locations and/or sides of the PCB 466, and any desirable type of port 468 and/or port connector 472 may be provided, or no port 468 or port connector 472 may be provided when some other communicative mechanism is to be used.

The other face of the PCB 466 in the illustrated embodiment is provided with an additional device connector 474 that may be similar or different from the connectors 472. For example, the device connector 474 may be of a type optimized for connection of devices other than mass storage devices. As with the port connector(s) 472, the type, location, and number of the device connector(s) 474 illustrated in FIGS. 39-41 is merely illustrative, and varying types and numbers of device connectors 474 may be provided, including embodiments with no device connectors 474.

To facilitate mounting of one or more devices to the PCB 466, the PCB 466 of the illustrated embodiment is provided with several features. The first feature is a plurality of direct mounting holes 476 passing through the PCB 466. The number and placement of the direct mounting holes 476 illustrated in FIG. 39 is merely illustrative, and may be varied according to the specific needs of each embodiment. In certain embodiments, no direct mounting holes 476 are provided, and in other embodiments, any number of direct mounting hole(s) 476 greater than zero may be present.

The direct mounting holes 476 may be used to mount a component or device directly to the PCB 466. For example, in the illustrated example, the more-centrally located direct mounting holes 76 may be used to mount a smaller component to one side of the PCB 466 by way of inserting fasteners such as threaded fasteners through the direct mounting holes 476 into corresponding threaded holes on the smaller component. The more-exterior direct mounting holes 476 may be used to mount a larger component to the other side of the PCB 466 by way of inserting fasteners through the direct mounting holes 476 in the opposite direction into corresponding threaded holes on the larger component. As long as any potential short-circuit issues that could be potentially caused by contact of one of the mounted components to the fasteners are avoided (such as by spacers, insulation, etc., the direct mounting holes 476 may be used to directly attach two components or devices in this fashion on opposite sides or faces of the PCB 466.

Of course, it will be realized that where only a single component or device is needed, only one set of the direct mounting holes 476 would be used and a component or device would only be located on a single side of the PCB 466. The other side of the PCB 466 would remain available for mounting of another device at a later time. Depending on the type of device(s) or component(s) and its/their communicative and/or power connection(s) to the PCB 466, the mounting procedure may entail first inserting the device/component into the applicable connector(s) (e.g. connector 470) and then securing the device/component to the PCB 466, or it may entail separately making a communicative/power connection between the device/component and the applicable connector(s) either before or after mounting the device/component to the PCB 466.

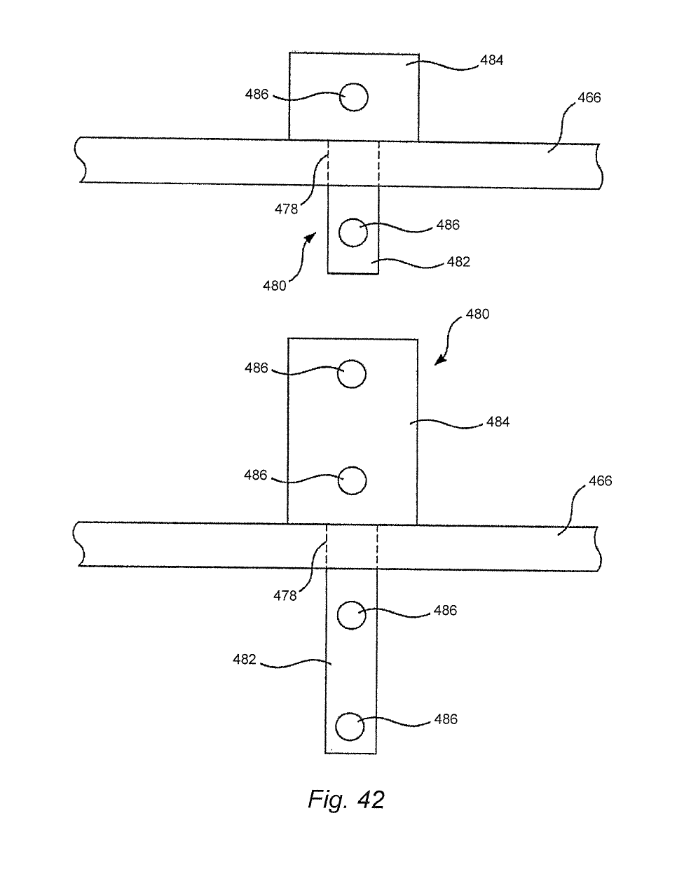

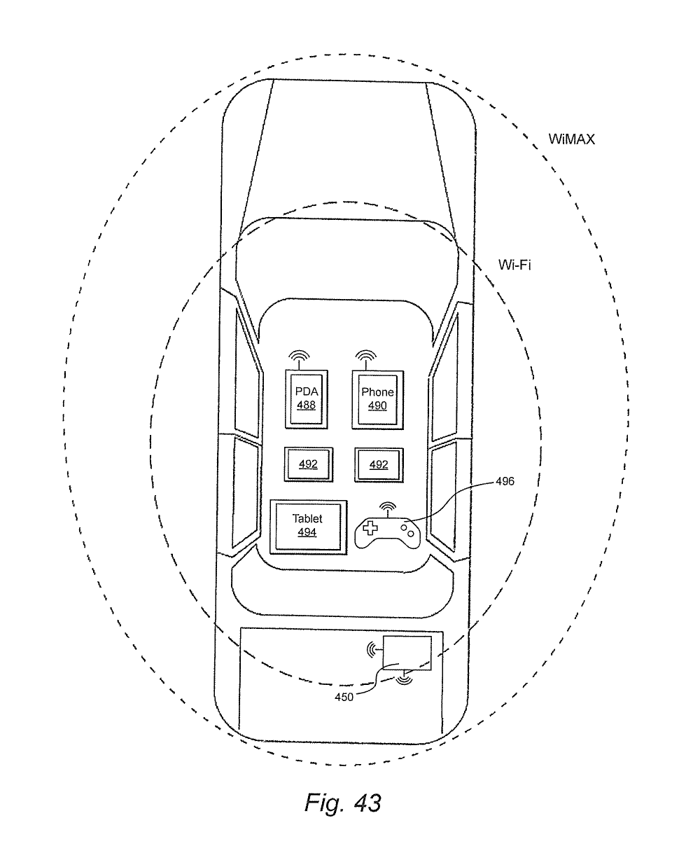

While the direct mounting holes 476 may permit mounting of a wide variety of devices to the PCB 466 and may even permit mounting of devices on both sides or faces of the PCB as discussed above, it is anticipated that it may not be possible to use the direct mounting holes 476 to mount devices on both sides of the PCB 466 in all circumstances. For example, the first-mounted component or device may obscure one or more needed direct mounting holes 476, thereby preventing mounting of the second component or device. Therefore, embodiments of the invention utilize an indirect mounting slot 478 as shown in FIGS. 39-41. The mounting slot 478 is adapted to receive a T-shaped connector 480 as shown in FIG. 42. The T-shaped connector 480 is a flat element having a narrow end 482 adapted to be inserted into and received by the indirect mounting slot 478 and a wide end 484 that is wider than the indirect mounting slot 478. Thus, the narrow end 482 of the T-shaped connector can be inserted into the indirect mounting slot 478 until the wide end 484 contacts the PCB 466, stopping further entry of the T-shaped connector. In at least some embodiments, the T-shaped connector may be soldered into place after insertion into the indirect mounting slot 478.

Both the narrow end 482 and the wide end 484 have at least one connector mounting hole 486 therein. As illustrated in FIG. 42, different embodiments of the T-shaped connector may be provided with more or fewer connector mounting holes 486 placed to be on each side of the PCB 466. Of course, it will be appreciated that while the lower version of the T-shaped connector 480 shown in FIG. 42 may permit the mounting of additional component(s) or device(s) on each side of the PCB 466, it will require a housing 452 of greater internal volume than the upper version of the T-shaped connector 480 shown in FIG. 42. The connector mounting holes 486 accept fasteners such as threaded fasteners therethrough and into one or more components to be mounted on the PCB 466 indirectly by way of the T-shaped connector 480. While two embodiments of the T-shaped connector 40 are shown in FIG. 42, other embodiments may have more connector mounting holes 486 than the number shown, and still other embodiments may have differing numbers of connector mounting holes 486 on the narrow end 482 compared with the wide end 484.

In certain embodiments, the T-shaped connectors 480 may be used in conjunction with the direct mounting holes 476 to mount multiple devices/components to opposite sides of the PCB 466, or may be used independently from the direct mounting holes 476 (if even present) to mount multiple devices/components to opposite sides of the PCB 466. If the direct mounting holes 476 are used, the first component is mounted to the PCB 466 using the direct mounting holes 476 first. Afterward, the T-shaped connectors 480 are used to mount a second device on an opposite side of the PCB 466. If the T-shaped connectors 480 allow mounting of additional device(s)/component(s), it or they may be mounted in like fashion.

Many hard drives, for example, have threaded receptacles in both the bottom and sides of the hard drives. The bottom threaded receptacles may be used in conjunction with at least some of the direct mounting holes 476, and the side threaded receptacles may be used in conjunction with at least some of the T-shaped connectors 480. Of course, placement of the direct mounting holes 476 and the indirect mounting slots 478 may be chosen to facilitate mounting in the described fashions. As will be appreciated, the size of the modular device 450, the PCB 466, and the placement of the various holes and connectors may be varied as desired and selected in accordance with the anticipated devices/components to be used in the modular device 450.

Embodiments of the invention may be used in a wide variety of fashions to provide advantages not currently available in the art. The additional three-dimensional connection arrangements provided by embodiments of the invention reduce the volume needed for equipment while still permitting adequate air flow and cooling capability. Additionally, such arrangements permit the connection of multiple devices of varying types within a single component as discussed above with respect to FIG. 35.

As another example, a modular device 450 may be configured as a storage device. While the modular device 450 may function essentially as a standard enclosure for a single mass storage device, the modular device 450 may also provide, in a single package, storage options not currently available. For example, if the modular device 450 is configured to contain up to two mass storage devices, a first mass storage device may be chosen according to first desirable performance or other characteristics, while the second mass storage device may be chosen according to second desirable performance or other characteristics. As one specific example, some users may desire the high performance characteristics of solid-state drives for storing operating systems (OSs) and application programs, while desiring the inexpensive large storage capability of spinning magnetic drives for storing all other data. Other users may desire only maximum capacity, while still other users may desire only maximum performance.

Embodiments of the invention cater to these specific desires in a flexible fashion. The modular device is simply provided with two drives: a solid state drive of appropriate capacity for the OS and application programs, and a spinning magnetic drive of appropriate size for the other data. Of course, different users may need different sizes of the two drives and may customizably select their drive capacities differently accordingly. Additional benefits are available as well: where existing hybrid drives usually have limited solid state capacity and can never have that capacity changed, any size of solid state drive may be initially chosen for the modular device 450, and can easily be swapped out at a later point in time for a drive of a different size without requiring replacement of the entire modular device 450. Similarly, if a user later needs additional capacity of the spinning magnetic drive or later desires the higher performance of a solid state drive, a similar change is made.

Another example may be realized by the combination of differing types of devices or components within the modular device 450. For example, an embodiment may be provided that provides features associated with digital video recording (DVR) technology. Thus, one of the devices or components within the modular device 450 may be a mass storage device, and another device or component may be a video capture component. In such an embodiment, a port may be provided to receive video signals (e.g. from an antenna or from a cable device), or an internal or external antenna may be attached to the modular device 450.

As another example, a wireless card or device could be mounted on one side of the PCB 466, and could allow the modular device 450 to communicate wirelessly with one or more remote devices. Some embodiments may be provided with a graphics card or device mounted on one side of the PCB 466 for outputting video signals. Indeed, any device that could be plugged into any port or connector provided on the PCB 466 (e.g. mini PCI, mini PCIe, etc.). Supporting mechanical and electronic devices can be connected to the modular device 450 as desired to provide additional features and functionality.

As another example, a modular device 450 could be provided with a mass storage device and a dual-band wireless device on opposite sides of the PCB 466. The dual-band wireless device may provide local WiFi connections to other devices in proximity of the modular device 450 (e.g. PDA 488, phone 490, display 492, tablet computer 494 (or any other computing device), and controller 496) while simultaneously providing longer-range WiMAX connections to permit accessing of external content, as illustrated in FIG. 436. Meanwhile, the mass storage device could provide storage and applications, including to external modules relying on the modular device 450 for providing computing capabilities.

Thus, embodiments of the invention are capable of customization to provide the best of price and performance in a single package. Embodiments also permit pairing of functions within a single modular component that might not normally be available. Embodiments of the invention may be particularly useful with systems and methods described in some of the related applications.

### Interactive Computing System

Embodiments of the present invention relates to an interactive computing system. In particular, at least some embodiments of the present invention relate to systems and methods that increase the capability and performance of a portable computer device (PCD) by linking the PCD with a stationary processing control unit (PCU). In some embodiments, the present invention further relates to systems and methods that increase the usability of a PCD by creating and associating scripts to defined movements or orientations of the PCD, thereby providing a desired processing function.

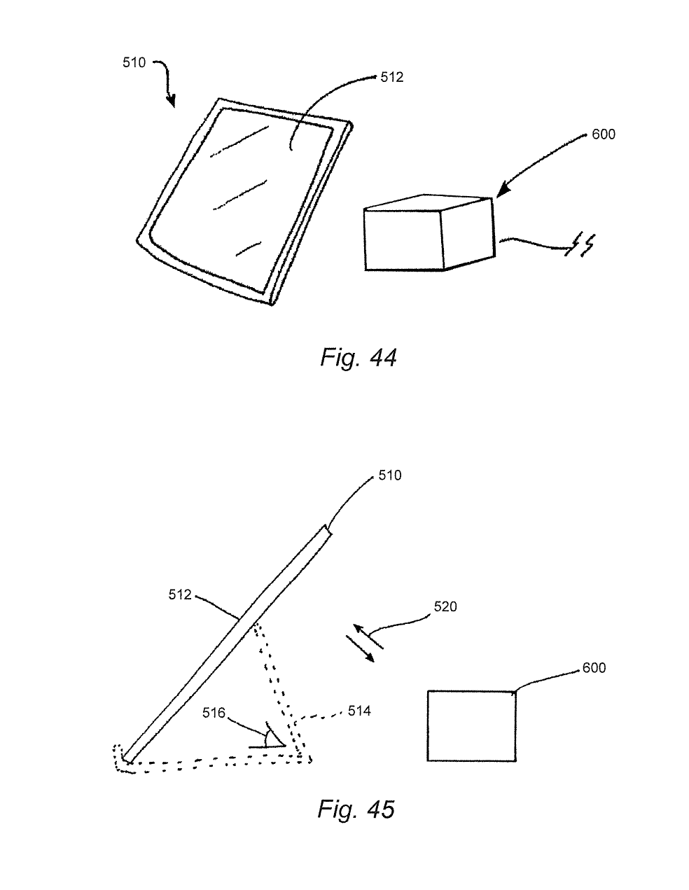

Referring now to FIG. 44, a PCD 510 and a PCU 600600 are shown. PCD 510 generally comprises a computer device or electronic device having processing power whereby to portably perform a desired function. For example, in some embodiments PCD 510 comprises a processor-based portable consumer device, such as a laptop computer, a personal digital assistant (PDA), a tablet computer, a cellular phone, a gaming system, a media player/recorder, and/or another portable electronic consumer device. PCD 510 may further include electronic devices comprising a plurality of desired functions.

In some embodiments, PCD 510 comprises a display whereby a user is able to visually and/or haptically interact with the PCD via a display 512. In some embodiments, display 512 is a touch screen. The dimensions of display 512 will vary greatly depending upon the type and function of PCD 510.

In some embodiments, PCD 510 comprises processing means, such as a central processing unit (not shown) whereby to perform various desired functions. In some embodiments, PCD 510 further comprises an arithmetic logic unit, a control unit, memory, and at least one input/output (I/O) device. Further, in some embodiments PCD 510 comprises at least one executable software program having computer readable instructions whereby to provide operating instructions to the processing means. Still further, in some embodiments PCD 510 comprises an antenna (not shown) whereby to facilitate wireless communication with an external device and/or network. Other features, systems, and elements commonly incorporated into a PCD 510 will be understood and appreciated by one having skill in the art.

In some embodiments, PCD 510 further comprises external keys and/or buttons to further facilitate use of the device by a user. For example, in some embodiments PCD 510 comprises an external power button (not shown). In other embodiments, PCD 510 comprises and external volume control button (not shown). Still further, in some embodiments PCD 510 comprises an external shortcut button (not shown) whereby to quickly access a desired program or function of the device. In other embodiments, PCD 510 comprises an external trackball or joystick whereby to navigate through various programs of functions of the device.

In some embodiments, PCU 600 comprises a separate, stationary electronic device having increased processing power and functionality as compared to PCD 510. For example, in some embodiments PCU 600 comprises a desktop computer, a personal computer, a workstation, a minicomputer, a mainframe, a supercomputer, a multi-processor system, a network computer, a processor-based stationary consumer device, a smart appliance or device, a control system, or the like.

In some embodiments, PCU 600 further comprises an antenna (not shown) whereby to communicate wirelessly 520 with PCD 510, as shown in FIG. 45. In some embodiments, wireless communication 520 between PCD 510 and PCU 600 provides increased processing power to PCD 510. In some embodiments, stand 514 is adjustable whereby to position PCD 510 at a desired angle 16 to enable ergonomic interaction with display 512. For example, where display 512 is used as a keyboard, stand 514 permits optimal positioning of PCD 510 such that the users hands are able to interact with display 512 in a comfortable, ergonomic fashion. In some embodiments, PCD 510 is used with a stand 514 or easel to enable hands free use of the device. In other embodiments, stand 514 is adjustable so as to enable a desired positioning, orientation and/or angle of PCD 510, as discussed in detail below.

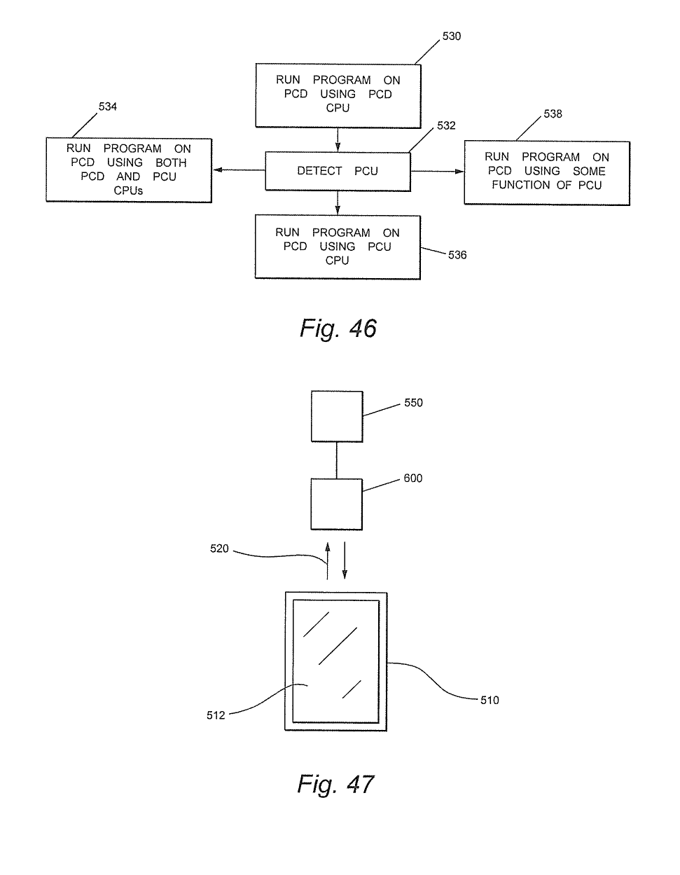

For example, in some embodiments a computer program is first executed 530 on a PCD using the CPU of the PCD, as shown in FIG. 46. When the PCD is brought within proximity to a PCU, the PCD detects 532 and recognizes the PCU. In some embodiments, the processing powers of the PCD and the PCU are combined to run the PCD program 534. In other embodiments, the processing power of the PCU is used to run the program on the PCD 536. Further, in some embodiments a feature or function of the PCU is utilized by the PCD while the program is run on the PCD 538. For example, in some embodiments a network feature of the PCU is utilized by the PCD to assist in running a program on the PCD.

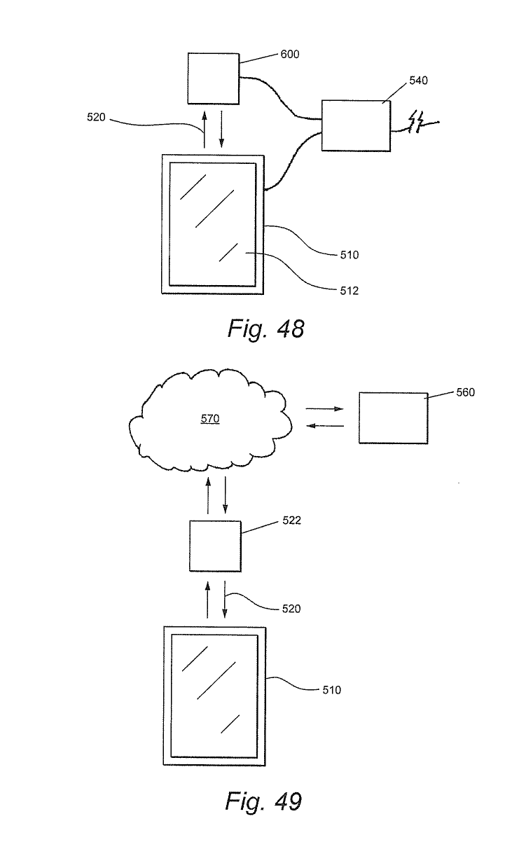

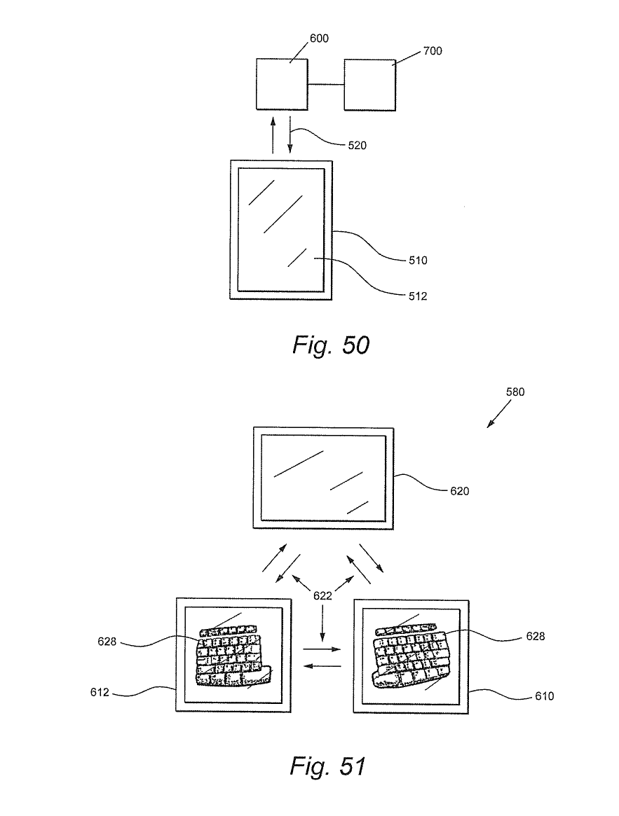

In some embodiments, PCD 510 and PCU 600 are simultaneously connected to a power supply 540 and wirelessly interconnected 520, as shown in FIG. 48. For example, in some embodiments power supply 540 comprises a docking station into which PCD 510 and PCU 600 are simultaneously connected. In other embodiments, power supply 540 comprises a power inverter, a power transformer, and/or a power convertor having circuitry to power both PCD 510 and PCU 600.

With reference to FIG. 47, in some embodiments PCD 510 is wirelessly connected to storage unit 550 via PCU 600. Thus, the storage capacity of PCD 510 is expanded simply by establishing wireless communication with storage unit 550 via PCU 600. In other embodiments, the storage capacity of PCD 510 is expanded via a remote, networked storage unit 560, as shown in FIG. 49. For example, in some embodiments PCD 510 establishes a wireless connection 520 with a cloud network 70 via an established connection 522 between PCU 600 and network 570. PCD 510 then accesses a remote storage unit 560 via an established connection 524 between network 570 and remote storage unit 560. Thus, the storage capacity of PCD 510 is expanded simply by establishing wireless communication with remote storage unit 560 via PCU 600 and cloud network 570.

In some embodiments, the processing power of PCD 510 is greatly expanded by establishing communication 520 between a graphics computing unit (GCU) via a PCU 600. A GCU comprises a processor attached to a graphics card dedicated to calculating floating point operations. A GCU implements a number of graphics primitive operations in a way that makes running them much faster than drawing directly to the screen with a host CPU. In some embodiments, parallel GCU processors are utilized for General Purpose Computing on GPU (GPGPU) processing procedures. Thus, in some embodiments of the present invention the processing power of PCD 510 is elevated to the level of supercomputing by accessing the processing power of GCU 200 via PCU 600. In some embodiments, PCU 600 is a GCU, thus eliminating the need for an intermediary computer device.

One having skill in the art will appreciate that the various combinations discussed above may be interchanged or altered to expand the processing power and/or functionality of PCD 510 as may be desired. One having skill in the art may further recognize the need for digital keys, scripts, drivers, passwords, logins, encryptions, and other computer executable codes as may be necessary to permit the communications described herein. Further, one having skill in the art will appreciate and may understand the need for additional hardware features and elements to facilitate the communications described herein.

Referring now to FIG. 51, an interactive computing system 580 is shown. In some embodiments, interactive computing system 580 comprises a plurality of PCDs 610 and 612 used in combination with a display unit 620620. Display unit 620620 may include any type of display capable of providing a visual representation of a computer executable program or function. For example, in some embodiments display unit 620 comprises at least one of a computer monitor, a television, a processor-based stationary consumer device, a non-processor-based consumer device, a smart appliance, a processor-based portable consumer device, a tablet computer, and a projected 2D or 3D image.

In some embodiments, the PCDs 610 and 612 are used in combination with display unit 620 to perform a desired function. For example, in some embodiments PCDs 610 and 612 provide an input function to perform a task or function which is displayed on output display unit 620. In some embodiments PCD 610 provides a first half of a touch screen keyboard 628 and PCD 612 provides a second half a touch screen keyboard. A network of communication 622 is established between PCDs 610 and 612 and display unit 620 such that touch screen keyboard 628 may be utilized to input information that subsequently output onto display unit 620. In some embodiments, the processing power of a single PCD 610 or 612 is used to perform a task, function, or computer executable program. Thus, the additional PCD 612 or 610 and the output display unit rely on the processing power of the PCD on which the program is stored. In other embodiments, the combined processing powers of the PCDs 610 and 612 are concurrently utilized to perform the desired task, function or computer executable program. Further, in other embodiments the processing powers to the PCDs 610 and 612 are combined with the processing power of the display unit 620 to perform the desired task, function or computer executable program. Still further, in some embodiments the desired computer executable program is stored on at least one of the first PCD 610, the second PCD 612, and the display unit 620. In other embodiments, the desired computer executable program is stored in a remote storage unit as discussed above.

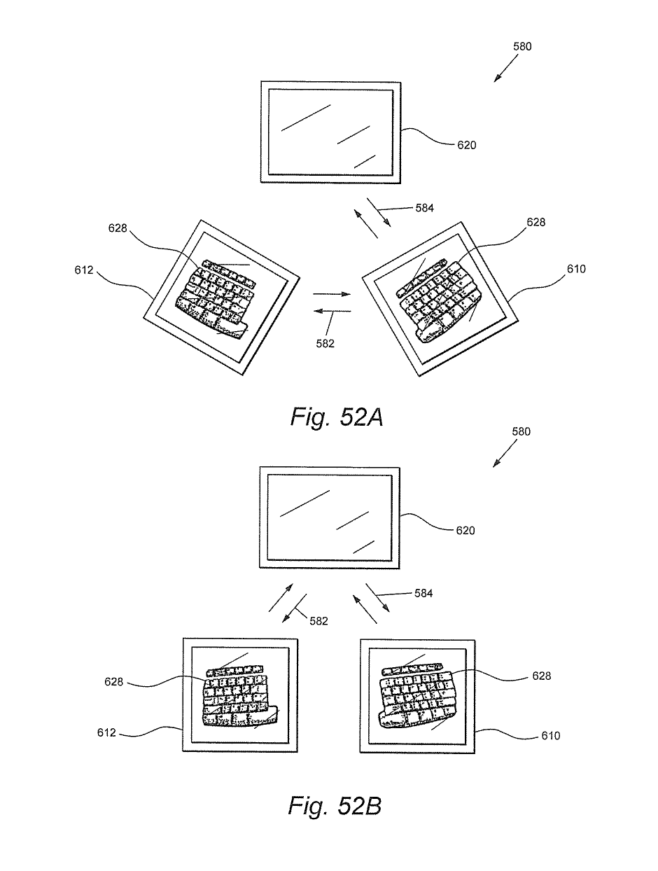

With reference to FIG. 52, as shown in parts A and B, in some embodiments an ergonomic feature or function is provided by using multiple PCDs 610 and 612. In some embodiments, an ergonomic touch screen keyboard 628 is provided by simply rotating PCDs 610 and 612 to a desired orientation, as shown in FIG. 52A. In other embodiments, an ergonomic touch screen keyboard 628 is provided by rotating the touch screen keyboard 628 on the respective PCD, as shown in FIG. 52B.

With continued reference to FIG. 52A, in some embodiments an interactive computing system 580 is provided through a wireless, serial communication structure wherein a first communication 582 is established between the PCDs 610 and 612, and a second communication 584 is established between PCD 610 and display unit 620. In other embodiments, a wireless, parallel communication structure is utilized wherein a first parallel communication 582 is established between PCD 612 and display unit 620, and a second parallel communication 84 is established between PCD 610 and display unit 620, as shown in FIG. 52B.

In some embodiments, the wireless, parallel communication structure shown in FIG. 52B is utilized in interactive computing, such as social networking or computer gaming. For example, in some embodiments PCD 610 is controlled by a first user and PCD 612 is controlled by a second user, wherein the first and second users are mutually participating in an interactive computing medium which is displayed on display unit 620. In other embodiments, PCD 610 is controlled by a first user and PCD 612 is controlled by a second user to concomitantly interact with an executable program, web-based application, or website displayed on display unit 620. Still further, in some embodiments an inter-device communication, as shown in FIGS. 51 and 52A, is further established between PCD 610 and PCD 612, wherein first and second users may further interact with the other user's PCD. Thus, one having skill in the art will appreciate that various other communication configurations may be implemented to achieve the desired functionality of system 580, and are therefore within the spirit of the present teaching.

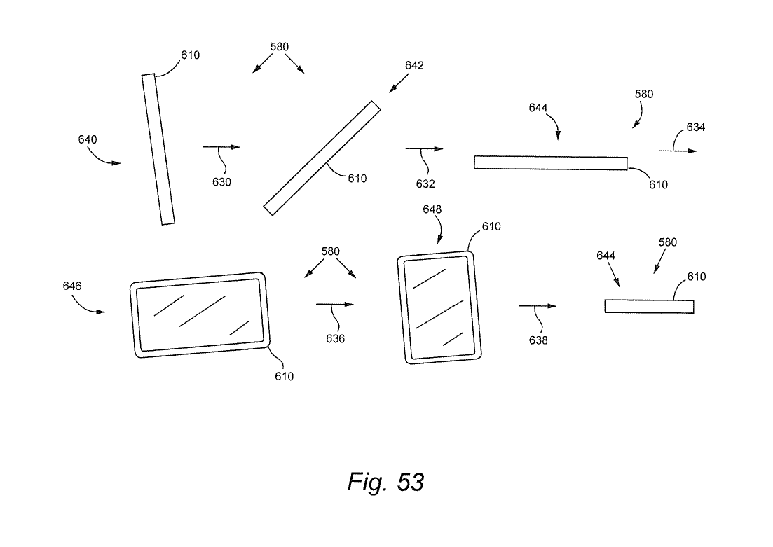

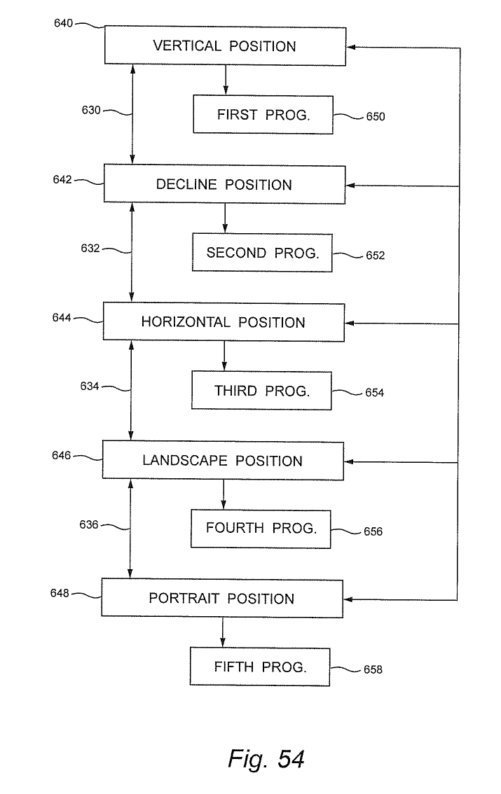

In some embodiments, a script command is provided that links a processing event to a motion or physical orientation of the PCD. Thus, a user may interact with the computing device merely by rotating, shifting, shaking or otherwise orienting the PCD in a predetermined, or customizable position or manner. Referring now to FIGS. 53 and 54, in some embodiments an interactive computing system 80 is provided wherein the orientation of a PCD 610 executes a computing function for the PCD. For example, in some embodiments the action 630 of moving the PCD 610 from a vertical position 640 to a declined position 642 results in the PCD 610 changing from a first computer executable program 650 to a second computer executable program 652. Conversely, as the PCD is moved 630 from the declined position 642 to a vertical position 640, the PCD 610 changes from the second program 652 to the first program 650.

From the declined position 642, the PCD 610 may be moved 632 to a horizontal position 644 whereupon the PCD changes from the second program 652 to a third program 654. From the horizontal position 644, the PCD 610 is moved 634 to a landscape position 646 thereby causing the PCD 610 to change from the third program 654 to a fourth program 656. Further, from the landscape position 646 the PCD 610 is moved 636 to a portrait position 648 thereby causing the PCD 610 to change from the fourth program 656 to a fifth program 658. Thus, in some embodiments a user accesses a desired program 650, 652, 654, 656 or 658 by merely repositioning the PCD 610 to an associated position 640, 642, 644, 646 or 648, respectively.

In some embodiments, a specific sequence of movements is required to access a desired program. In other embodiments, a program is accessed by simply moving the PCD from a first position to a second position. In other embodiments, access to a program is dependent only upon the orientation of the PCD, thereby eliminating the need for a movement, action or motion of the PCD. Still further, in some embodiments a motion or an orientation of the PCD results in a program being terminated. In other embodiments, a motion or an orientation of the PCD results in the initiation of a shutdown sequence or a sleep sequence for the device. For example, in some embodiments the PCD enters a sleep mode when oriented in horizontal position with the display facing downward.

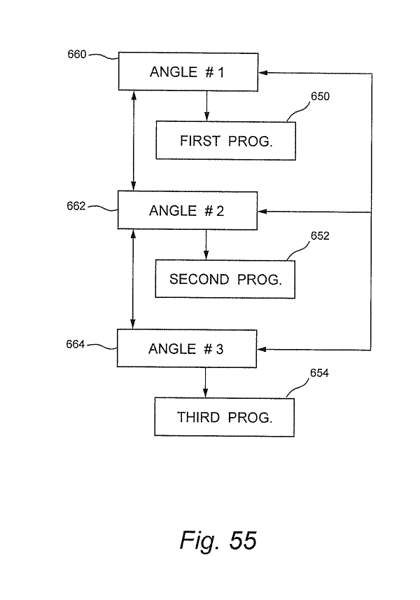

With reference to FIG. 55, in some embodiments an angle of the PCD 610 determines the execution of a computer program for the PCD. For example, in some embodiments an angle of decline for the PCD determines the execution of a computer program. In some embodiments, a first angle 660 results in the execution of a first program 650. Upon moving the PCD from the first angle 660 to a second angle 662, the PCD executes a second computer program 652. Further, upon moving the PCD from the second angle 662 to a third angle 664, the PCD executes a third computer program 654. In some embodiments PCD 510 is used with a stand 514, as shown in FIG. 45 above, which is adjustable to maintain a desired angle for the PCD 510. Thus, a user may select and use a desired computer program by simply adjusting the stand 514 to hold the PCD at the desired angle.

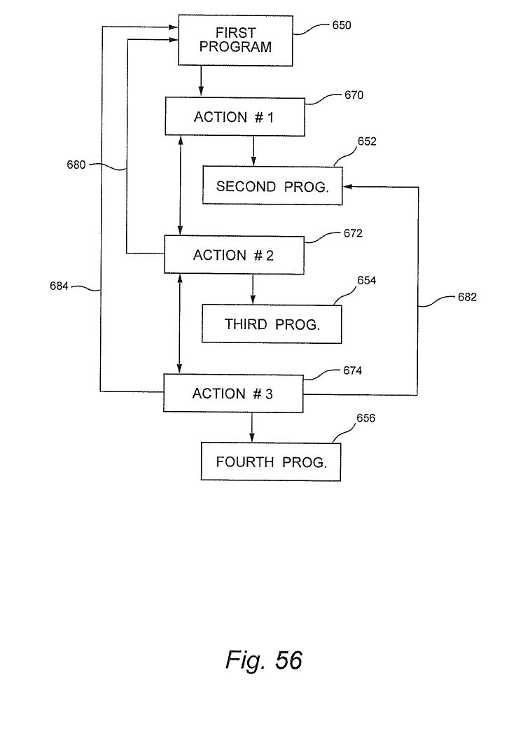

Referring now to FIG. 56, in some embodiments a physical action performed with the PCD determines the execution of a computer program for the PCD. For example, in some embodiments a first action 670 changes the PCD from executing a first program 650 to executing a second program 652. Similarly, a second action 672 changes the PCD from executing the second program 652 to executing a third program 654. Further, a third action 674 changes the PCD from executing the third program 654 to executing a fourth program 656.

In some embodiments, repeat performance 680 of an action 672 causes the PCD to execute a previously executed computer program 650. In other embodiments, a first repeat performance 682 of an action 674 causes the PCD to execute a first previously executed computer program 652, and a second repeat performance 684 of an action 674 causes the PCD to execute a second previously executed computer program 650.

In some embodiments, physical actions 670, 672 and 674 are selected from the group including tilting, shaking, shifting, rapidly changing position, performing a series of directed movements, rotating, inverting, spinning, jolting, resting and/or changing altitude of the PCD. In other embodiments physical actions 670, 672 and 674 include changing the proximity of the PCD to a second PCD. Further, in other embodiments physical actions 670, 672 and 674 include changing the proximity of the PCD to a PCU.

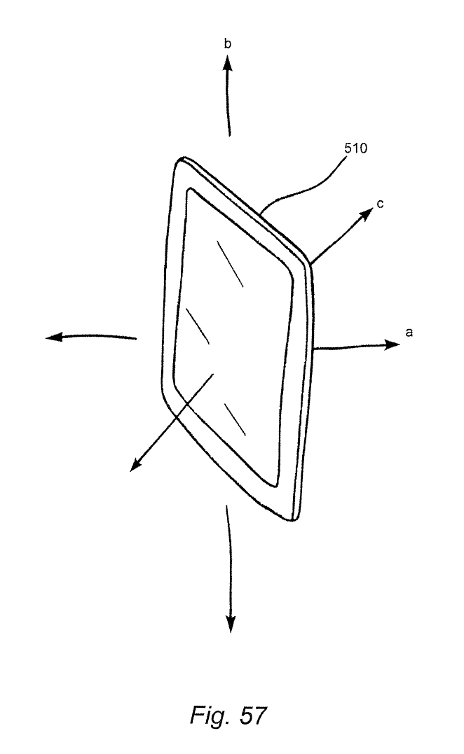

As shown in FIG. 57, physical actions 670, 672 and 674 may include any movement of PCD 510 along any axis, between any axis, around any axis, or any combination of possible movements for which a script has been defined to execute a desired processing function, drive application, or action.

For example, in some embodiments a drive application is selected and/or executed based on the orientation of the device. In some embodiments a platform or docking station is provided whereby when the device is placed on the platform a predetermined orientation for the device is acheived thereby resulting in the selection or execution of a drive application. Further, in some embodiments a platform or docking station is provided whereby an orientation of the device, when placed on the platform, achieves a predetermined orientation for the device, thereby resulting in at least one of: 1) a software update; 2) a firmware update; 3) an authorization to download a program, such as an application; 4) an authorization to download promotional or advertising information; 5) enable wireless transmission of information and/or data; and 6) lock or unlock functionality of the device.

In some embodiments, PCD 510 further comprises a 3-axis gyroscope whereby the PCD 510 is capable of detecting motion along, around and between axes a, b, and c. Thus, in some embodiments PCD 510 is capable of detecting a three-dimensional position thereby selecting and/or executing a drive application based on a predetermined three-dimensional position. Accordingly, embodiments of the present invention are not limited to two-dimensional positions, but also include three-dimensional positions, as well as transitional movements of the device between various dimension positions.

In some embodiments, PCD 510 further comprises global positioning satellite capabilities (GPS) wherein a physical position of the device, or change in the physical position of the device is used to select and/or execute a drive application. For example, in some embodiments a geographical location of the phone automatically executes a drive application of the PCD 510, wherein audio capabilities of the PCD 510 are silenced, for example, at a movie theater. In other embodiments, a geographical location of the phone automatically executes a drive application of the PCD 510, wherein wireless capabilities of the PCD 510 are enabled. Further, in some embodiments a user selects and associates a drive application or command of the PCD 510 with a desired geographical location, such that when the GPS of the PCD 510 detects the geographical location, the user selected drive application is automatically executed.

In addition to physical or geographical location, GPS capabilities of PCD 510 also provide information relative to the altitude of PCD 510. Accordingly, in some embodiments an altitude of the device, or change in the altitude of the device is used to select and/or execute a drive application. Further, in some embodiments a user is able to set or select an application that is automatically executed at a desired altitude or change in altitude.

In some embodiments, a position or series of positions of PCD 510 results in the execution of a desired program, a drive application, or an action. In other embodiments, a position or series of positions in response to the execution of a drive application results in the execution of a user command, a second drive application, a desired program, and/or an action. In some embodiments the execution of a drive application requires the user to respond to executed drive application by manipulating a position of the PCD 510.

For example, where PCD 510 is a mobile phone device, an incoming call executes a drive application for receiving and alerting the user of the incoming call. In response to the executed drive application, a user will manipulate the position of the mobile phone device such that he is able to respond to the incoming call. In some embodiments, the position of the mobile phone device is manipulated so as to position the earpiece and mouthpiece of the mobile device adjacent the user's ear are and mouth, respectively. Accordingly, the mobile phone device is in a first position when the drive application is first executed, and subsequently moved to a second position, by the user, in response to execution of the first drive application. In some embodiments, a second drive application is executed based on the user manipulation of the mobile phone device from the first position to the second position. For example, in some embodiments a second drive application comprises automatically answering or accepting the incoming call of the first drive application.

In some embodiments, the motion by which a user interacts with PCD 510 automatically executes at least one of a desired program, a drive application, or an action. For example, where PCD 510 is a mobile phone device, an incoming call executes a drive application for receiving and alerting the user of an incoming call. In response to the incoming call, the user manipulates the phone in certain motions which indicate what the user intends to do with the phone in response to the incoming call. For example, by one motion the user intends to accept the incoming call, while by a second motion the user intends to ignore the incoming call. Further, by one motion the user views the phone to determine if they desire to answer or ignore the incoming call. If the user desires to answer the incoming call, the user manipulates the phone into a first position whereby the phone is held up to the user's mouth and ear. If the user desires to ignore the incoming call, the user may return the phone to an initial position of the phone prior to the incoming call. Accordingly, in some embodiments the motion by which a user interacts with PCD 510, in response to the execution of a drive application, results in the execution of a second drive application, or action.

For example, where the user desires to answer the incoming call, a change in position of the PCD 510 from an initial position to a position adjacent the user's head automatically answers the incoming call. In some embodiments, a mid-position of the phone (such as when the user views the phone to make a determination whether as to answer or ignore the incoming call) does not result in the execution of a drive application or action. Rather, movement of the PCD 510 (i.e.: phone) subsequent to the mid-position of the phone indicates a desired action by the user. Where the user moves the phone from the mid-position to the user's ear, the action of answering the incoming call is automatically executed. In contrast, where the user returns the phone from the mid-position to an initial position, the action of ignoring the incoming call is automatically executed. Accordingly, one having skill in the art will appreciate that any movement of PCD 510 that is generally associated with a user-executed drive application or action may be programmed to be automatically executed based solely on the motion patterns of the phone.

In some embodiments, PCD 510 further comprises learning logic whereby a user may train the phone to execute a desired drive application, program, or action based on a motion pattern of the phone. In some embodiments the learning logic comprises an executable code which enables a user to select an action or secondary drive application which is automatically executed in response to a primary executed drive application. In other embodiments, the learning logic comprises an executable code which enable a user to select an action or drive application which is automatically enabled or executed based solely on a pattern of motions experienced by the PCD 510.

For example, in some embodiments a user teaches or programs PCD 510 to execute a drive application based on a repetitive motion of the PCD 510, such as a forward and backward motion that is commonly experienced by PCD 510 when placed in a pocket or attached to an arm of the user while the user is walking or running. In some embodiments, the repetitive motion automatically launches or executes an audio player drive application. In other embodiments, the repetitive motion automatically launches or executes a GPS navigation drive application.

A method by which the user teaches or trains the learning logic of PCD 510 includes the stops of 1) selecting an action or drive application; and 2) associating a motion with the selected action or drive application. The method of associating a motion with the selected action may include repeating the motion for a predetermined number of times, such that the learning logic of PCD 510 is able to detect and map the motion of the phone and any variations that the user may unintentionally effect during the movement. PCD 510 then records and stores the user motion such that when the motion is detected the desired action or drive application is automatically executed.

Further, in some embodiments the rate of speed at which the PCD 510 moves automatically executes a desired drive application. For example, in some embodiments a GPS navigation drive application is launched or executed automatically when PCD 510 moves at or greater than a user-specified rate of speed. In other embodiments, a traffic application is automatically executed when PCD 510 exceeds a predetermined rate of speed. Further, in some embodiments a speedometer application is executed automatically when PCD 510 exceeds a predetermined rate of speed.

Thus, embodiments of the present invention relate to computer processors, computer systems, computer housings, computer encasement modules, computer system configurations, computer resources, and/or computer system interactivity. More particularly, implementations of the present invention relate to a virtually-modularized computer system, an interactive computing system, and/or storage and other modular systems devices for use with computer systems. At least some implementations of the present invention relate to systems and methods that increase the capability and performance of a portable computer device (“PCD”) by linking the PCD with a stationary processing control unit (“PCU”). In some implementations, the present invention further relates to systems and methods that increase the usability of a PCD by creating and associating scripts to defined movements or orientations of the PCD, thereby providing a desired processing function.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. An intelligent mounting bracket comprising:
a structural shell configured to be mounted to an underlying surface and to securely hold a mounted item; and
a computer system contained within the structural shell and configured to distribute processing resources from a remote computer system to one or more computer resources proximate to the mounting bracket.

2. A system for distributing computing resources comprising:
a base module having certain processing resources; and
a peripheral module communicatively connected to the base module and configured to utilize processing resources of the base module using one or more input/output devices connected to the peripheral module, whereby the peripheral module facilitates a user's opening a session on the base module while using less than ten watts of power for the peripheral module itself.

3. A system for distributing computing resources comprising:
a base module having certain processing resources; and
a peripheral module communicatively connected to the base module and configured to utilize processing resources of the base module using one or more input/output devices connected to the peripheral module, wherein the peripheral module utilizes only enough computing resources to pass input/output signals between the input/output devices at the peripheral module and the base module.

4. A system for efficiently managing and distributing computing resources comprising:
a base module having certain processing resources and providing a first user with a graphical user interface providing access to a first session of an operating system of the base module; and
a peripheral module communicatively connected to the base module and providing a second user with a graphical user interface providing access to a second session of the operating system of the base module without requiring that a separate instance of the operating system be loaded into memory of the base module.
